(19) United States
(12) Patent Application Publication
(10) Pub. No.: US 2019/0036484 A1
(43) Pub. Date: Jan. 31, 2019

(54) Efficient Back Supported Solar Panel Systems and Methods

(71) Applicant: Patton Engineering, Inc., Roseville, CA (US)

(72) Inventor: John C. Patton, Roseville, CA (US)

(21) Appl. No.: 15/747,031

(22) PCT Filed: Aug. 10, 2016
(86) PCT No.: PCT/US2016/046382

§ 371 Date: Jan. 23, 2018

Related U.S. Application Data
(60) Provisional application No. 62/282,793, filed on Aug. 10, 2015.

(51) Int. Cl. H02S 40/42; H02S 20/23; H02S 30/10; H02S 40/34

(52) U.S. Cl. CPC H02S 40/425; H02S 40/345; H02S 30/10; H02S 20/23

(57) ABSTRACT

Embodiments of the present invention include solar power attachment systems between a photovoltaic layer (19) and at least one protuberant limb (130); novel cooling systems with the use of conductive layers (32); and even PV cell connection systems which may provide both electrical connections and cell cooling systems.

This application is a PCT Application claiming the benefit of and priority to U.S. Provisional Application No. 62/282,793 filed Aug. 10, 2015, hereby incorporated by reference herein.

### TECHNICAL FIELD

This invention relates to the field of solar power back supported systems that provide increased flexibility and lower costs for installation.

### BACKGROUND

In the past, most solar panels have aluminum frames around the laminate which provide most of the strength to the module. These frames are used to attach to other support structures, such as PV racking, which could then be attached to surfaces such as roofs. To achieve maximum strength, the frame can only be attached at specific locations. This results in lack of flexibility of the system and high costs for installation. It is desirable to develop a solar panel system which provides strength of the module other than from a frame and allow flexibility in installation perhaps allowing reduced installation costs.

In the laminate, the main strength may come from the glass. Since the laminate is typically held from the edges, the glass can bend during heavy loads such as wind and snow. As the glass bends, it stresses the photovoltaic layer, usually solar cells. This bending can cause breaking of the solar cells, wire contact issues, or even micro-cracks in the solar cell which can effect life of the solar cell.

Typical solar panel efficiency varies from about 10 to about 24 percent. Most of the remaining energy goes to heating the PV layer. The various layers in the solar panel are typically not good heat conductors such as the polymeric layers, the encapsulant layers and the glass. This makes the PV layer heat up and as the PV layer temperature rises, the overall efficiency goes down. Heat may then be transferred out the back of the module through the backsheet. The surface area of the flat backsheet is limited so heat transfer is low. The heat transfer may also be dependent on the air flow across the backsheet. If the air flow is restricted, the solar cell temperature will increase. Solar panels are usually mounted close to a surface or there may be other obstacle flow restrictions so temperatures rise due to the poor heat transfer on the backside of the solar panel. Also, the traditional solar frame forms a pocket on the back side of the solar panel further restricting the air flow. It is desirable to provide a solar power systems that reduces the temperature of the PV layer making the solar panel more efficient.

Solar cells are usually connected together with flat buss wire that is typically attached to the top of one cell to the bottom of the adjacent solar cell. The cells are connected in series. Since these wires are thick as compared to the cell, cell breaking and cracking can occur during the manufacturing process. This occurs mainly in the tab soldering, the handling of the cell string, and even the laminating processes. Later during normal solar panel operation, further stresses may occur when the solar panel is subjected to the outdoor elements such as wind and snow loading, and daily and seasonal temperature cycles.

The thinner the buss, the less stress will be created. For this reason and to improve the efficiency of the cell for electron collection, more buss wires have been added to the cell. The solar cell started with about 1-2 bus wires, but now there may be about 3-5 buss wires. The buss wires can also shade the solar cell which reduces the effective area that the photons can hit the cell and even reduces the effective active photovoltaic area of the solar cell. Therefore, it is desirable to have thinner and even more buss wires to reduce solar cell stress and perhaps to decrease the area on top of the solar cell that shades active area of the PV layer.

Further, it is desirable to reduce the amount of area taken up by grid lines, which may reduce the wire buss, and may result in increased efficiency of the solar cell. Also, if the thickness of the interconnection buss can be reduced, the solar cell stress caused by the buss can be reduced. This will increase the manufacturing yield and increase the reliability of the solar cell.

The junction box or other electronic box is usually attached to the backsheet. The electronics in the box creates some heat and also restricts the flow of heat out of the back sheet. The electronic box is usually put over multiple cells so no one cell is completely covered, but this still causes cell hot spots on the solar cells. This increases the temperature of the cell and reduces the overall efficiency of the solar panel. It is desirable to provide a system where some or even most of an electronic box can be elevated from the backsheet which may allow reduction of surface area contact, and may increase the efficiency of the solar panel.

The present invention addresses these needs by providing, in embodiments, a solar panel strength that comes from a supporting structure. Due to the stronger and support to the backside of a module, mounting may be more flexible and installation costs can be reduced. The present invention provides, in embodiments, attachment of modules to a backsheet in many areas, which will reduce bending of the glass. Since bending is not as severe, stresses in the solar cells should be reduced as well. Embodiments of the present invention may also provide a thin conductive layer which can reduce the stresses to the solar cells that may even increase manufacturing yield and increase the solar cell reliability. In yet other embodiments of the present invention, a trough proper grid design may be provided perhaps to reduce the solar cell shadowing and perhaps allow more efficient collecting of the electrons before they recombine. The present invention may provide an electronic box that can be attached to protuberant limb which can reduce box adhesion. This may prevent the box from adding and trapping heat perhaps providing a cell temperature to drop and drastically reducing or even eliminating hot spots.

In addition, embodiments of the present invention provide solar panels with supports and heat extraction features perhaps to lower the temperature of the photovoltaic cells or photovoltaic layer which may increase the power output of the solar panel. Also, a back supported solar panel may be stronger and lighter than the conventional framed solar panel which may allow minimal or even no racking additions to attach to the roof, ground mount, carport or other structures. These features can also provide reduced installation labor and may even provide a less restricted air flow since it may not have a frame to create a pocket. Further, with the use of non-conductive structural materials, grounding may not be required. By increasing the PV output, reducing the installation labor, lowering the solar panel cost, the cost of the PV system may be greatly reduced.

### SUMMARY OF THE INVENTION

Accordingly, the invention provides various embodiments that can be implemented either alone or in combinations to achieve a variety of goals. Some of these goals include, but are not limited to, providing a solar panel system which includes efficient cooling of the photovoltaic layer and cell; providing a solar panel system with efficient surface attachment systems such that in some embodiments, it may provide an option to exclude framing of the panels; and may even provide efficient electrically attached and perhaps with cooling options between panels. Other goals and objects of the present invention can be found in the specification, figures and claims of this application.

### BRIEF DESCRIPTION OF THE DRAWINGS

FIG. 1 shows an example of a traditional solar panel.

FIG. 2 shows an example of a traditional solar panel.

FIG. 3 shows an example of a back supported solar panel system in accordance with the various embodiments of the present invention.

FIG. 4 shows an example of a back supported solar panel system in accordance with the various embodiments of the present invention.

FIG. 5 shows an example of a back supported solar panel system in accordance with the various embodiments of the present invention.

FIG. 6 shows an example of a back supported solar panel system in accordance with the various embodiments of the present invention.

FIG. 7 shows an example of a back supported solar panel system in accordance with the various embodiments of the present invention.

FIG. 8 shows an example of a back supported solar panel system in accordance with the various embodiments of the present invention.

FIG. 9 shows an example of a back supported solar panel system in accordance with the various embodiments of the present invention.

FIG. 10 shows an example of a back supported solar panel system in accordance with the various embodiments of the present invention.

FIG. 11 shows an example of a back supported solar panel system in accordance with the various embodiments of the present invention.

FIG. 12 shows an example of a back supported solar panel system in accordance with the various embodiments of the present invention.

FIG. 13 shows an example of a back supported solar panel system in accordance with the various embodiments of the present invention.

FIG. 14 shows an example of a back supported solar panel system in accordance with the various embodiments of the present invention.

FIG. 15 shows an example of a back supported solar panel system in accordance with the various embodiments of the present invention.

FIG. 16 shows an example of a bottom support in accordance with the various embodiments of the present invention.

FIG. 17 shows an example of a protuberant limb in accordance with the various embodiments of the present invention.

FIG. 18 shows an example of an attachment of a protuberant limb to a docking base in accordance with the various embodiments of the present invention.

FIG. 19 shows an example of an attachment of a protuberant limb in accordance with the various embodiments of the present invention.

FIG. 20 shows an example of an attachment of a protuberant limb in accordance with the various embodiments of the present invention.

FIG. 21 shows an example of an attachment of a protuberant limb in accordance with the various embodiments of the present invention.

FIG. 22 shows an example of a conductive layer of a protuberant limb in accordance with the various embodiments of the present invention.

FIG. 23 shows an example of an attachment of a protuberant limb in accordance with the various embodiments of the present invention.

FIG. 24 shows an example of an attachment of a protuberant limb in accordance with the various embodiments of the present invention.

FIG. 25 shows an example of an attachment of a protuberant limb in accordance with the various embodiments of the present invention.

FIG. 26 shows an example of attaching channels of a back supported solar panel system in accordance with the various embodiments of the present invention.

FIG. 27 shows an example of attaching channels of a back supported solar panel system in accordance with the various embodiments of the present invention.

FIG. 28 shows an example of attaching channels of a back supported solar panel system in accordance with the various embodiments of the present invention.

FIG. 29 shows an example of attaching channels of a back supported solar panel system in accordance with the various embodiments of the present invention.

FIG. 30 shows an example of attaching channels of a back supported solar panel system in accordance with the various embodiments of the present invention.

FIG. 31 shows an example of attaching channels of a back supported solar panel system in accordance with the various embodiments of the present invention.

FIG. 32 shows an example of attaching channels of a back supported solar panel system in accordance with the various embodiments of the present invention.

FIG. 33 shows an example of attaching channels of a back supported solar panel system in accordance with the various embodiments of the present invention.

FIG. 34 shows an example of attaching channels of a back supported solar panel system in accordance with the various embodiments of the present invention.

FIG. 35 shows an example of attaching channels of a back supported solar panel system in accordance with the various embodiments of the present invention.

FIG. 36 shows an example of attaching channels of a back supported solar panel system in accordance with the various embodiments of the present invention.

FIG. 37 shows an example of attaching channels of a back supported solar panel system in accordance with the various embodiments of the present invention.

FIG. 38 shows an example of attaching channels of a back supported solar panel system in accordance with the various embodiments of the present invention.

FIG. 39 shows an example of a flat roof PV mounting system as part of a back supported solar panel system in accordance with the various embodiments of the present invention.

FIG. 40 shows an example of a flat roof PV mounting system as part of a back supported solar panel system in accordance with the various embodiments of the present invention.

FIG. 41 shows an example of a flat roof PV mounting system as part of a back supported solar panel system in accordance with the various embodiments of the present invention.

FIG. 42 shows an example of a flat roof PV mounting system as part of a back supported solar panel system in accordance with the various embodiments of the present invention.

FIG. 43 shows an example of a flat roof PV mounting system as part of a back supported solar panel system in accordance with the various embodiments of the present invention.

FIG. 44 shows an example of a flat roof PV mounting system as part of a back supported solar panel system in accordance with the various embodiments of the present invention.

FIG. 45 shows an example of a flat roof PV mounting system as part of a back supported solar panel system in accordance with the various embodiments of the present invention.

FIG. 46 shows an example of a flat roof PV mounting system as part of a back supported solar panel system in accordance with the various embodiments of the present invention.

FIG. 47 shows an example of a flat roof PV mounting system as part of a back supported solar panel system in accordance with the various embodiments of the present invention.

FIG. 48 shows an example of attaching channels of a back supported solar panel system in accordance with the various embodiments of the present invention.

FIG. 49 shows an example of a flat roof PV mounting system as part of a back supported solar panel system in accordance with the various embodiments of the present invention.

FIG. 50 shows an example of a flat roof PV mounting system as part of a back supported solar panel system in accordance with the various embodiments of the present invention.

FIG. 51 shows an example of a flat roof PV mounting system as part of a back supported solar panel system in accordance with the various embodiments of the present invention.

FIG. 52 shows an example of a flat roof PV mounting system as part of a back supported solar panel system in accordance with the various embodiments of the present invention.

FIG. 53 shows an example of a flat roof PV mounting system as part of a back supported solar panel system in accordance with the various embodiments of the present invention.

FIG. 54 shows an example of a flat roof PV mounting system as part of a back supported solar panel system in accordance with the various embodiments of the present invention.

FIG. 55 shows an example of a flat roof PV mounting system as part of a back supported solar panel system in accordance with the various embodiments of the present invention.

FIG. 56 shows an example of an alternative flat roof PV mounting system as part of a back supported solar panel system in accordance with the various embodiments of the present invention.

FIG. 57 shows an example of an alternative flat roof PV mounting system as part of a back supported solar panel system in accordance with the various embodiments of the present invention.

FIG. 58 shows an example of an alternative flat roof PV mounting system as part of a back supported solar panel system in accordance with the various embodiments of the present invention.

FIG. 59 shows an example of an alternative flat roof PV mounting system as part of a back supported solar panel system in accordance with the various embodiments of the present invention.

FIG. 60 shows an example of an alternative flat roof PV mounting system as part of a back supported solar panel system in accordance with the various embodiments of the present invention.

FIG. 61 shows an example of an alternative flat roof PV mounting system as part of a back supported solar panel system in accordance with the various embodiments of the present invention.

FIG. 62 shows an example of attaching channels of a back supported solar panel system in accordance with the various embodiments of the present invention.

FIG. 63 shows an example of an alternative flat roof PV mounting system as part of a back supported solar panel system in accordance with the various embodiments of the present invention.

FIG. 64 shows an example of attaching channels of a back supported solar panel system in accordance with the various embodiments of the present invention.

FIG. 65 shows an example of attaching channels of a back supported solar panel system in accordance with the various embodiments of the present invention.

FIG. 66 shows an example of a joining link as part of a back supported solar panel system in accordance with the various embodiments of the present invention.

FIG. 67 shows an example of a joining link as part of a back supported solar panel system in accordance with the various embodiments of the present invention.

FIG. 68 shows an example of an alternative flat roof PV mounting system as part of a back supported solar panel system in accordance with the various embodiments of the present invention.

FIG. 69 shows an example of an alternative flat roof PV mounting system as part of a back supported solar panel system in accordance with the various embodiments of the present invention.

FIG. 70 shows an example of an alternative flat roof PV mounting system as part of a back supported solar panel system in accordance with the various embodiments of the present invention.

FIG. 71 shows an example of an alternative flat roof PV mounting system as part of a back supported solar panel system in accordance with the various embodiments of the present invention.

FIG. 72 shows an example of an alternative flat roof PV mounting system as part of a back supported solar panel system in accordance with the various embodiments of the present invention.

FIG. 73 shows an example of an alternative flat roof PV mounting system as part of a back supported solar panel system in accordance with the various embodiments of the present invention.

FIG. 74 shows an example of an alternative flat roof PV mounting system as part of a back supported solar panel system in accordance with the various embodiments of the present invention.

FIG. 75 shows an example of an alternative flat roof PV mounting system as part of a back supported solar panel system in accordance with the various embodiments of the present invention.

FIG. 76 shows an example of an alternative flat roof PV mounting system as part of a back supported solar panel system in accordance with the various embodiments of the present invention.

FIG. 77 shows an example of an alternative flat roof PV mounting system as part of a back supported solar panel system in accordance with the various embodiments of the present invention.

FIG. 78 shows an example of an alternative flat roof PV mounting system as part of a back supported solar panel system in accordance with the various embodiments of the present invention.

FIG. 79 shows an example of an alternative flat roof PV mounting system as part of a back supported solar panel system in accordance with the various embodiments of the present invention.

FIG. 80 shows an example of an alternative flat roof PV mounting system as part of a back supported solar panel system in accordance with the various embodiments of the present invention.

FIG. 81 shows an example of an alternative flat roof PV mounting system as part of a back supported solar panel system in accordance with the various embodiments of the present invention.

FIG. 82 shows an example of an alternative flat roof PV mounting system as part of a back supported solar panel system in accordance with the various embodiments of the present invention.

FIG. 83 shows an example of air channels of a back supported solar panel system in accordance with the various embodiments of the present invention.

FIG. 84 shows an example of air channels of a back supported solar panel system in accordance with the various embodiments of the present invention.

FIG. 85 shows an example of back supported PV panels for a pitched roof in accordance with the various embodiments of the present invention.

FIG. 86 shows an example of back supported PV panels for a pitched roof in accordance with the various embodiments of the present invention.

FIG. 87 shows an example of back supported PV panels for a pitched roof in accordance with the various embodiments of the present invention.

FIG. 88 shows an example of back supported PV panels for a pitched roof in accordance with the various embodiments of the present invention.

FIG. 89 shows an example of back supported PV panels for a pitched roof in accordance with the various embodiments of the present invention.

FIG. 90 shows an example of back supported PV panels for a pitched roof in accordance with the various embodiments of the present invention.

FIG. 91 shows an example of back supported PV panels for a pitched roof in accordance with the various embodiments of the present invention.

FIG. 92 shows an example of back supported PV panels for a pitched roof in accordance with the various embodiments of the present invention.

FIG. 93 shows an example of back supported PV panels for a pitched roof in accordance with the various embodiments of the present invention.

FIG. 94 shows an example of back supported PV panels for a pitched roof in accordance with the various embodiments of the present invention.

FIG. 95 shows an example of back supported PV panels for a pitched roof in accordance with the various embodiments of the present invention.

FIG. 96 shows an example of back supported PV panels for a pitched roof in accordance with the various embodiments of the present invention.

FIG. 97 shows an example of back supported PV panels for a pitched roof in accordance with the various embodiments of the present invention.

FIG. 98 shows an example of back supported PV panels for a pitched roof in accordance with the various embodiments of the present invention.

FIG. 99 shows an example of back supported PV panels for a pitched roof in accordance with the various embodiments of the present invention.

FIG. 100 shows an example of back supported PV panels for a pitched roof in accordance with the various embodiments of the present invention.

FIG. 101 shows an example of back supported PV panels for a pitched roof in accordance with the various embodiments of the present invention.

FIG. 102 shows an example of back supported PV panels for a pitched roof in accordance with the various embodiments of the present invention.

FIG. 103 shows an example of back supported PV panels for a pitched roof in accordance with the various embodiments of the present invention.

FIG. 104 shows an example of back supported PV panels for a pitched roof in accordance with the various embodiments of the present invention.

FIG. 105 shows an example of back supported PV panels for a pitched roof in accordance with the various embodiments of the present invention.

FIG. 106 shows an example of back supported PV panels for a pitched roof in accordance with the various embodiments of the present invention.

FIG. 107 shows an example of back supported PV panels for a pitched roof in accordance with the various embodiments of the present invention.

FIG. 108 shows an example of back supported PV panels for a pitched roof in accordance with the various embodiments of the present invention.

FIG. 109 shows an example of back supported PV panels for a pitched roof in accordance with the various embodiments of the present invention.

FIG. 110 shows an example of back supported PV panels for a pitched roof in accordance with the various embodiments of the present invention.

FIG. 111 shows an example of back supported PV panels for a pitched roof in accordance with the various embodiments of the present invention.

FIG. 112 shows an example of back supported PV panels for a pitched roof in accordance with the various embodiments of the present invention.

FIG. 113 shows an example of back supported PV panels for a pitched roof in accordance with the various embodiments of the present invention.

FIG. 114 shows an example of back supported PV panels for a pitched roof in accordance with the various embodiments of the present invention.

FIG. 115 shows an example of back supported PV panels for a pitched roof in accordance with the various embodiments of the present invention.

FIG. 116 shows an example of back supported PV panels for a pitched roof in accordance with the various embodiments of the present invention.

FIG. 117 shows an example of back supported PV panels for a pitched roof in accordance with the various embodiments of the present invention.

FIG. 118 shows an example of back supported PV panels for a pitched roof in accordance with the various embodiments of the present invention.

FIG. 119 shows an example of back supported PV panels for a pitched roof in accordance with the various embodiments of the present invention.

FIG. 120 shows an example of back supported PV panels for a pitched roof in accordance with the various embodiments of the present invention.

FIG. 121 shows an example of back supported PV panels for a pitched roof in accordance with the various embodiments of the present invention.

FIG. 122 shows an example of back supported PV panels for a pitched roof in accordance with the various embodiments of the present invention.

FIG. 123 shows an example of back supported PV panels for a pitched roof in accordance with the various embodiments of the present invention.

FIG. 124 shows an example of back supported PV panels for a pitched roof in accordance with the various embodiments of the present invention.

FIG. 125 shows an example of back supported PV panels for a pitched roof in accordance with the various embodiments of the present invention.

FIG. 126 shows an example of back supported PV panels for a pitched roof in accordance with the various embodiments of the present invention.

FIG. 127 shows an example of back supported PV panels for a pitched roof in accordance with the various embodiments of the present invention.

FIG. 128 shows an example of back supported PV panels for a pitched roof in accordance with the various embodiments of the present invention.

FIG. 129 shows an example of an open top support as part of a back supported solar panel system in accordance with the various embodiments of the present invention.

FIG. 130 shows an example of an open top support as part of a back supported solar panel system in accordance with the various embodiments of the present invention.

FIG. 131 shows an example of an open top support as part of a back supported solar panel system in accordance with the various embodiments of the present invention.

FIG. 132 shows an example of a lip system as part of a back supported solar panel system in accordance with the various embodiments of the present invention.

FIG. 133 shows an example of lip system as part of a back supported solar panel system in accordance with the various embodiments of the present invention.

FIG. 134 shows an example of lip system as part of a back supported solar panel system in accordance with the various embodiments of the present invention.

FIG. 135 shows an example of lip system as part of a back supported solar panel system in accordance with the various embodiments of the present invention.

FIG. 136 shows an example of lip system as part of a back supported solar panel system in accordance with the various embodiments of the present invention.

FIG. 137 shows an example of lip system as part of a back supported solar panel system in accordance with the various embodiments of the present invention.

FIG. 138 shows an example of lip system as part of a back supported solar panel system in accordance with the various embodiments of the present invention.

FIG. 139 shows an example of lip system as part of a back supported solar panel system in accordance with the various embodiments of the present invention.

FIG. 140 shows an example of lip system as part of a back supported solar panel system in accordance with the various embodiments of the present invention.

FIG. 141 shows an example of an open top support as part of a back supported solar panel system in accordance with the various embodiments of the present invention.

FIG. 142 shows an example of lip system as part of a back supported solar panel system in accordance with the various embodiments of the present invention.

FIG. 143 shows an example of an open top support as part of a back supported solar panel system in accordance with the various embodiments of the present invention.

FIG. 144 shows an example of an open top support as part of a back supported solar panel system in accordance with the various embodiments of the present invention.

FIG. 145 shows an example of an open top support as part of a back supported solar panel system in accordance with the various embodiments of the present invention.

FIG. 146 shows an example of an open top support as part of a back supported solar panel system in accordance with the various embodiments of the present invention.

FIG. 147 shows an example of a sheet with protuberant limbs extending therefrom in accordance with the various embodiments of the present invention.

FIG. 148 shows an example of a sheet with protuberant limbs extending therefrom in accordance with the various embodiments of the present invention.

FIG. 149 shows an example of a sheet with protuberant limbs extending therefrom in accordance with the various embodiments of the present invention.

FIG. 150 shows an example of a sheet with protuberant limbs extending therefrom in accordance with the various embodiments of the present invention.

FIG. 151 shows an example of attachment systems with protuberant limbs in accordance with the various embodiments of the present invention.

FIG. 152 shows an example of attachment systems with protuberant limbs in accordance with the various embodiments of the present invention.

FIG. 153 shows an example of attachment systems with protuberant limbs in accordance with the various embodiments of the present invention.

FIG. 154 shows an example of attachment systems with protuberant limbs in accordance with the various embodiments of the present invention.

FIG. 155 shows an example of attachment systems with protuberant limbs in accordance with the various embodiments of the present invention.

FIG. 156 shows an example of attachment systems with protuberant limbs in accordance with the various embodiments of the present invention.

FIG. 157 shows an example of attachment systems with protuberant limbs in accordance with the various embodiments of the present invention.

FIG. 158 shows an example of attachment systems with protuberant limbs in accordance with the various embodiments of the present invention.

FIG. 159 shows an example of attachment systems with protuberant limbs in accordance with the various embodiments of the present invention.

FIG. 160 shows an example of attachment systems with protuberant limbs in accordance with the various embodiments of the present invention.

FIG. 161 shows an example of attachment systems with protuberant limbs in accordance with the various embodiments of the present invention.

FIG. 162 shows an example of attachment systems with protuberant limbs in accordance with the various embodiments of the present invention.

FIG. 163 shows an example of attachment systems with protuberant limbs in accordance with the various embodiments of the present invention.

FIG. 164 shows an example of thermally conductive, electrical connections between cells in accordance with the various embodiments of the present invention.

FIG. 165 shows an example of thermally conductive, electrical connections between cells in accordance with the various embodiments of the present invention.

FIG. 166 shows an example of thermally conductive, electrical connections between cells in accordance with the various embodiments of the present invention.

FIG. 167 shows an example of thermally conductive, electrical connections between cells in accordance with the various embodiments of the present invention.

FIG. 168 shows an example of thermally conductive, electrical connections between cells in accordance with the various embodiments of the present invention.

FIG. 169 shows an example of thermally conductive, electrical connections between cells in accordance with the various embodiments of the present invention.

FIG. 170 shows an example of thermally conductive, electrical connections between cells in accordance with the various embodiments of the present invention.

FIG. 171 shows an example of thermally conductive, electrical connections between cells in accordance with the various embodiments of the present invention.

FIG. 172 shows an example of thermally conductive, electrical connections between cells in accordance with the various embodiments of the present invention.

### DETAILED DESCRIPTION OF THE PREFERRED EMBODIMENTS

The present invention includes a variety of aspects, which may be combined in different ways. The following descriptions are provided to list elements and describe some of the embodiments of the present invention. These elements are listed with initial embodiments, however it should be understood that they may be combined in any manner and in any number to create additional embodiments. The variously described examples and preferred embodiments should not be construed to limit the present invention to only the explicitly described systems, techniques, and applications. Further, this description should be understood to support and encompass descriptions tecahe various embodiments, systems, techniques, methods, devices, and applications with any number of the disclosed elements, with each element alone, and also with any and all various permutations and combinations of all elements in this or any subsequent application.

Embodiments of the present invention may include a surface affixment solar power system comprising a photovoltaic layer; a sheet joined to a back of said photovoltaic layer; at least one protuberant limb extending from said sheet; and perhaps even at least one planted limb docking base for said photovoltaic layer configured to securely couple with said at least one protuberant limb when mated with said planted base limb docking support. Other embodiments may include a cooling solar power system comprising a photovoltaic layer; a sheet joined to a back of said photovoltaic layer; a plurality of cooling conductive protuberant limbs extending from said sheet; a thermal conductive layer within said sheet conforming within said protuberant limbs; perhaps even wherein said thermal conductive layer dissipates heat from said photovoltaic layer. Even other embodiments may include connected solar power system comprising a plurality of individual photovoltaic cells; a sheet joined to a back of each of said plurality of individual photovoltaic cells; a thermal conductive layer within said sheet; a plurality of cooling conductive protuberant limbs extending from said sheet; and perhaps even a thermally conductive, electrical connection between said sheet joined to a back of one of said individual photovoltaic cells and a top surface electric current of an adjacent individual photovoltaic cell.

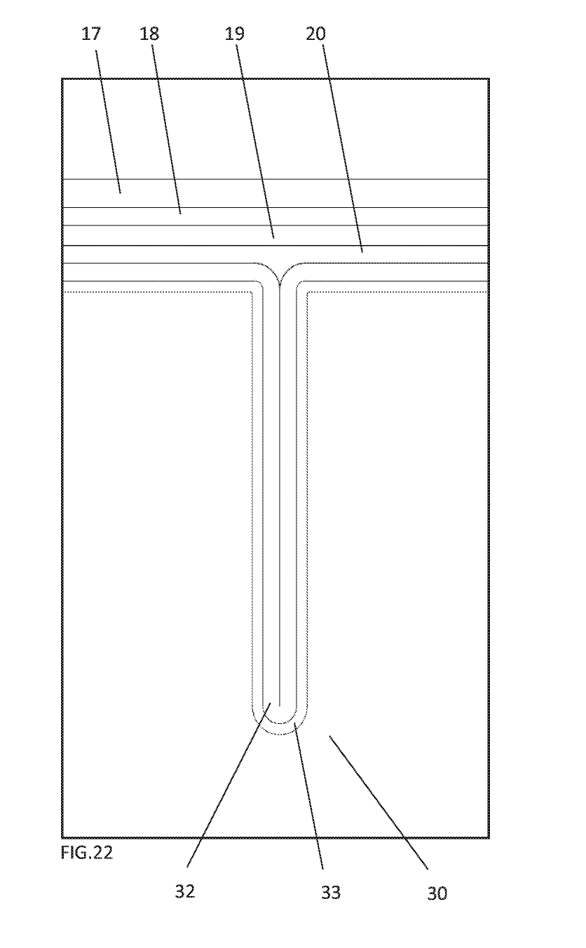

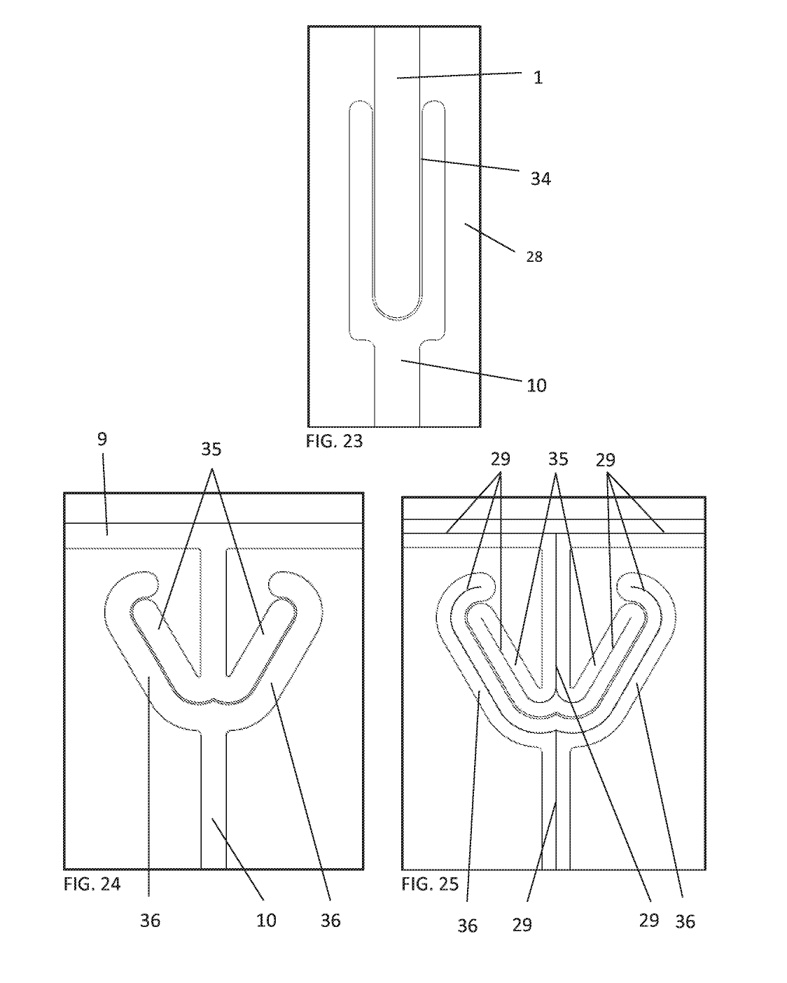

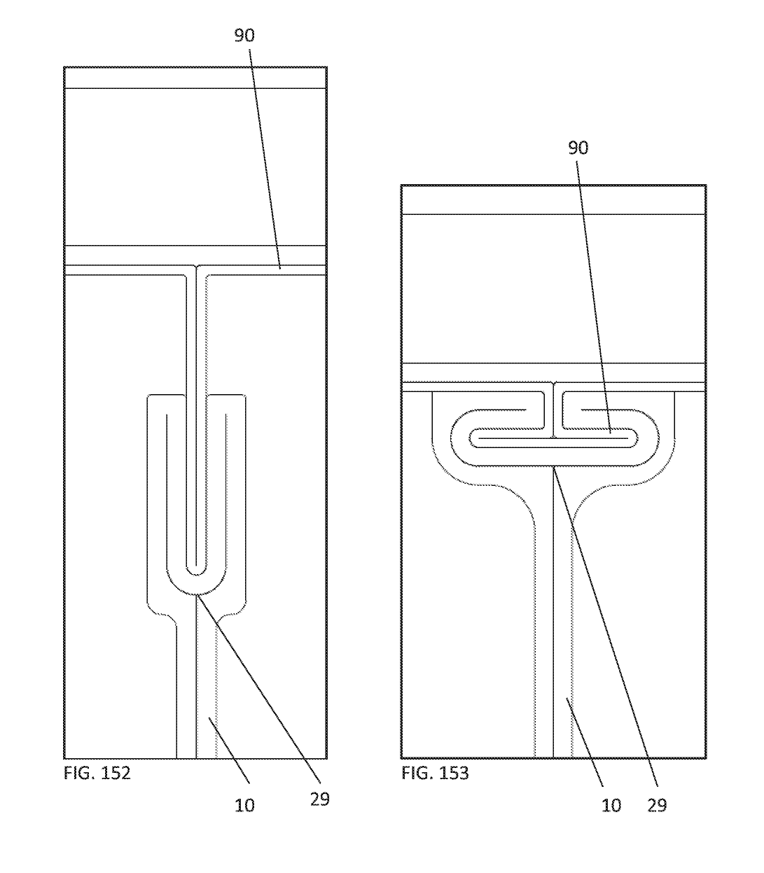

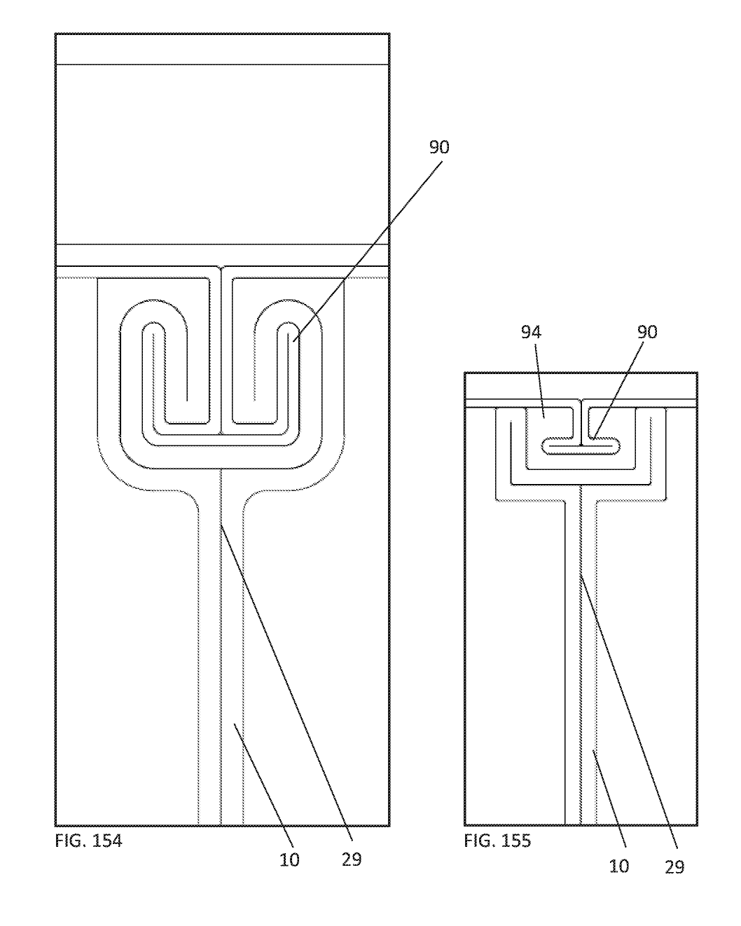

A solar power system may provide an affixment system to attach a photovoltaic layer (19) to a surface such as a roof (43). A surface may include a roof (43), ground, carport, structure, and the like. A photovoltaic layer (19) may be a part of a photovoltaic system which may include additional layers of encapsulants, sheets, and the like. A sheet (22), sometimes herein referred to as a backsheet may be joined to a back of a photovoltaic layer (19). This may include directly joined or even indirectly joined where a sheet may be attached to a layer or layers which may be in between the sheet and the photovoltaic layer (16) such as shown in FIG. 22. There could be any number of layers between the sheet and the photovoltaic layer. At least one protuberant limb (130) which may be herein referred to as a fin, may extend from a sheet (22) such as shown in the non-limiting example of FIG. 17. A protuberant limb may be any kind of extension, bump, curve, projection, or the like from a sheet. Non-limiting examples of a protuberant limb are shown in FIGS. 18, 21, 23-25, and 149-163. A sheet may have at least one protuberant limb, may have at least two protuberant limbs, may have a plurality of protuberant limbs, or the like. Embodiments of the present invention may provide a planted base limb docking support (10) which may be a web support or web support fingers (96), or the like. A planted base limb docking support may be attached to a surface with a surface securement element (65) such as, but not limited to, adhesive, nails, screws (65), or the like. At least one protuberant limb may be capable of mating with at least one planted base limb docking support and may even be capable of securely coupling with at least one planted base limb docking support, non-limiting examples are shown in FIGS. 23-25 and 151-163. For example, one of either a limb or docking support may be a female part that may mate with the other as a complimentary a male part. The limb and docking support may be molded, may be configured to latch to each other, and may be configured to confirm with each other. In some embodiments, the limb and docking support may be attached by an adhesive such as but not limited to glue, cement, bonding material, or the like.

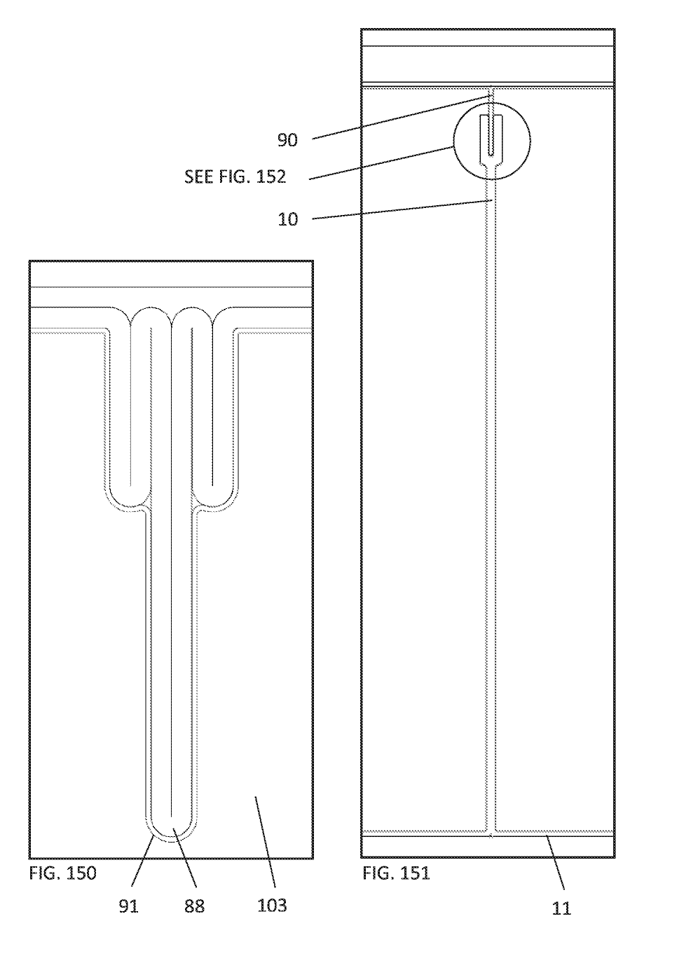

In some embodiments, the present invention may provide a PV cooling system perhaps including a plurality of cooling conductive protuberant limbs extending from a sheet. A cooling conductive protuberant limb may be a protuberant limb (130) with perhaps a conductive layer (32) such as shown in the examples in FIGS. 17 and 22. A conductive layer (32) may be within a sheet (22) that may be joined (directly or indirectly) to a photovoltaic layer (19). A conductive layer may include aluminum, copper, silver, conductive metal, any combination thereof, or the like. A sheet (22) may be a formed sheet, a folded sheet, or the like, an example of which is shown in FIGS. 149-150. A conductive layer may be a thermal conductive layer which may remove heat from a PV layer and dissipate it away from the PV layer. A thermal conductive layer may be substantially integrated within a sheet and may even follow a curvature of a sheet such as shown in the examples in FIGS. 22 and 150. When a sheet is formed perhaps with limbs, folds, protrusions, or the like and a conductive layer is formed within the formed sheet, it may allow for increased dissipation of heat away from the PV layer.

The present invention may provide, in embodiments, connection systems between photovoltaic cells. A thermally conductive, electrical connection (113) may be provided which may attached between a sheet (22) joined (directly or indirectly) to a back (or bottom) of a PV cell (112). The electrical connection (113) may electrically attach the bottom of one solar cell (112) to the top surface of an adjacent cell perhaps through a top surface electrical current (110) (perhaps even with contact fingers) of an adjacent PV cell. A connection may allow heat dissipation from the cells. A thermally conductive, electrical connection (113) may be a formed conductive layer as discussed herein. In some embodiments, this connection may provide both heat dissipation and electrical connections between cells. A sheet may be thermally conductive sheet.

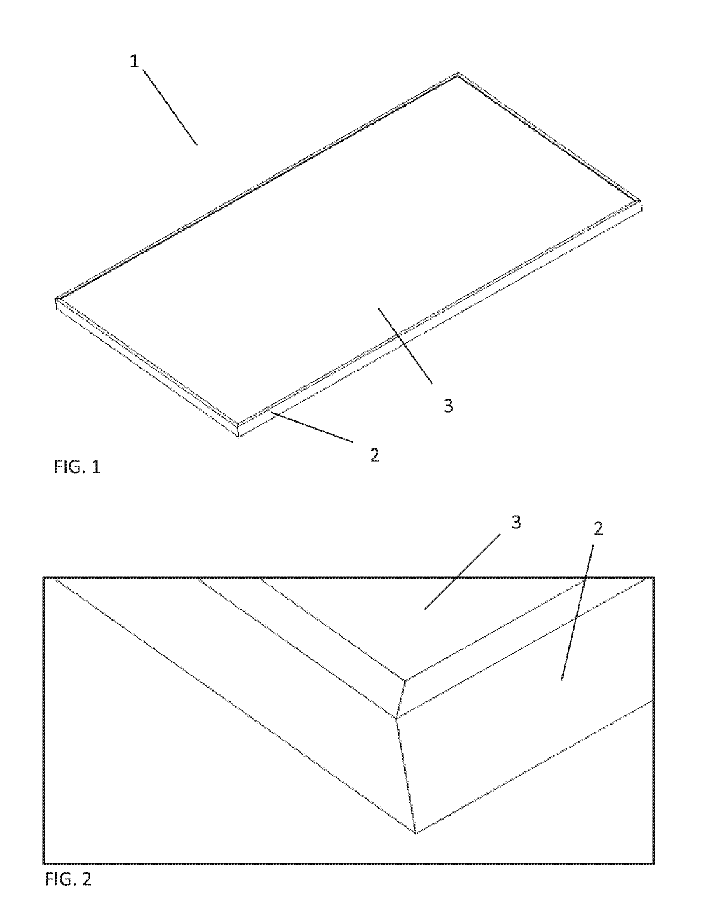

FIGS. 1 and 2 shows a traditional solar panel (1) used in the solar industry. The strength of a traditional solar panel (1) may result from a frame (2) and a standard PV laminate (3). A top of the standard PV laminate (3) may typically be made of tempered glass which may add to the weight. A standard PV laminate (3) may also contain bottom glass and may or may not include a frame (2). In either case, the traditional solar panel (1) may be high in weight perhaps in order to achieve the strength needed to meet industry standards. The larger standard solar panel (1) may require more than one person to carry and even install the solar panel.

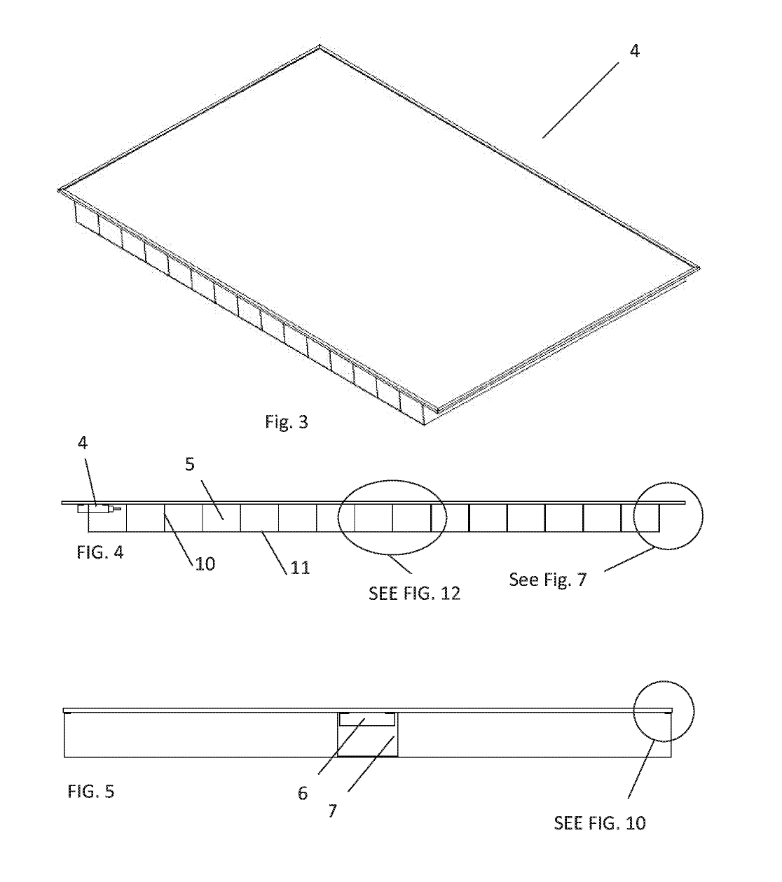

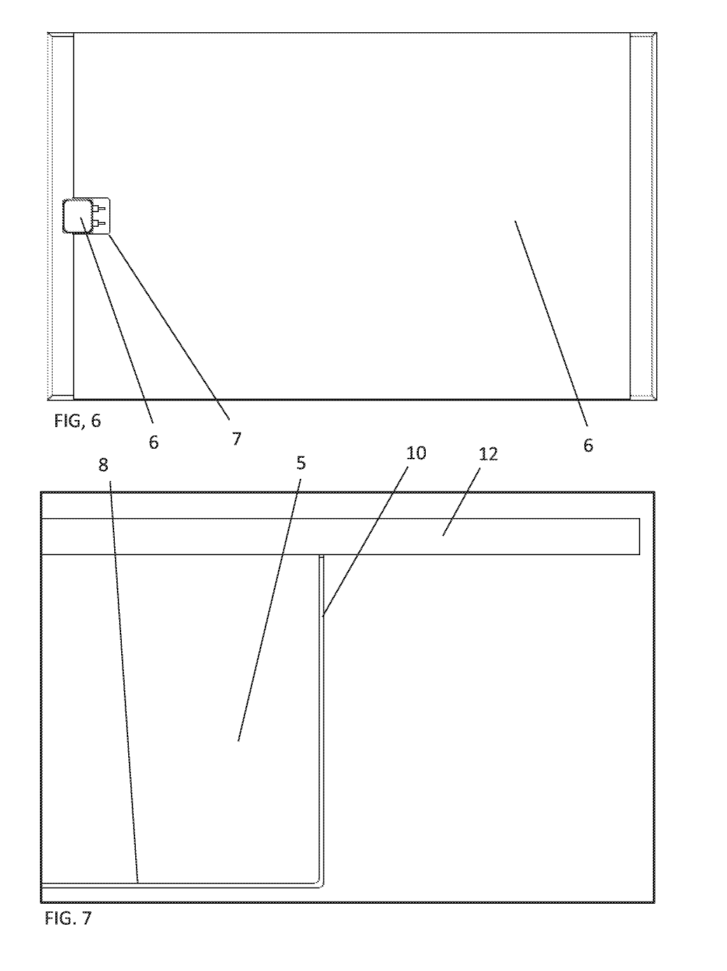

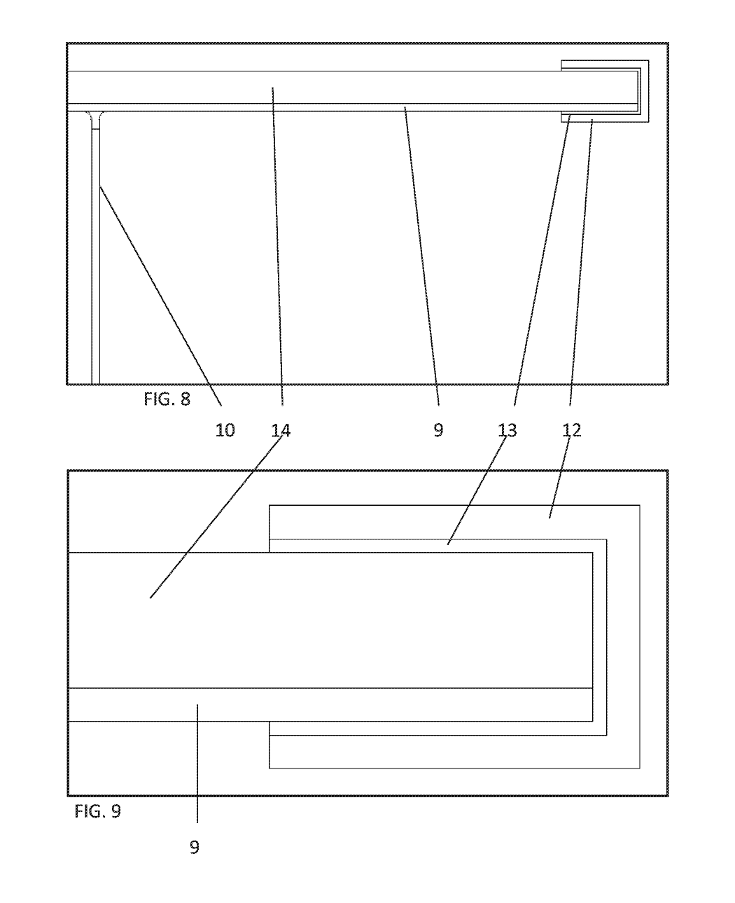

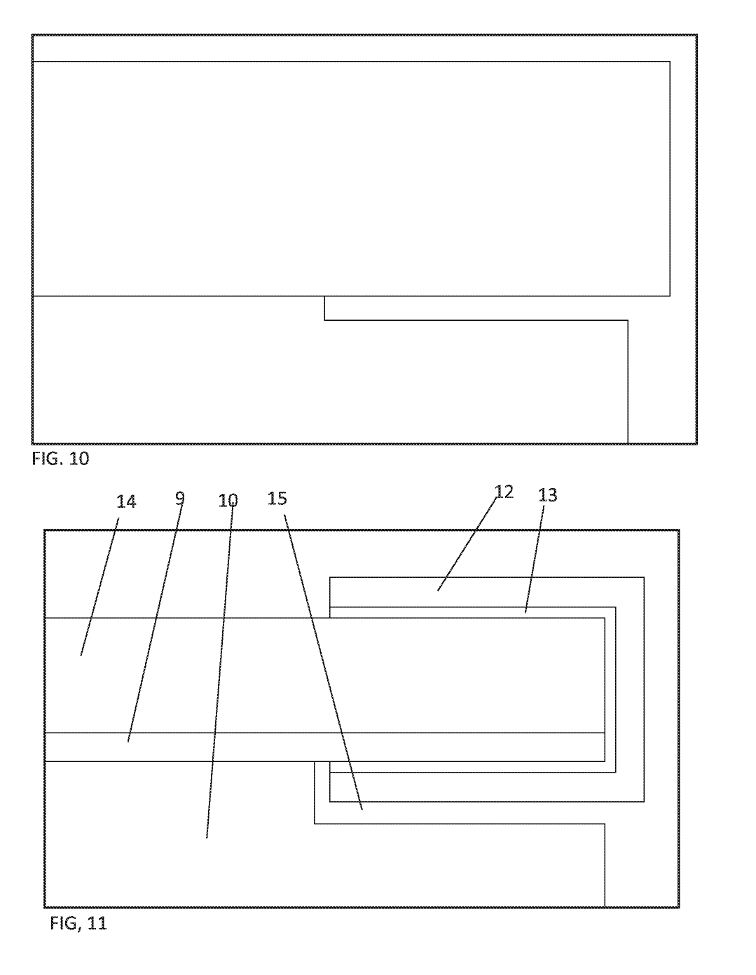

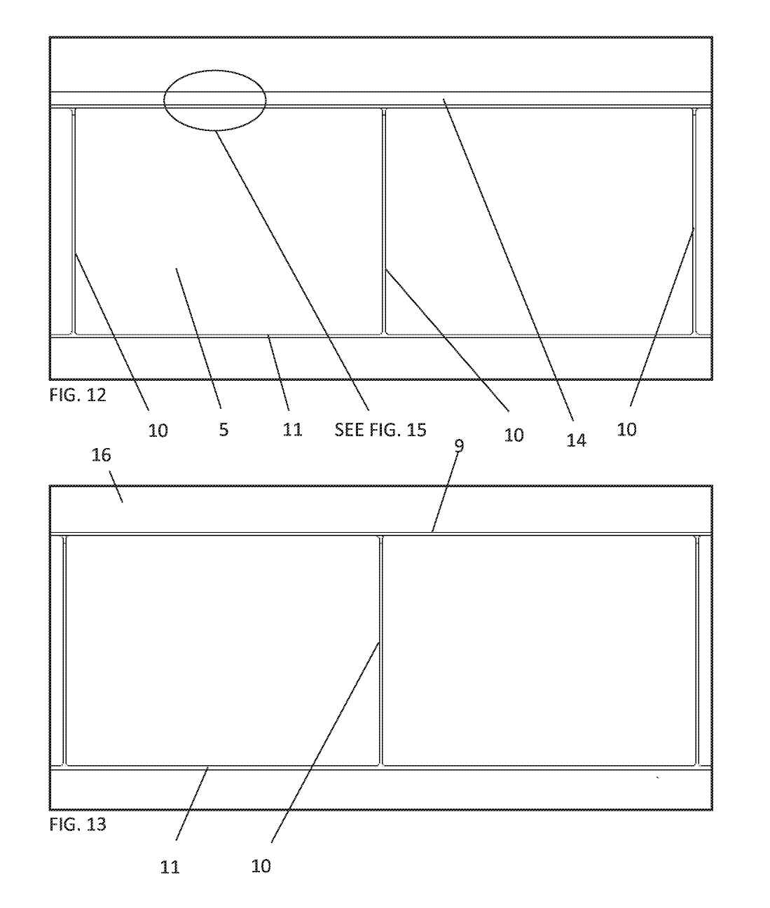

Embodiments of the present invention provide a back supported solar panel (4) which may include a PV layer, a PV cell, or the like. FIGS. 3 to 15 show an example of a back supported solar panel (4). Referring to FIGS. 4, 12 and 13, the high strength of a back supported solar panel (4) may come from a laminate (14), the top support (9), the bottom support (11), and the web support (10), or the like. The top support (9), the bottom support (11), and even the web support (10) can be thin. A separation of between a top support (9) and a bottom support (11) perhaps by a web support (10) may greatly increase the strength of a back supported solar panel (4). A laminate (14) may greatly strengthen perhaps by continuous support by a laminate back support (16).

A laminate back support (16) can be made with, but is not limited to, a reinforced fiber polymer which may make it strong and even light. The support may be, but is not limited to, a fiberglass, UV resin, or even fiber polymer composite, or the like. The fiber may be, but is not limited to, woven matte, fiber cloth, random fiber, or the like. A laminate back support (16) can be made with, but is not limited to, a metal such as aluminum, other metal, or the like. A metal could be heavier than the polymer. Besides weight, an advantage of the polymer may include that it is non-conductive where grounding may not be necessary.

FIGS. 4, 5 and 6 show an electronic enclosure (6) and the electronic enclosure cut out (7). An electronic enclosure (6) may be a junction box, power optimizer, or inverter. The electronic enclosure cut out (7) is not necessary if the electronic enclosure (6) is smaller.

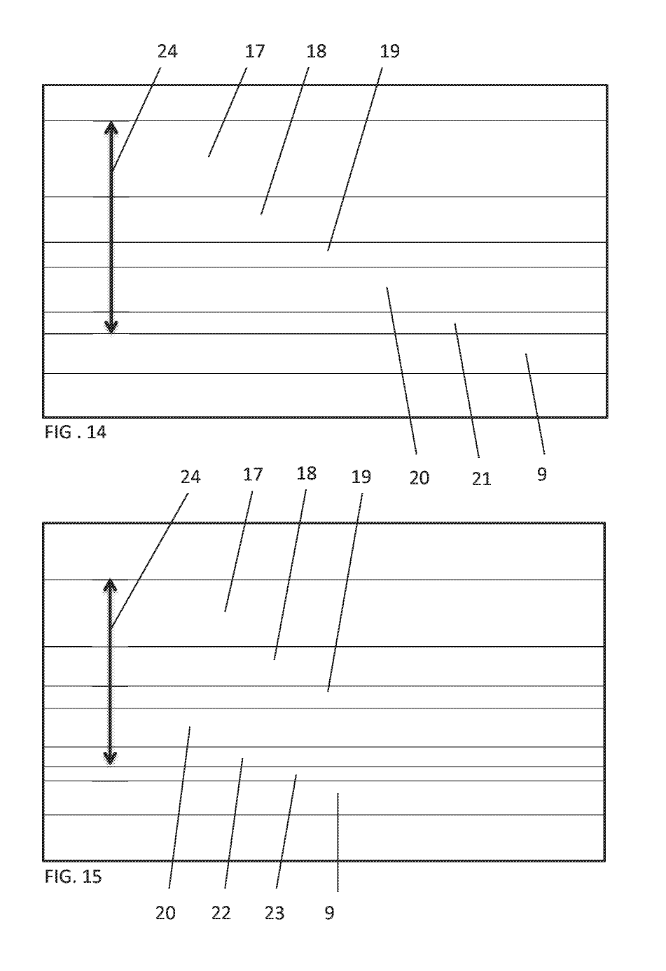

FIGS. 4, 7 to 11, show details on the laminate frame seal (12). This seal may not be required perhaps if the distance of the PV layer (19) may be sufficient with the type of top encapsulant (18) or even a bottom encapsulant (20) used such as shown in FIGS. 14 and 15. FIG. 11 shows examples of a laminate frame seal (12) and a laminate seal (13) around the edge of the laminate (14) and even a top support (9). Shown also is a web relief (15) perhaps to allow clearance for a laminate frame seal (12). A web relief (15) may not be required perhaps if a top support (9) was shortened.

Air channels (5), examples of which are shown in FIGS. 5, 7, 12 and 13, may allow air to flow under a top support (9), perhaps to help cool the PV layer (19). In some embodiments, if the back supported solar panel (4) is at an angle to perhaps horizontal, a chimney effect can help pull the air through the air channels (5).

FIGS. 14 and 15 show possible layers that may be above the top support (9). In FIG. 14, a barrier layer (21) may be necessary perhaps if a bottom support is not adequate to keep moisture from the PV layer (19). The bottom encapsulant (20) may be fiber filled perhaps for strength or may be electrical insulation from the PV layer (19) perhaps if the barrier layer (21) is an electrically conductive layer. If the barrier layer (21) is aluminum, perhaps making it a thermal conductive layer (21), which is an excellent thermal conductor, then heat can be better dissipated from the PV layer (19). A top encapsulant (18) could also have fiber fill perhaps for strength. This may be beneficial if the front layer (17) is a clear polymer perhaps instead of tempered glass. For weight, a polymer may be desired for the front layer (17).

It may be beneficial, if all the layers such as but not limited to a bottom support (11), barrier layer (21), bottom encapsulant (20), top encapsulant (18), and even the front layer (17), are good thermal conductors. Additives can be added to polymers to increase the thermal conduction. There are companies that make these products. Also, keeping the thickness of these layers may help with the heat dissipation.

The above discussion for the same layers in FIG. 15 may apply. FIG. 14 may be for adding the layers in sequence on a bottom support (11). FIG. 15 may show how a full laminate (24), can be made first and then attached to the bottom support (11), with an adhesive top support (23).

A full laminate (24), such as shown in FIGS. 14 and 15, may normally be for the PV layer (19), which may be PV solar cells. A laminate (24) could also be thin film or any PV active material. Some of the layers shown in FIGS. 14 and 15, may need to have treated surfaces and/or have a very thin film of the adjacent layer perhaps for high adhesion. This is not shown in the layers but could apply if necessary.

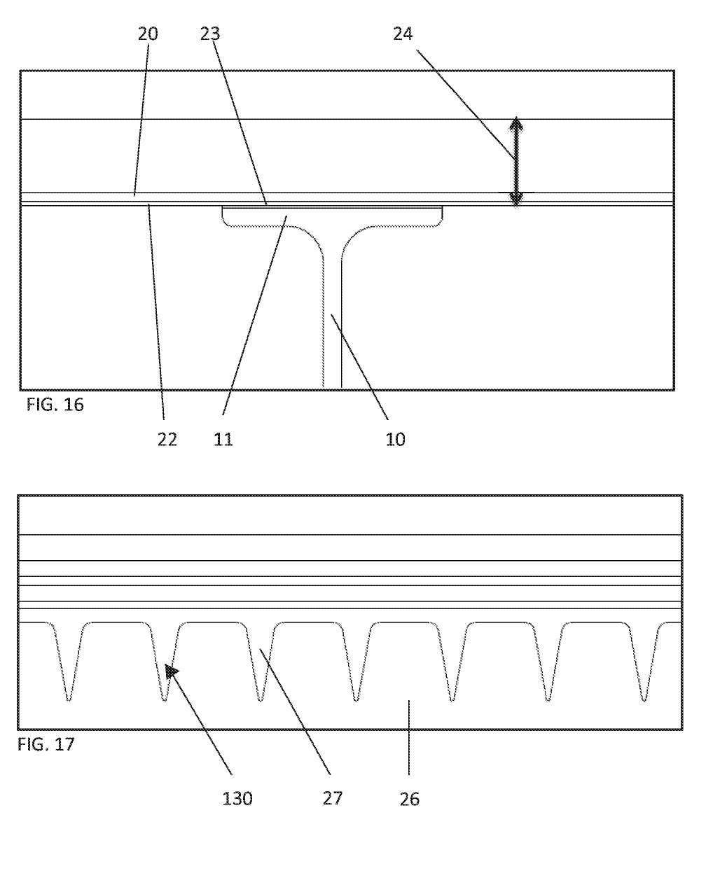

FIG. 16 shows an example of a partial bottom support (11) that may be attached to the backsheet (22) perhaps with an adhesive top support (23). Like FIG. 15, this may allow a full laminate (24) and even a laminate back support (16) to be made separately and then may be adhered together later. This could be done at a manufacturing facility, intermediate facility, or in the field, or the like. Of course, alternative embodiments may provide the support to be formed as one.

To increase a heat flow away from the PV layer (19), top support fins (27) or the like could be added as shown in FIG. 17. This heat dissipation may be more effective if the finned top support (26) is a good thermal conductor. In FIGS. 21 and 22, a thermally conductive layer (32) may be added to perhaps help draw out the heat. A thermally conductive layer (32) can be, but is not limited to, aluminum or the like.

FIG. 18 shows an example of a web support (10) attached at a web support joint (28). This may allow a top support (9) and perhaps a top of the web support (10) to be a different material than a bottom support (11) and perhaps the bottom of the web support (10). These materials could have different thermal properties. In general, higher thermal polymers may be more expensive than lower thermal polymers. This may also allow a top and bottom to be made at different operations.

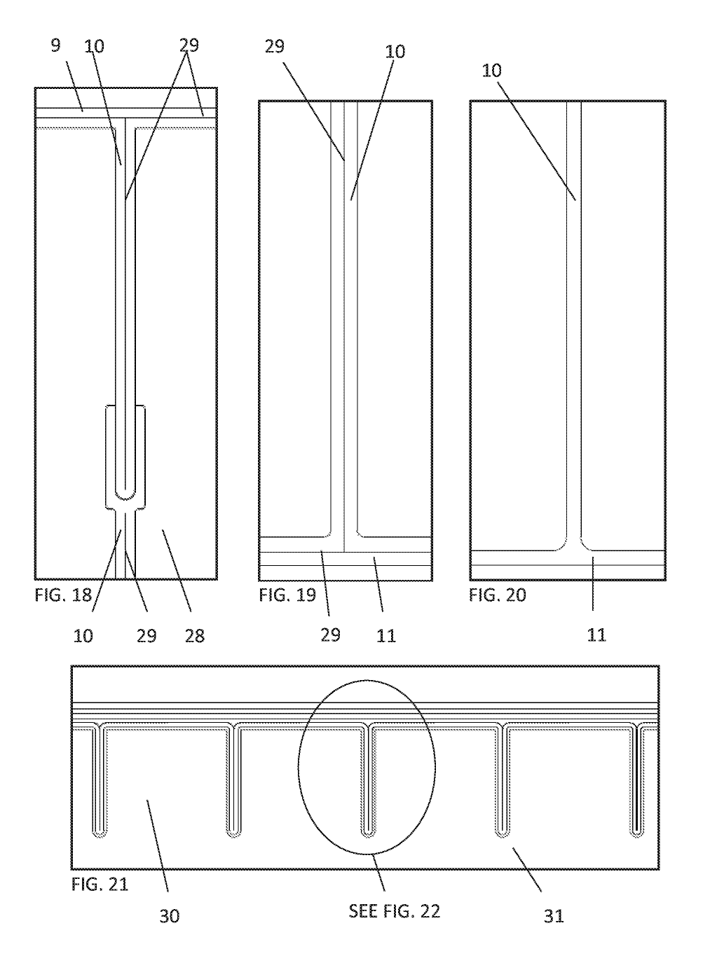

Layer lines (29), such as shown in FIGS. 18 and 19, may indicate that the supports can be made in layers, which may make manufacturing easier. As discussed herein, a support structure can be made with or without layer lines (29).

FIG. 22, shows a conductive layer top support (30) perhaps with a thermally conductive layer (32), and even a shaped top support (33). This may allow manufacturing of the thermally conductive layer (32) and even shaped top support (33), before a bottom encapsulant (20), PV layer (19), top encapsulant (18), and perhaps even a front layer (17) may be put on. A full laminate (24) could also be attached to the previous manufactured thermally conductive layer (32), and may be a shaped top support (33) perhaps using an adhesive top support (23) such as shown in FIG. 16.

FIG. 23 may be similar to FIG. 18, but two web supports (10) may be attached by an adhesive web support, 34, perhaps instead of being formed together.

FIGS. 24 and 25 may show how a protuberant limb and a docking base may be snapped together. In some embodiments, the may apply to a top support (9) and a web support (10) that can be snapped together. By pressing down on a top support (9), the top fingers (35) may compress inward and the bottom fingers (36) may expand outward perhaps until they snap back as show in the examples in FIGS. 24 and 25.

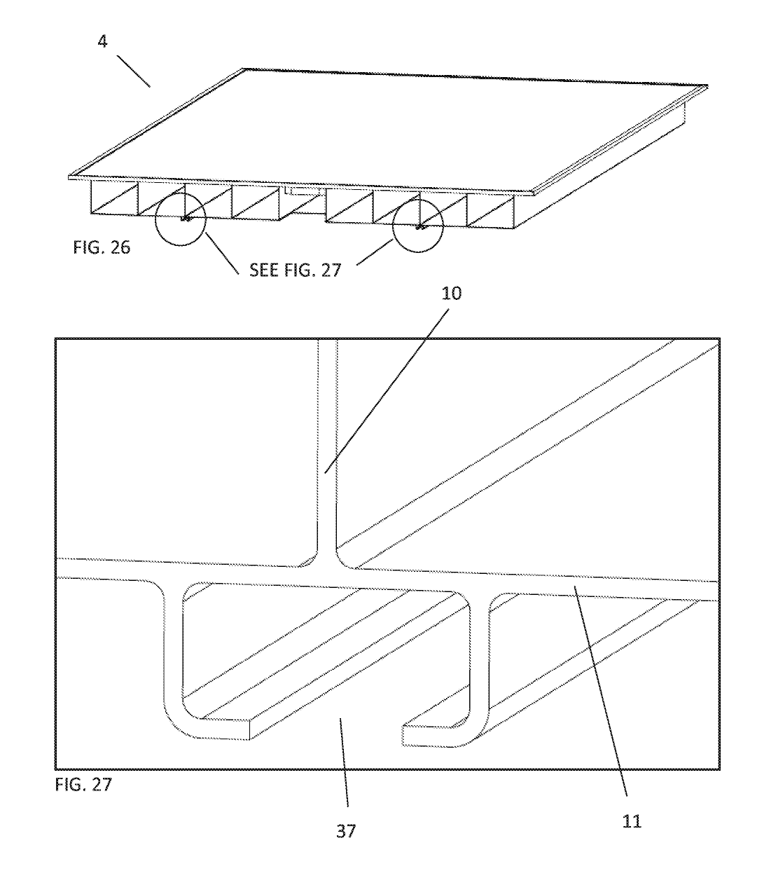

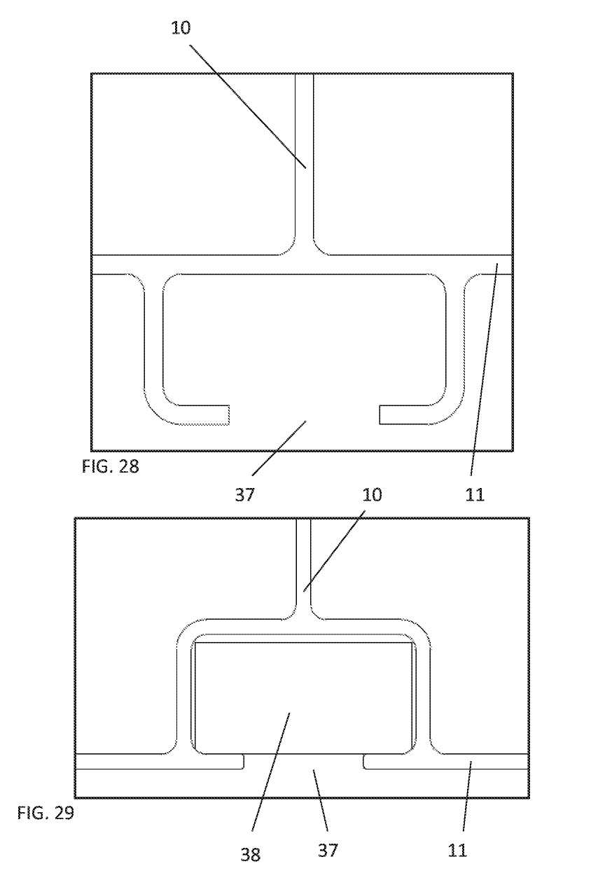

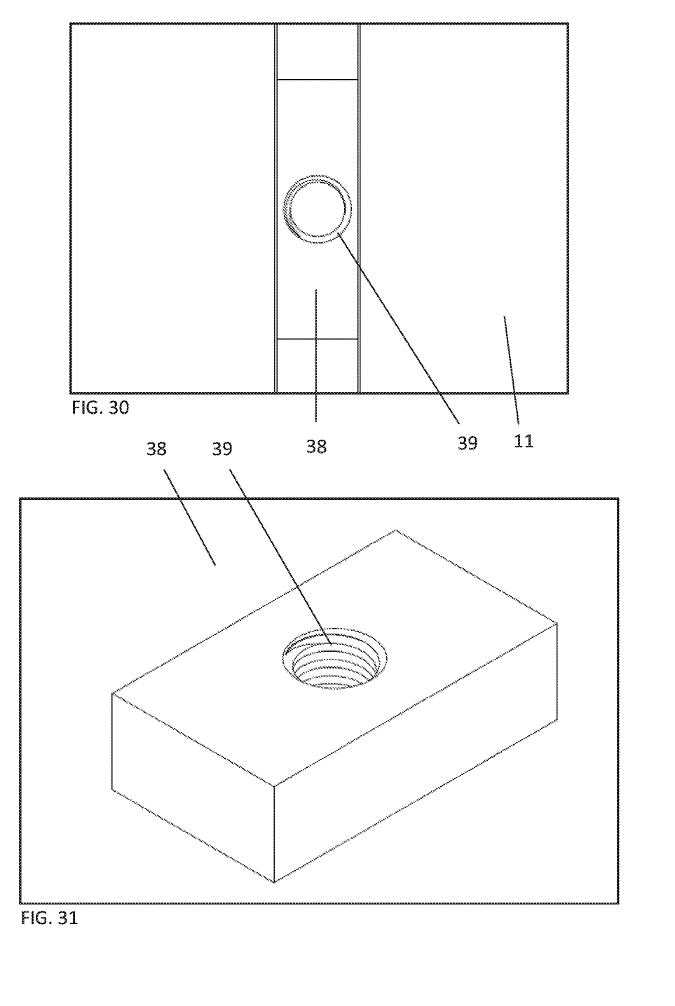

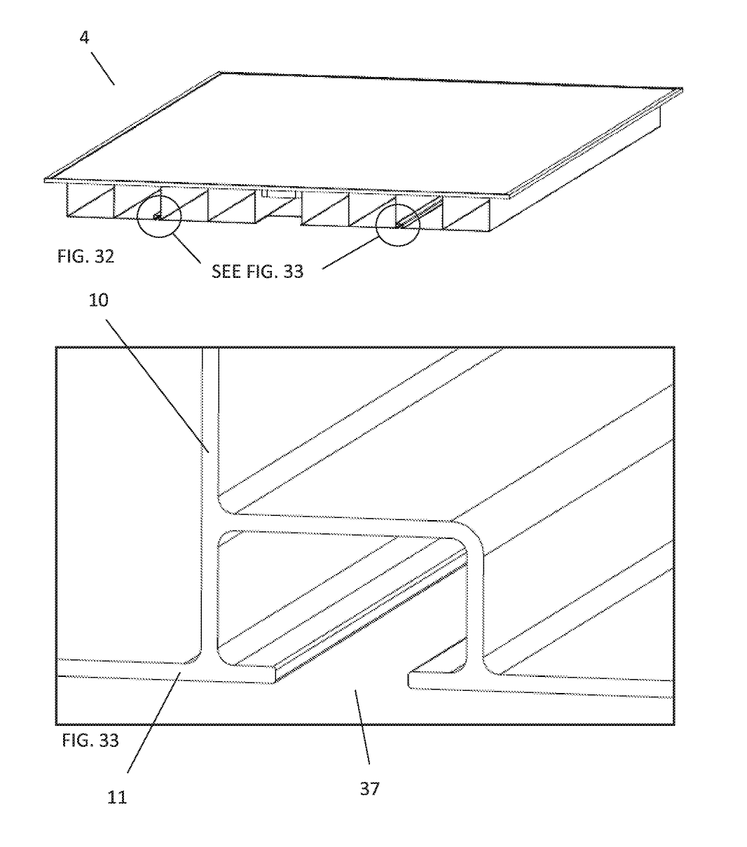

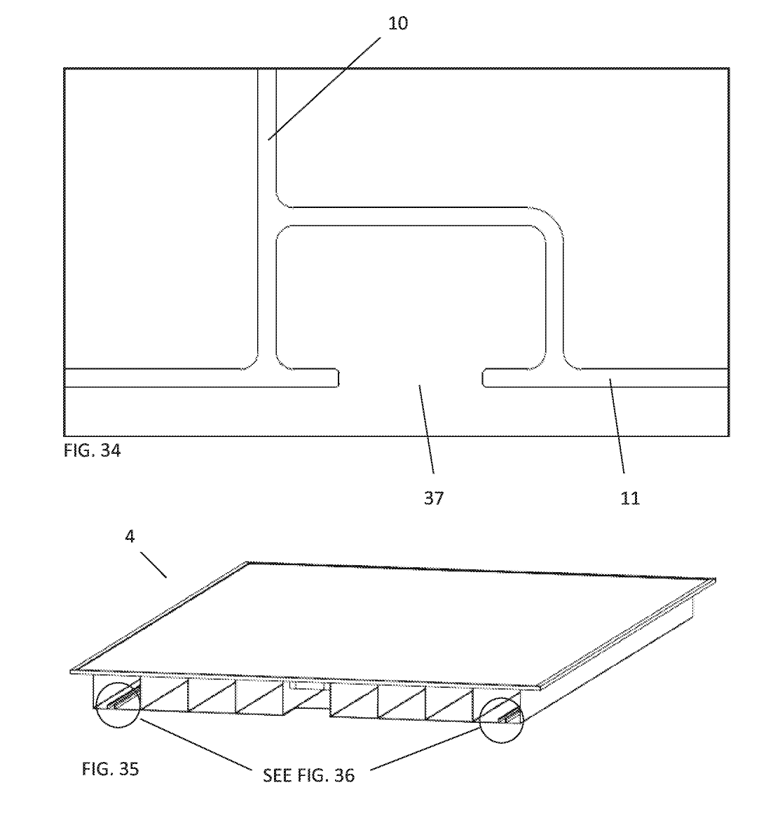

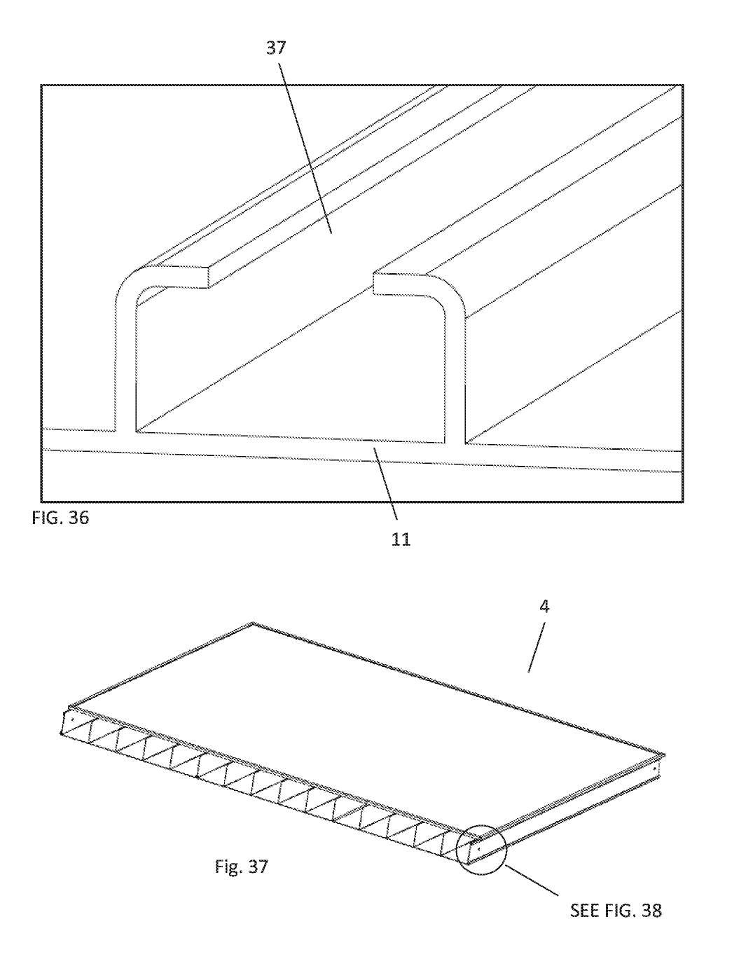

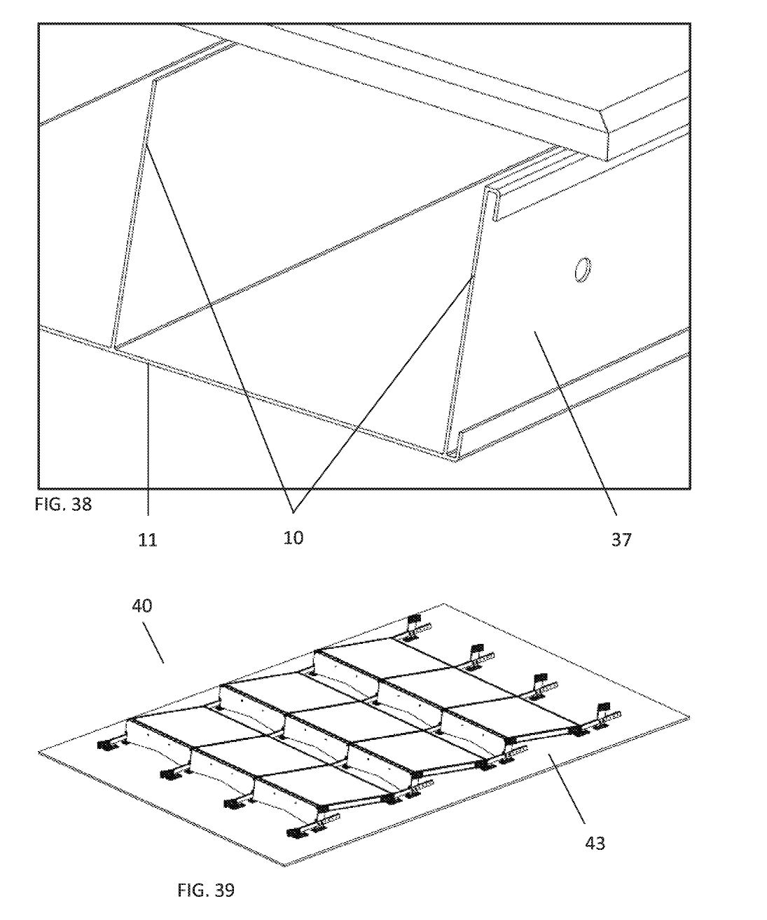

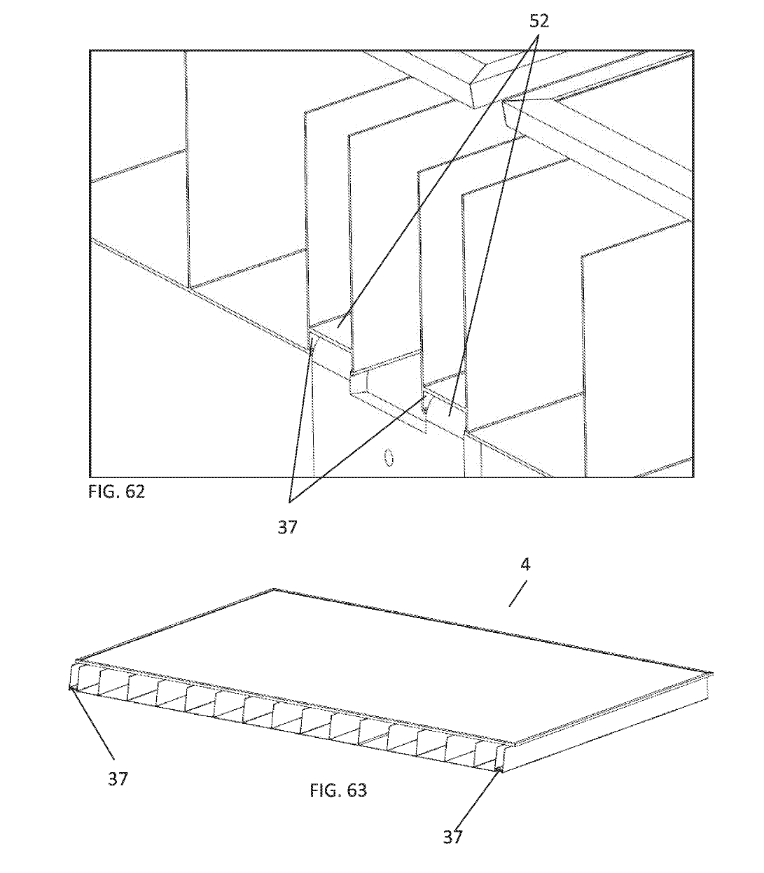

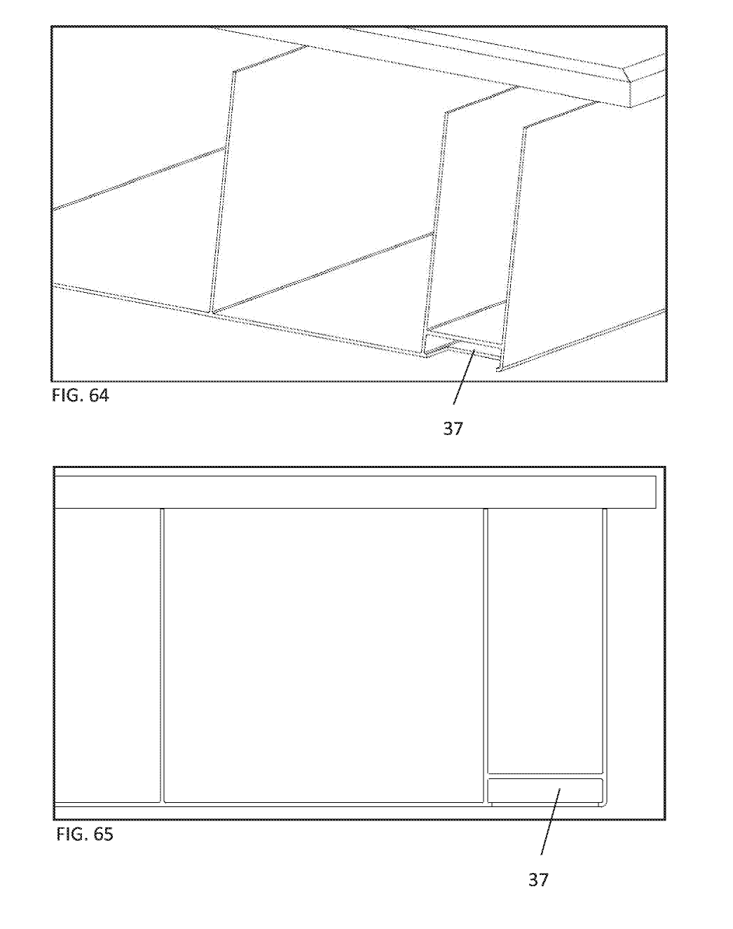

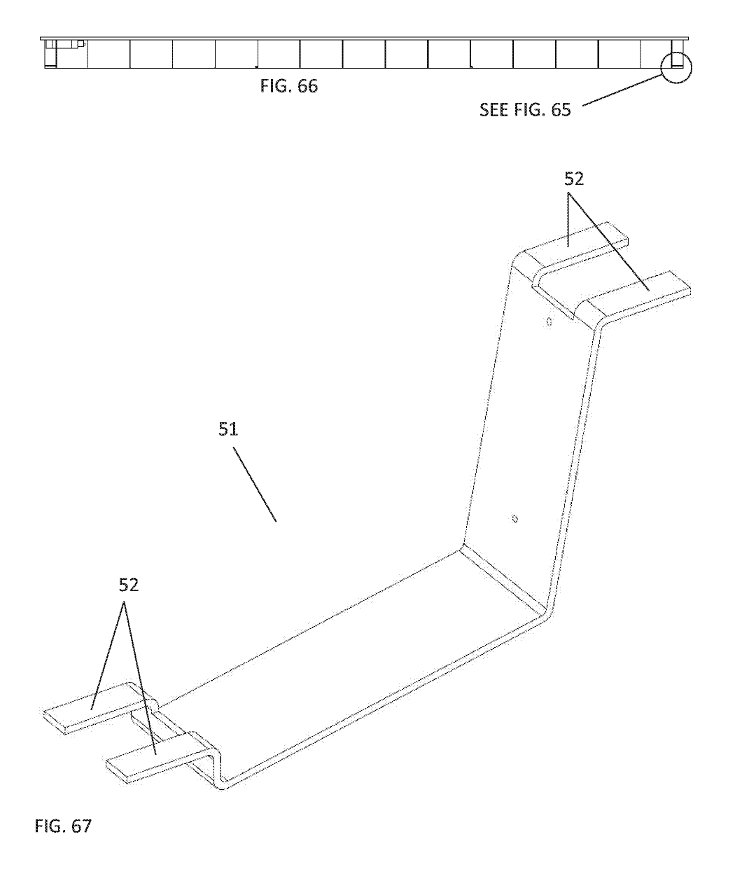

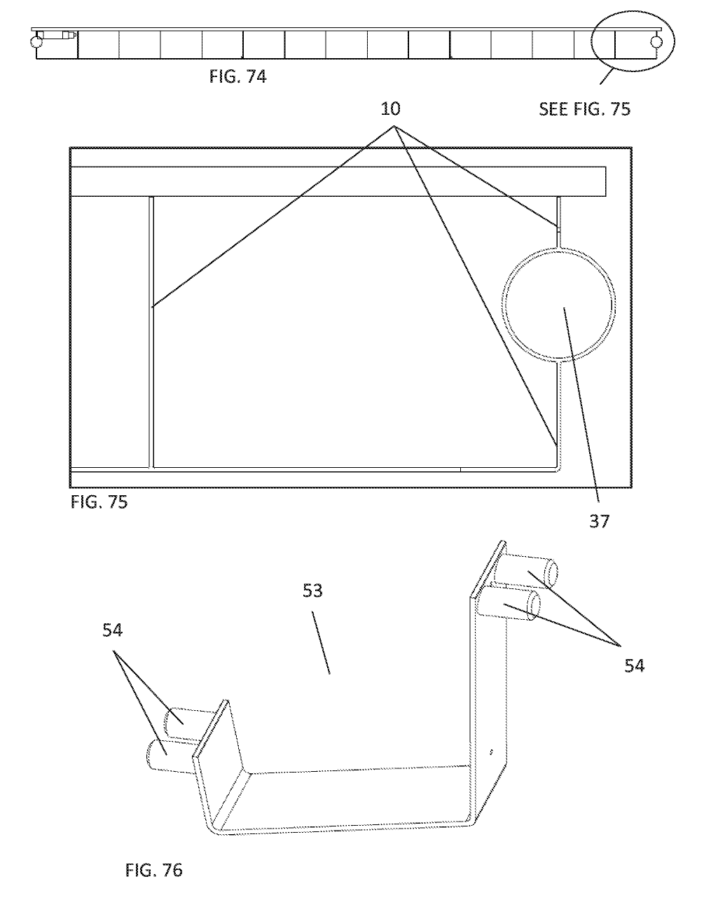

FIGS. 26 to 38, 48, 62, 64, 65 and 74 show examples of some different attaching channels (37) which may be used to attach a back supported solar panel (4) to each other or to other racking or racking parts, or the like. Examples of using some of these attaching channels (37) will be discussed further herein. Of course, attaching channels (37) and use thereof, are not limited to the examples shown.

FIGS. 29 to 31 show an example of a bar nut (38) with a bar nut thread (39) which can be used in an attaching channel (37). A bar nut thread (39) can be a stud or any other type of fastening feature, or the like. A bar nut (38) can also be a different attachment device that may fit in attaching channels (37).

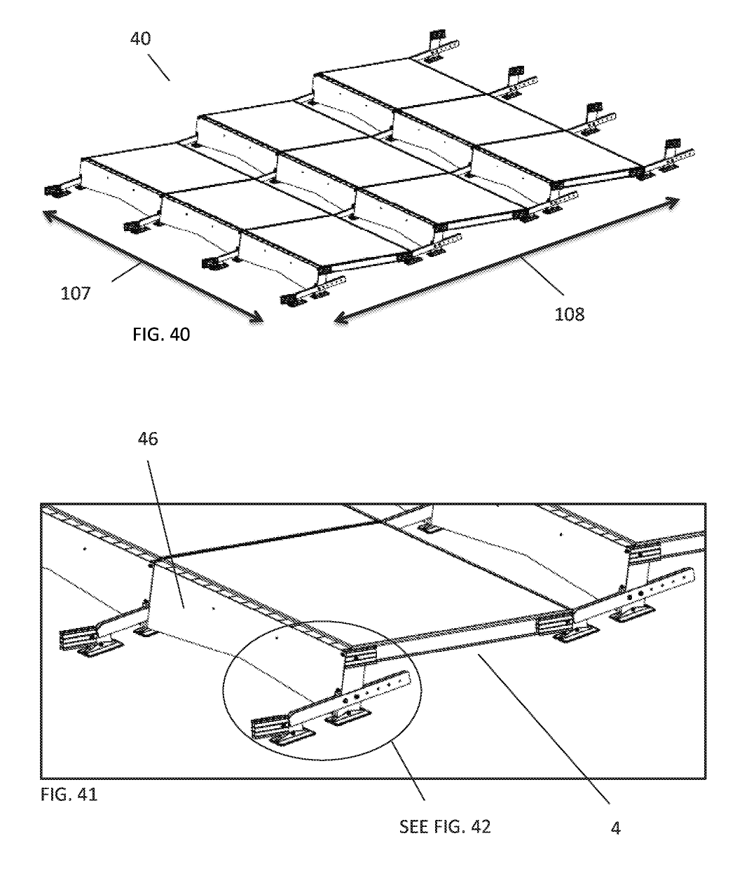

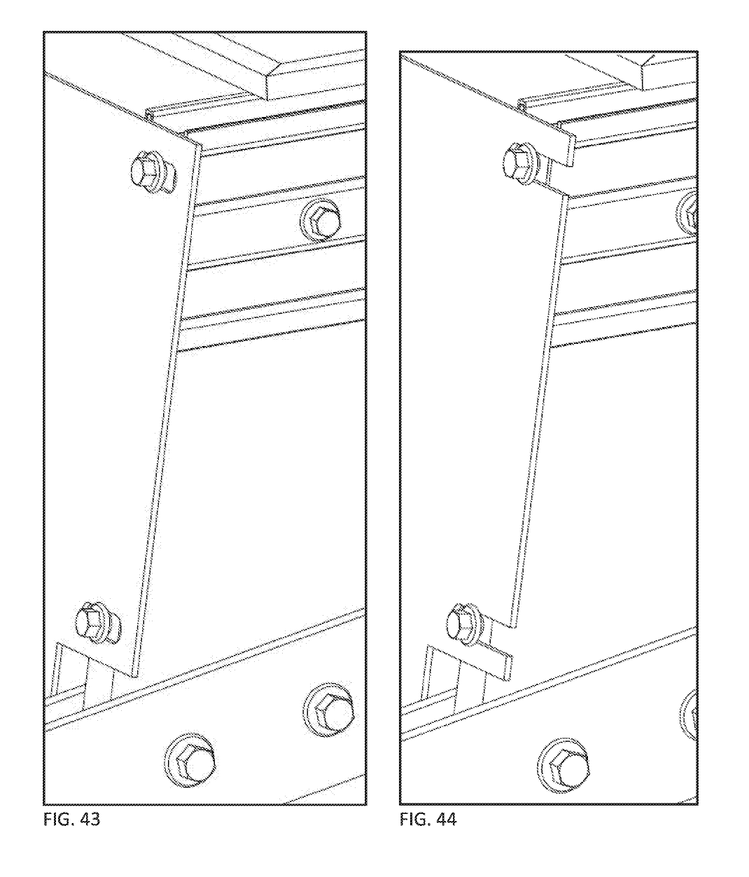

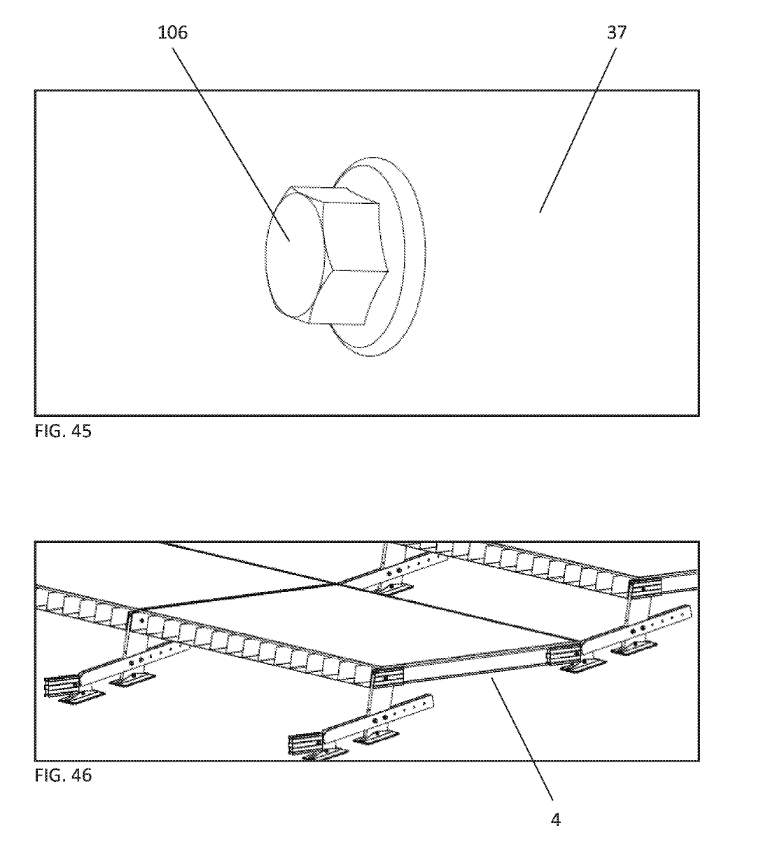

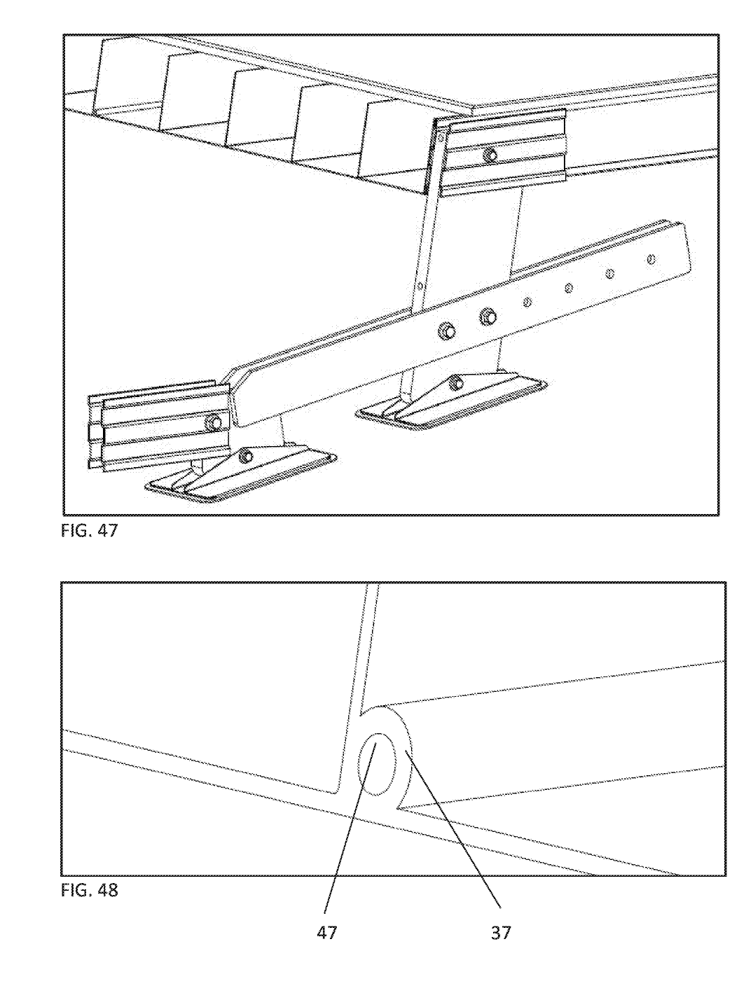

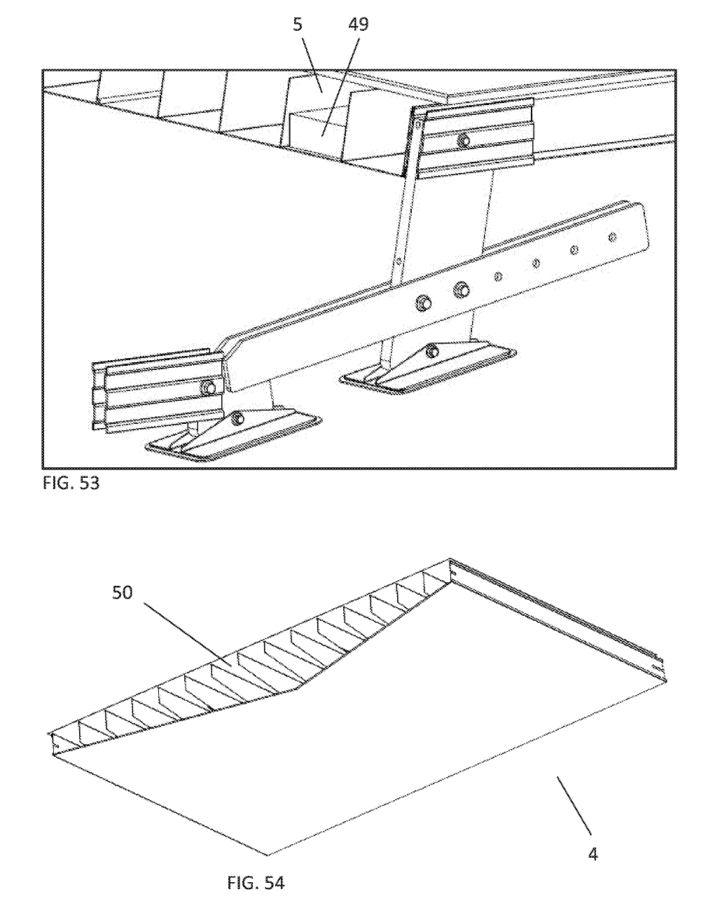

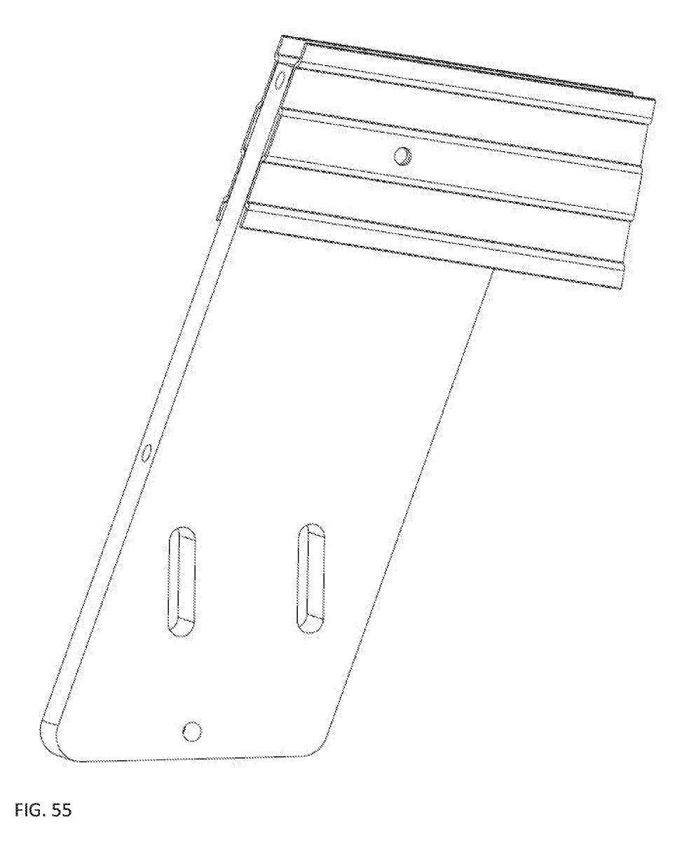

FIG. 39 shows an example of one type of flat roof PV mounting system (40). FIGS. 40 to 55 show more details of this system. FIG. 40 may be similar to FIG. 39 but with a flat roof (43) removed.

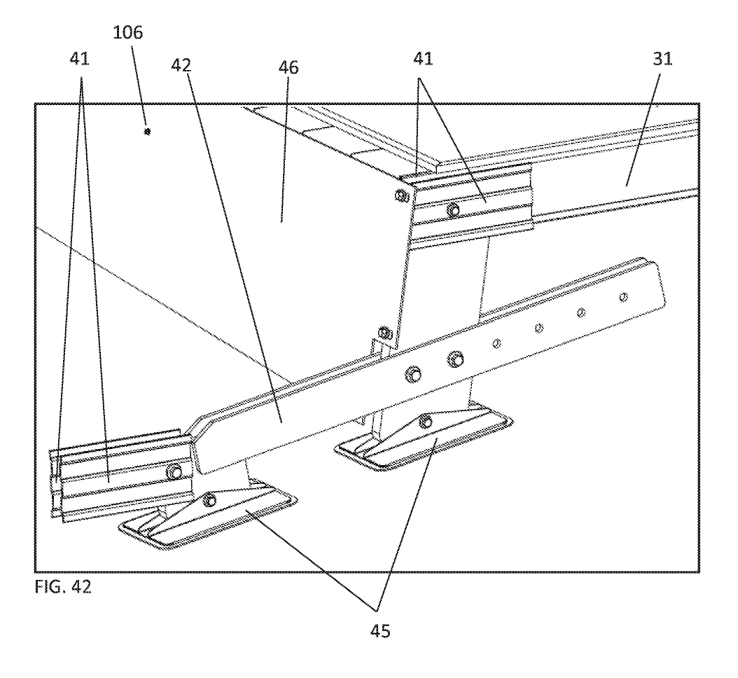

FIG. 42 shows an example of a the wind deflector bolt (106) that may screw into attaching channels (37) and perhaps even an channel thread (47) as shown in FIG. 48.

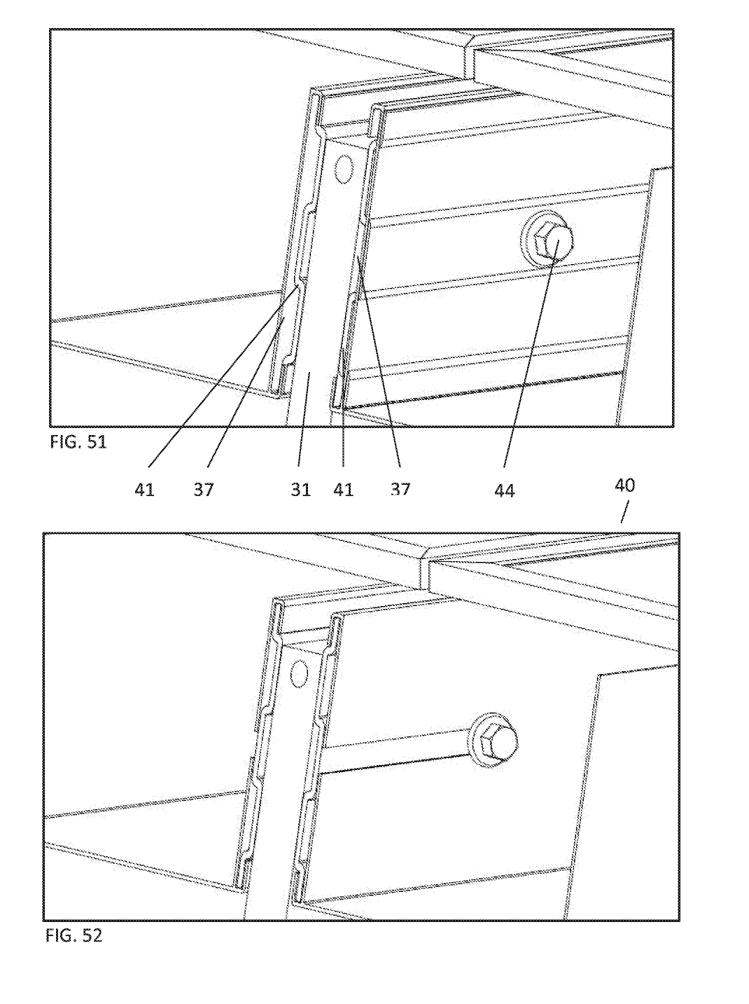

FIGS. 42-44, and 49-52 show an example of how an attaching channel (37) may be used to attach back supported solar panels (4) together perhaps in a row direction (107) using joining plates (41) and even adjustable joining linkage (42). In FIGS. 51 and 52, two adjacent back supported solar panels (4) may be attached together with joining plates (41) perhaps inserted into the attaching channels (37) and even a joining plate bolt (44) through the upper panel support (31).

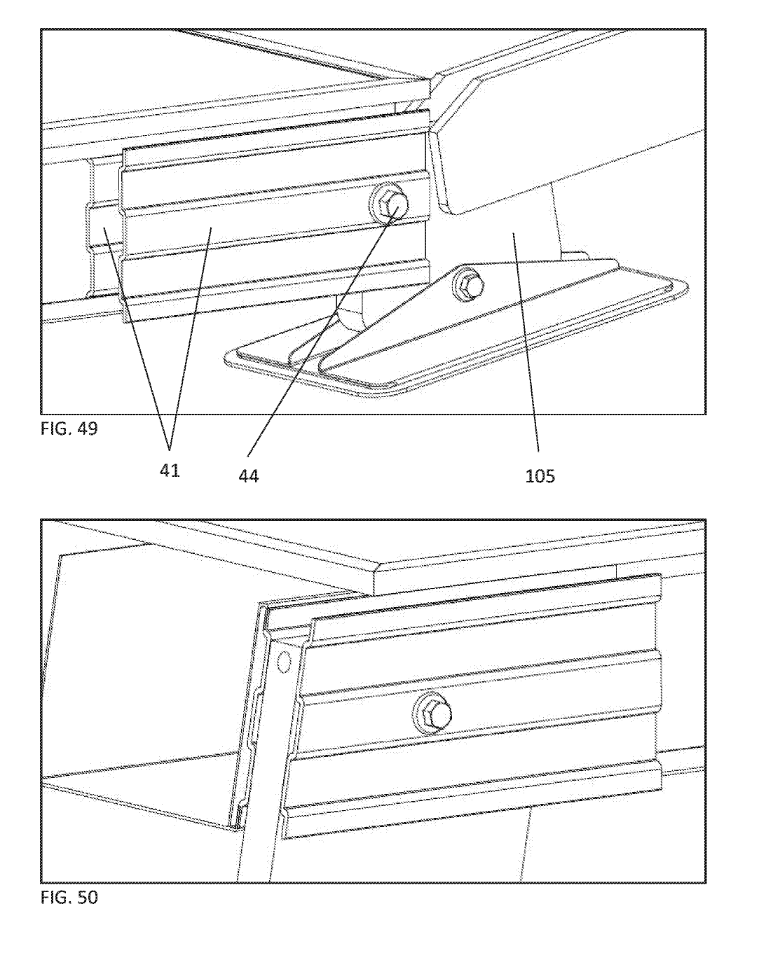

Similarly, in FIG. 49, two adjacent back supported solar panels (4) may be attached together with joining plates (41) inserted into the attaching channels (37) and a joining plate bolt (44) through the lower panel support (105). In FIG. 49, only one back supported solar panel (4) is used with the same technique. See FIG. 46 for additional information.

FIGS. 40, 41, and 46, show an example of back supported solar panels (4) together in a row direction (107) perhaps using joining plates (41), adjustable joining linkage (42), an upper panel support (31), and even a lower panel support (105).

Shown in FIGS. 49 and 51, a joining plate bolt (44) may hold a joining plate (41) in the attaching channel (37). Holding the joining plate (41) in the attaching channel (37) can also be accomplished with a snap latch or the like perhaps when the joining plate (41) may be inserted in the attaching channel (37).

Before the joining plate bolt (44) may be tightened, such as in FIGS. 49 and 51, the joining plates (41) can rotate perhaps in a column direction (108) to allow for uneven flat roof (43). The pivoting feet (45) can also pivot for the uneven flat roof (43) as shown in FIG. 42.

Clearance between the joining plate (41) in the attaching channel (37) can also allow some movement in the row direction (107) for an uneven flat roof (43).

For severe uneven roofs it may be necessary to cut out a section on the back supported solar panel (4) perhaps as shown as the cut area (50) in FIG. 54. Ballast (49) can be added in the air channels (5) as shown in FIG. 54. An attaching channel (37) perhaps for a wind deflector bolt (106) may further attach the wind deflector (46) to the back supported solar panel (4). This may also further strengthen a supported solar panel (4).

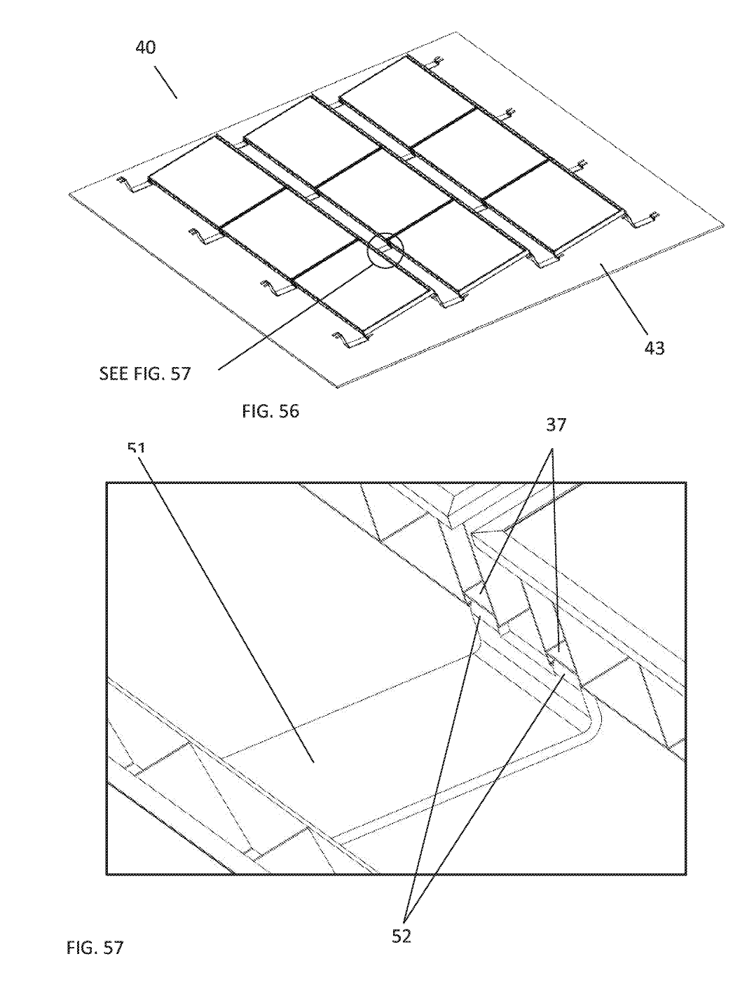

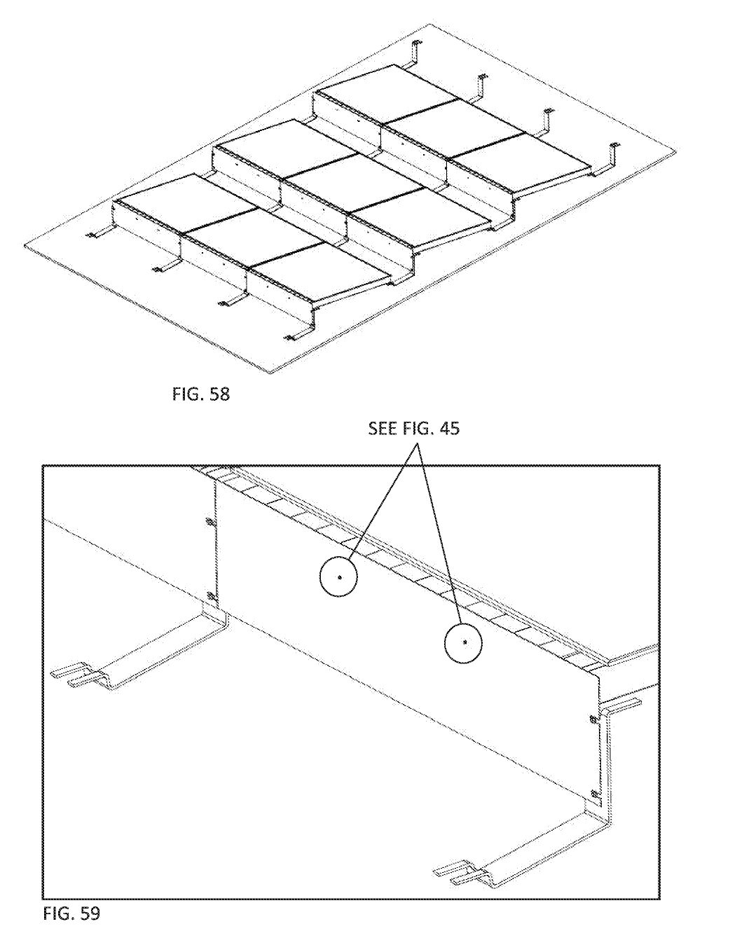

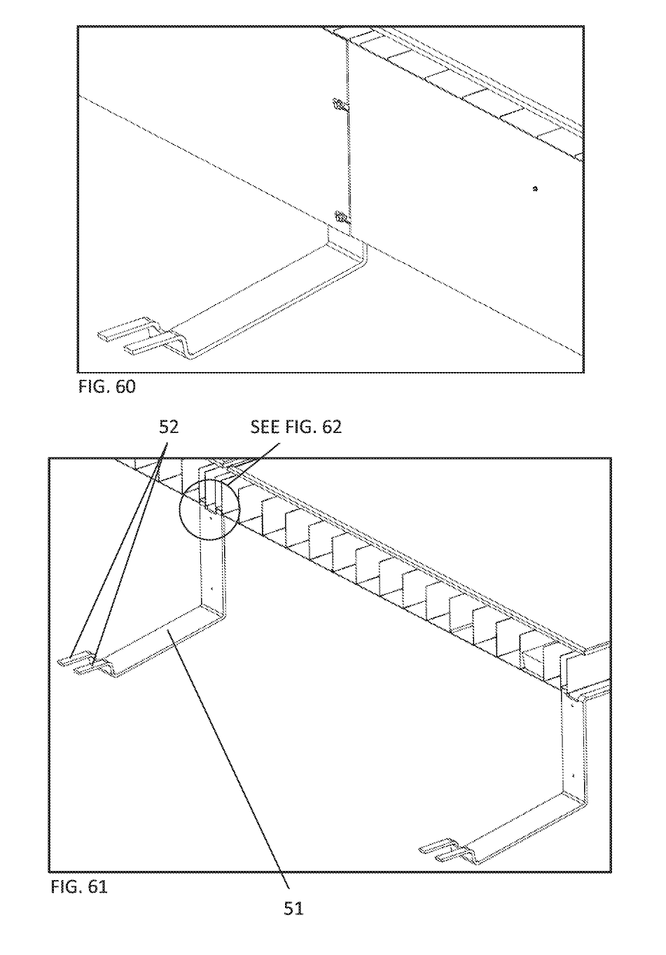

FIG. 56 shows another type of a flat roof PV mounting system (40). FIGS. 57-65 show more details on this system. A flat roof PV mounting system (40) may use a simpler method of joining back supported solar panels (4) together. A joining link (51) may attach the back supported solar panels (4) together in a row direction (107) and perhaps even a column direction (108).

FIGS. 57, 61, 62, 64, 65, 66, and 67 show an example of a position of the joining link (51), and an example of an insertion of the joining link fingers (52) in the attaching channels (37) perhaps located in the back supported solar panels (4). The joining link fingers (52) can be held in place in the attaching channels (37) perhaps by fasteners or a snap latch or the like, when the joining link fingers (52) may be inserted in the attaching channel (37).

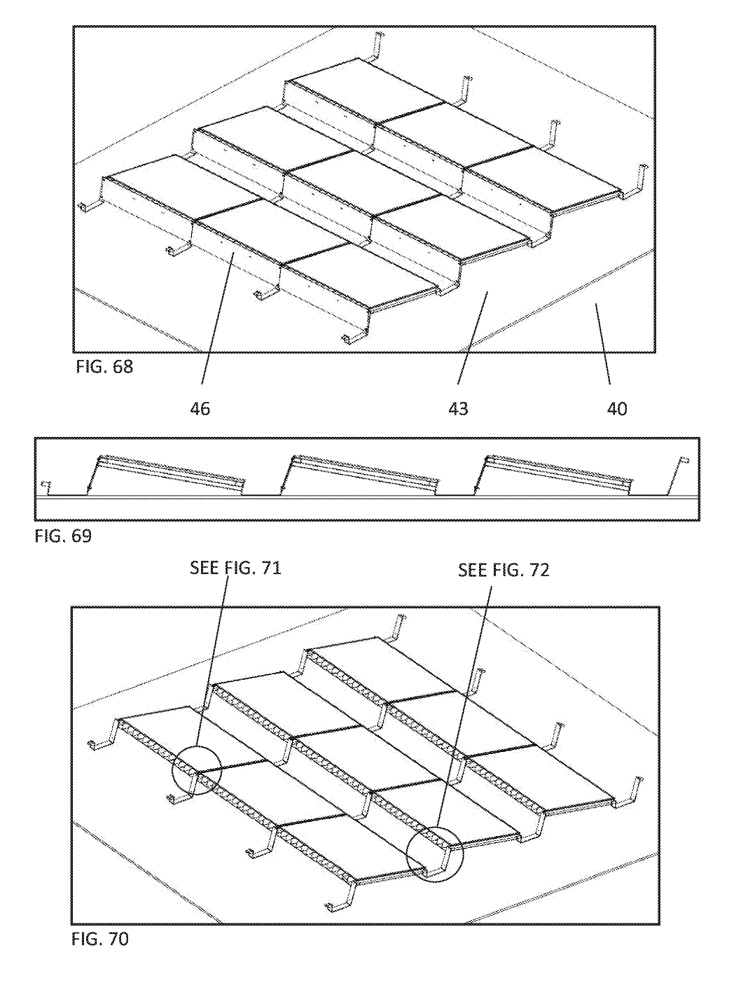

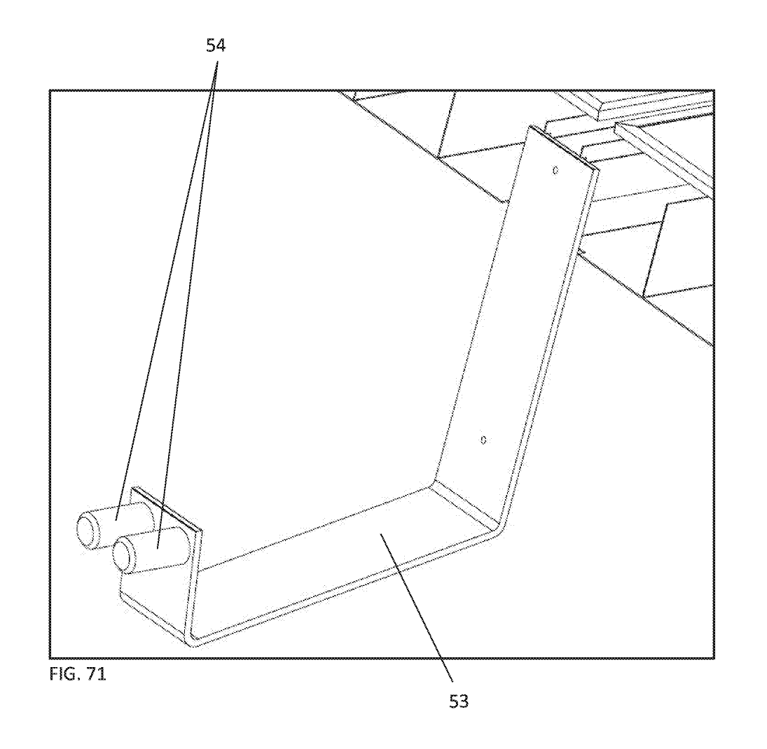

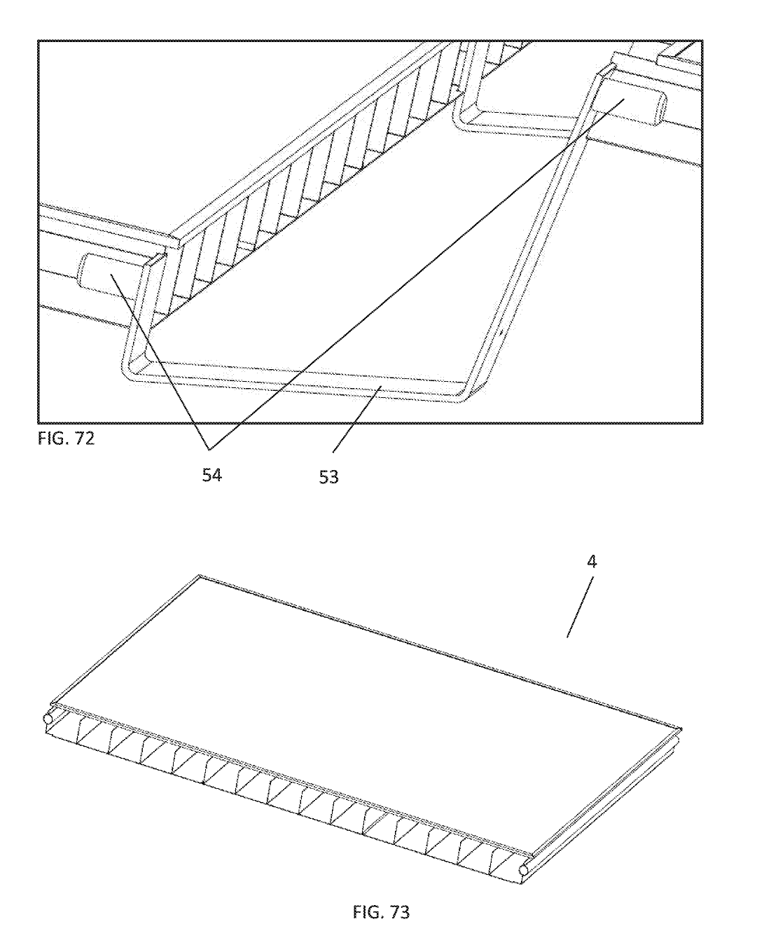

FIG. 68 shows another type of flat roof PV mounting system (40). FIGS. 69-76 show more details on this system.

FIGS. 70, 71, 74 to 76 show an example of a position of a joining rod link (53) and an insertion of the joining rods (54) in the attaching channels, (37) perhaps located in the back supported solar panels (4). The joining rods (54) can be held in place in the attaching channels (37) by fasteners or a snap latch or the like when the joining rods (54) may be inserted in the attaching channel (37).

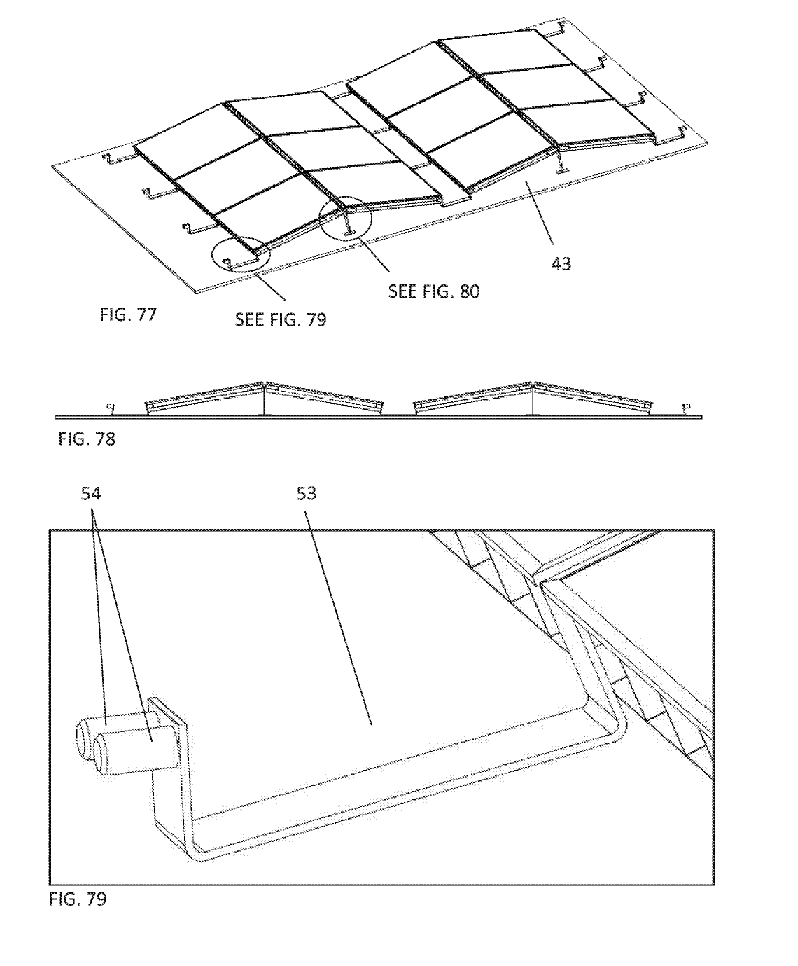

FIG. 77 shows another type of flat roof PV mounting system (40). FIGS. 78-82 show more details on this system.

Referring to FIGS. 77, 80, and 82, back supported solar panels (4) may be directly joined in a row direction (107) and even in a column direction (108) perhaps with a joining rod link high rod (59) at the high side of the back supported solar panels (4) and a joining rod link low (55) and joining rods (54) at the low side of the back supported solar panels (4).

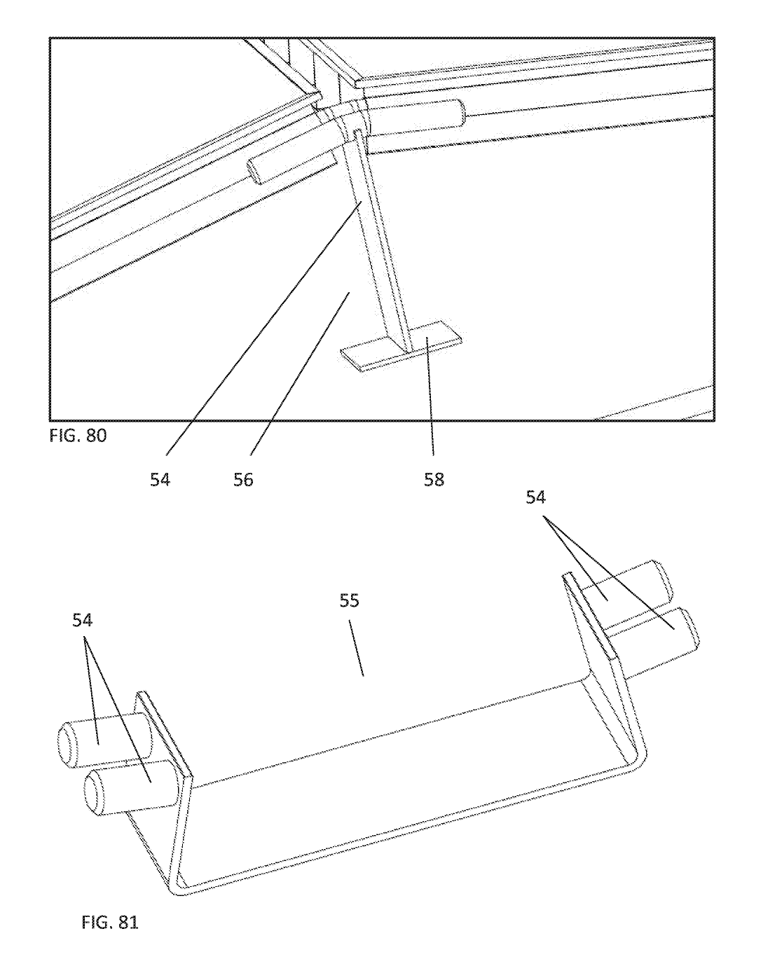

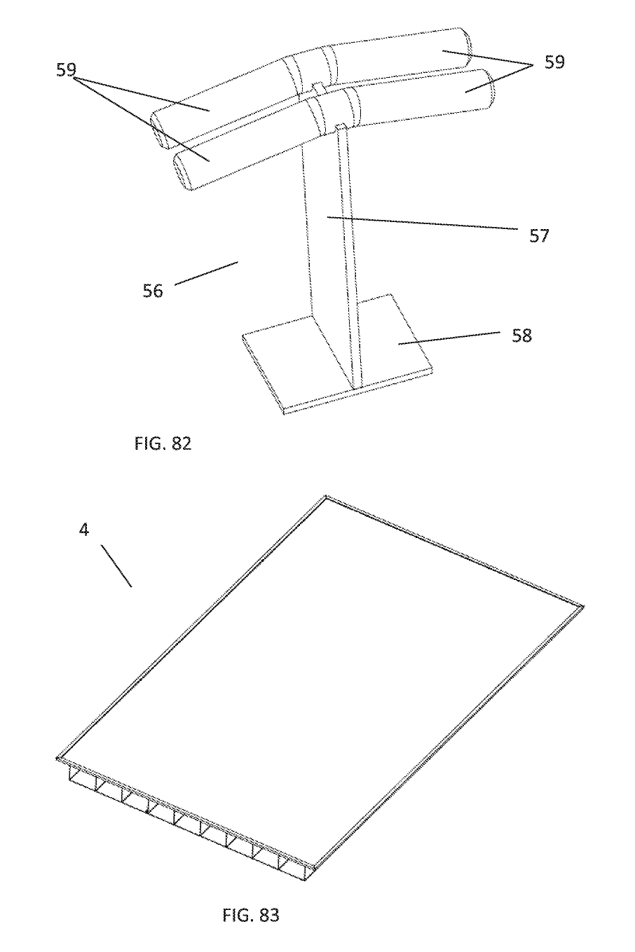

In FIGS. 80 and 82, the joining rod link high rods (59) may be held off the flat roof (43) by the joining rod link high support (57) and the joining rod link high base (58). In light wind and snow loads, the joining rod link high support (57) and the joining rod link high base (58) may not be required.

FIGS. 77 to 82 show an example of a position of the joining rod link low (55), the insertion of the joining rods (54) into the attaching channels (37) located in the back supported solar panels (4) and the joining rod link high (56), the insertion of the joining rod link high rods (59) into the attaching channels (37) located in the back supported solar panels (4). The joining rods (54) and the joining rod link high rods (59) can be held in place in the attaching channel (37) by fasteners or a snap latch when the joining rods (54) and the joining rod link high rods (59) may be inserted in the attaching channel (37).

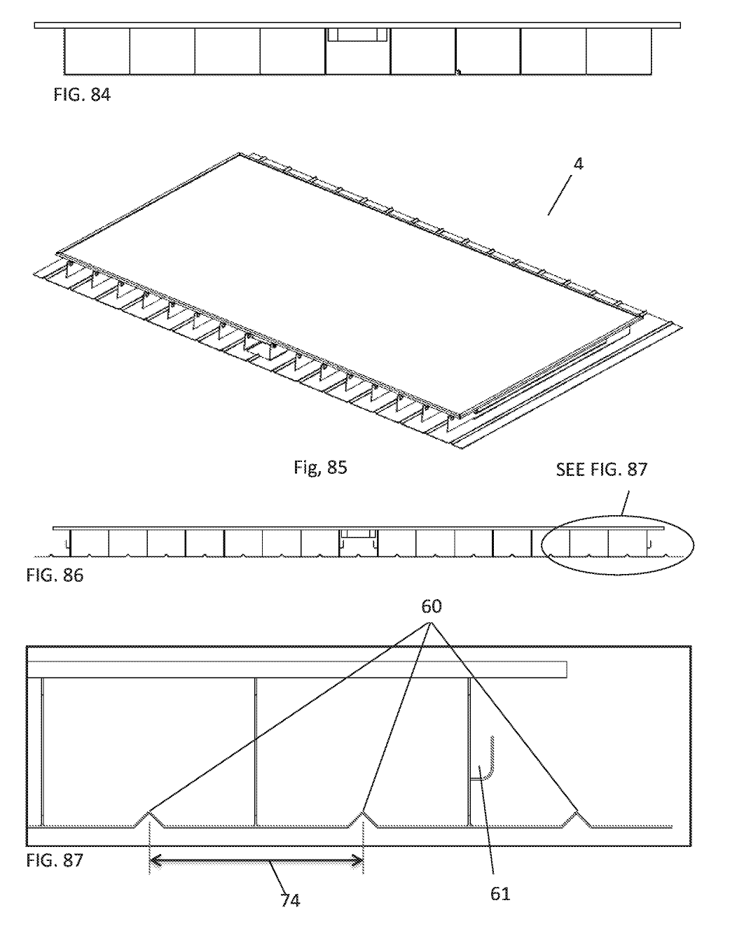

The back supported solar panels (4) have been shown with air channels (5) in the short or landscape direction. Back supported solar panels (4) can also be in portrait perhaps with the air channels (5) in the long direction as shown in the examples in FIGS. 83 and 84. All the systems shown in this disclosure can use landscape or portrait solar panels perhaps as defined by the air channel (5) direction.

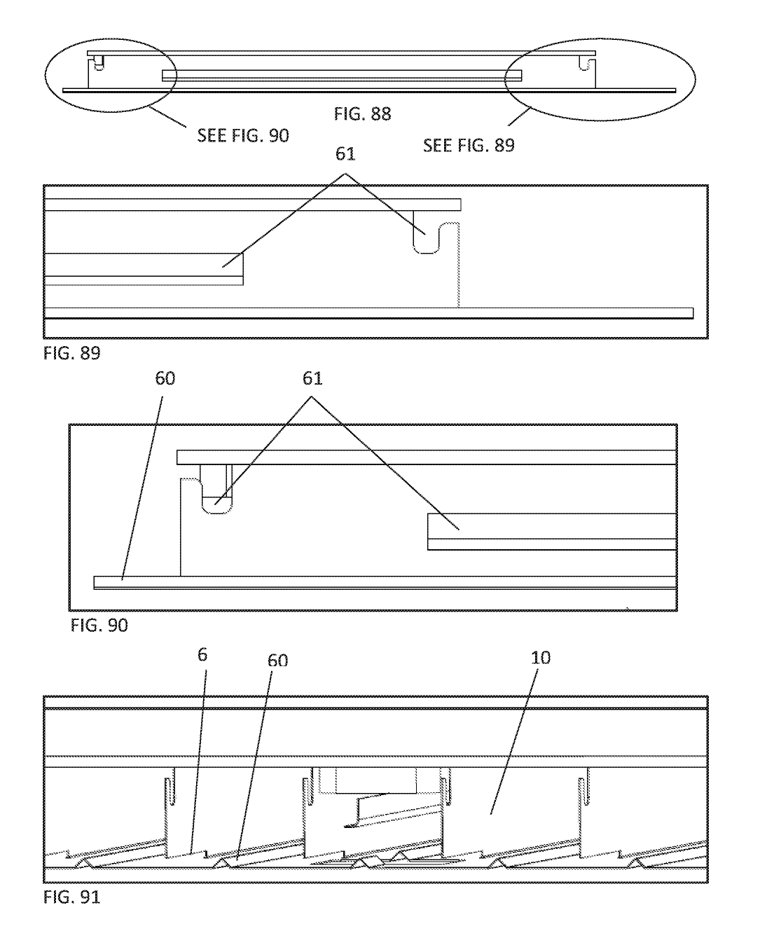

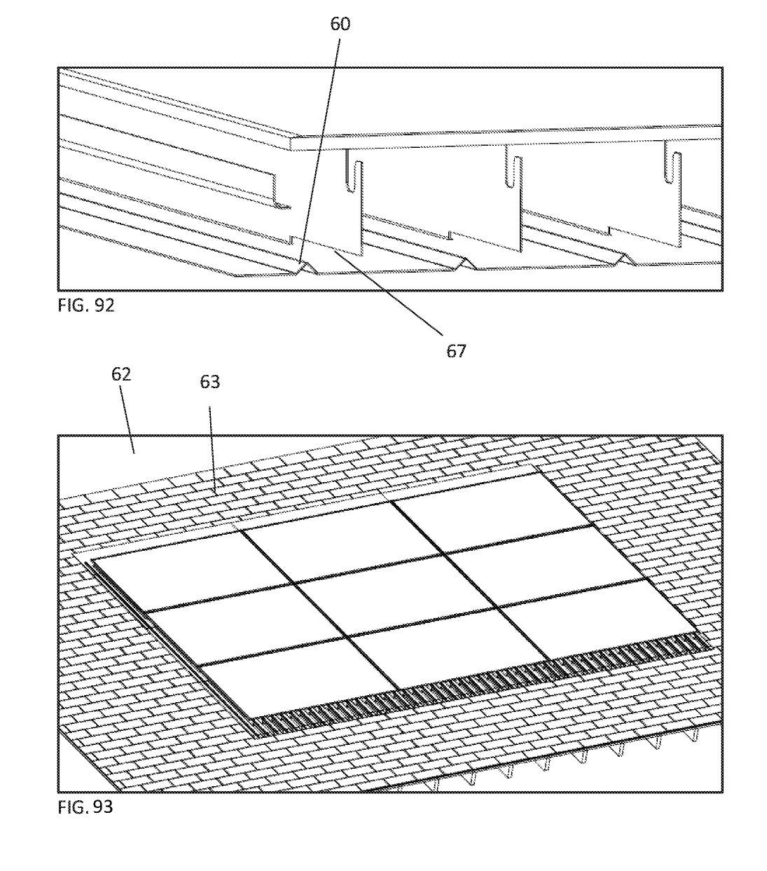

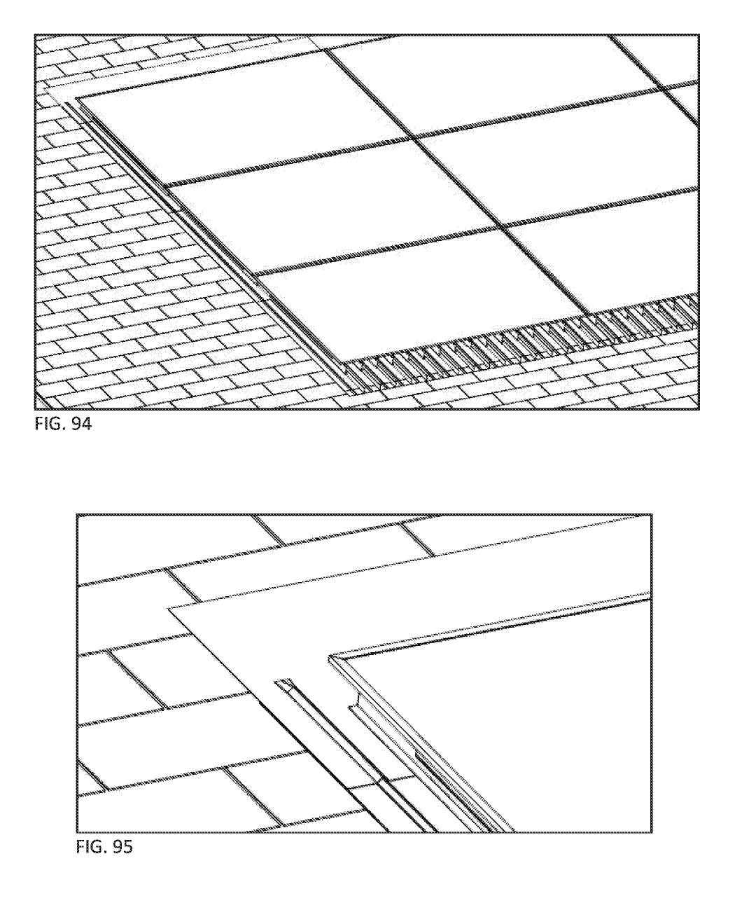

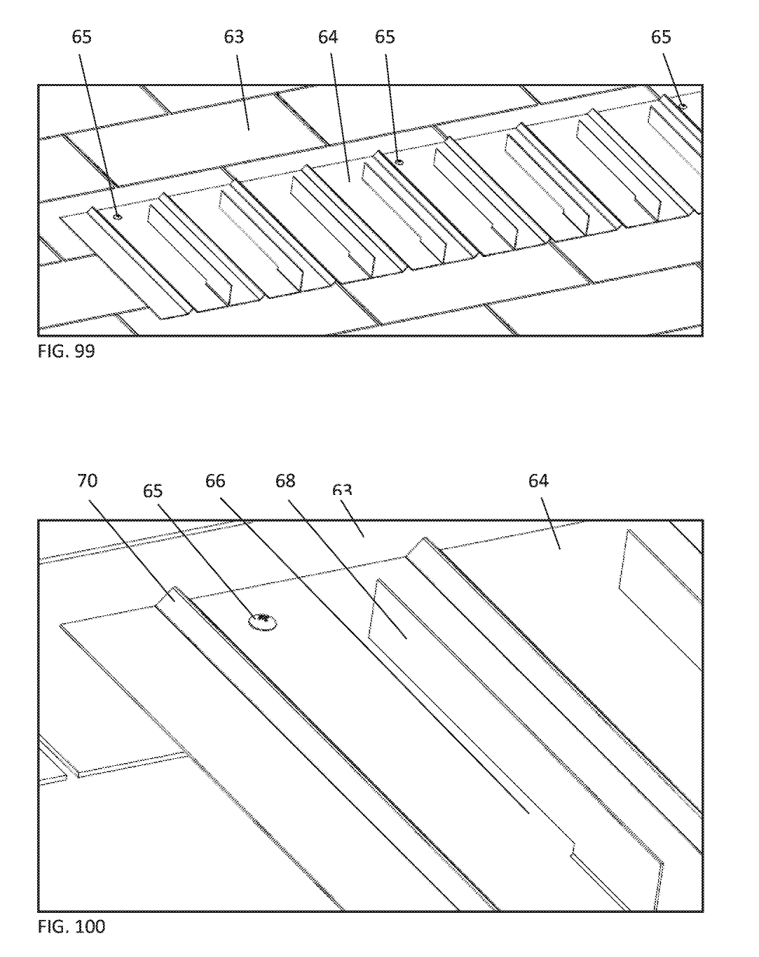

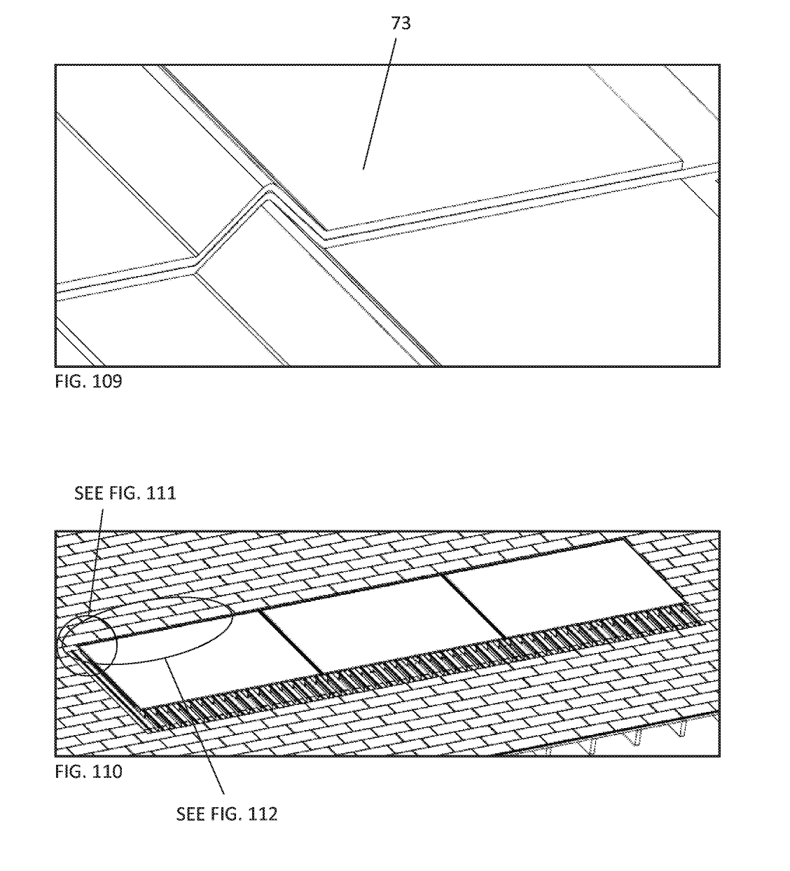

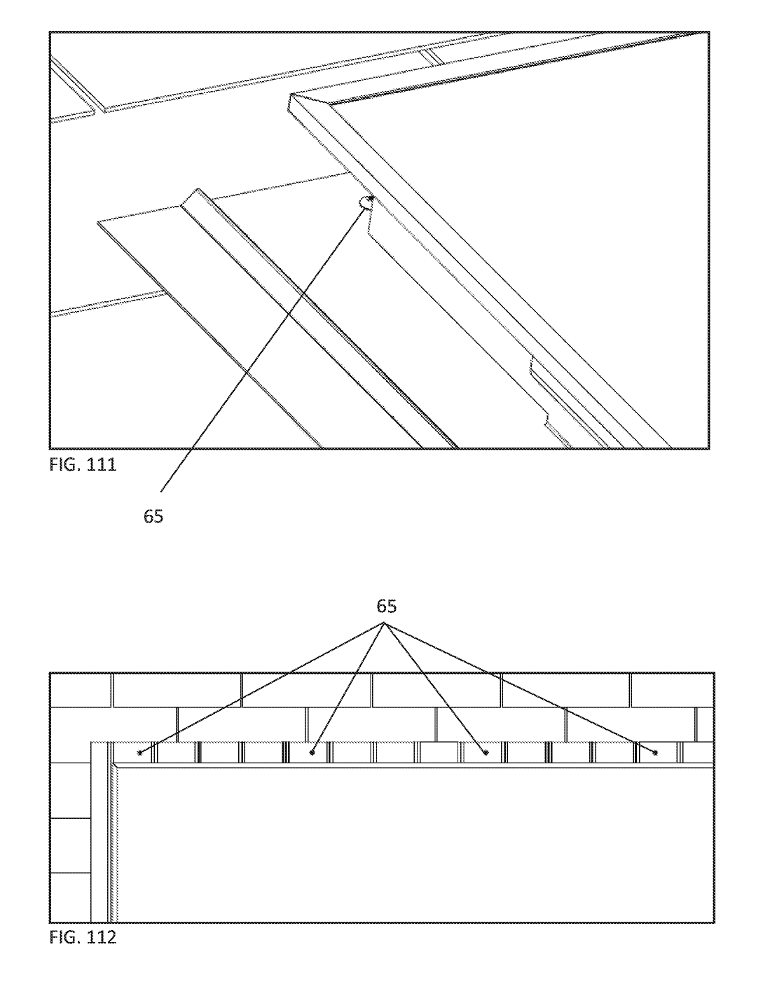

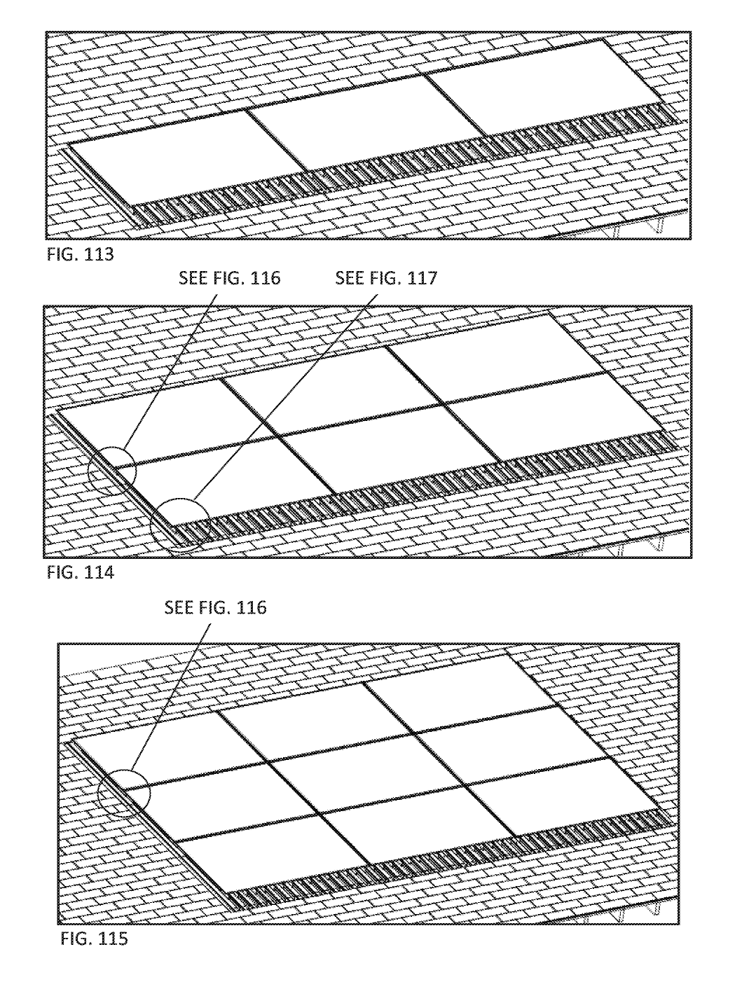

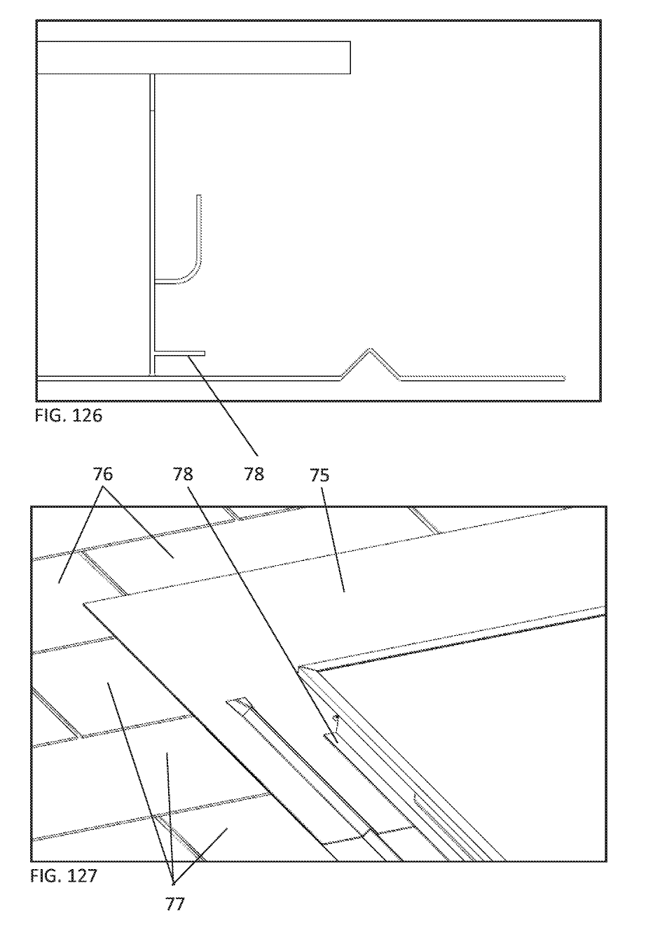

FIG. 85 shows an example of a back supported solar panels (4) perhaps primarily for a pitched roof (63) and a pitched roof PV mounting system (62). FIGS. 76-128 show more details on this system. FIGS. 86, 87 to 92 shows an example of a bottom support ridge (60) and cable guides (61). The bottom support ridges (60) may be along the bottom support (11) perhaps at equal ridge pitches (74). The web support notch (67) may be located at the bottom of each web support (10).

FIG. 93 shows an example of a pitched roof PV mounting system (62) on a pitched roof (63). The back supported solar panels (4) may overlap each other on the top, bottom and sides perhaps with flashing on top and bottom. The overlap and flashing may prevent water intrusion and will be explained further regarding solar panels and flashing as installed on a roof.

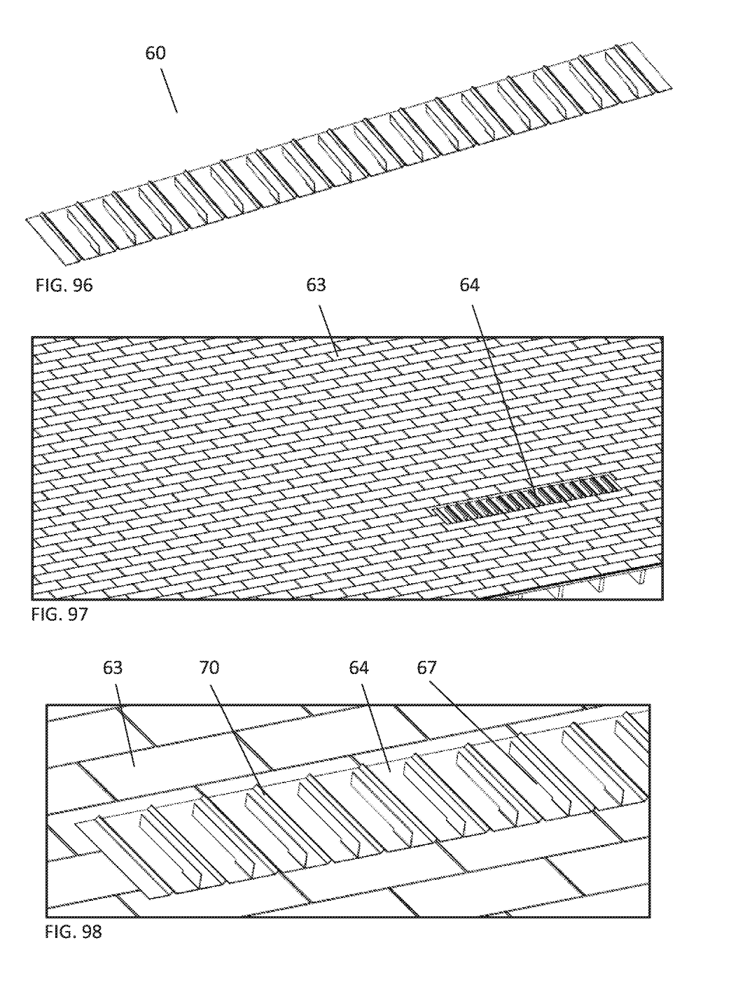

FIG. 96 shows an example of a bottom flashing (64). This bottom flashing (64) may be laid on the pitched roof (63) as shown in the examples in FIGS. 97 and 98. Roof screws (65) may be then screwed into the pitched roof (63). The roof screws (65) can be screwed into the roof rafters, roof sheathing, OSB, or battens, or the like. A bottom flashing ridge (70) may match the size and even locations of the bottom support ridge (60) on the back supported solar panel (4). The bottom flashing web support notch (66) may be located on each bottom flashing web (68).

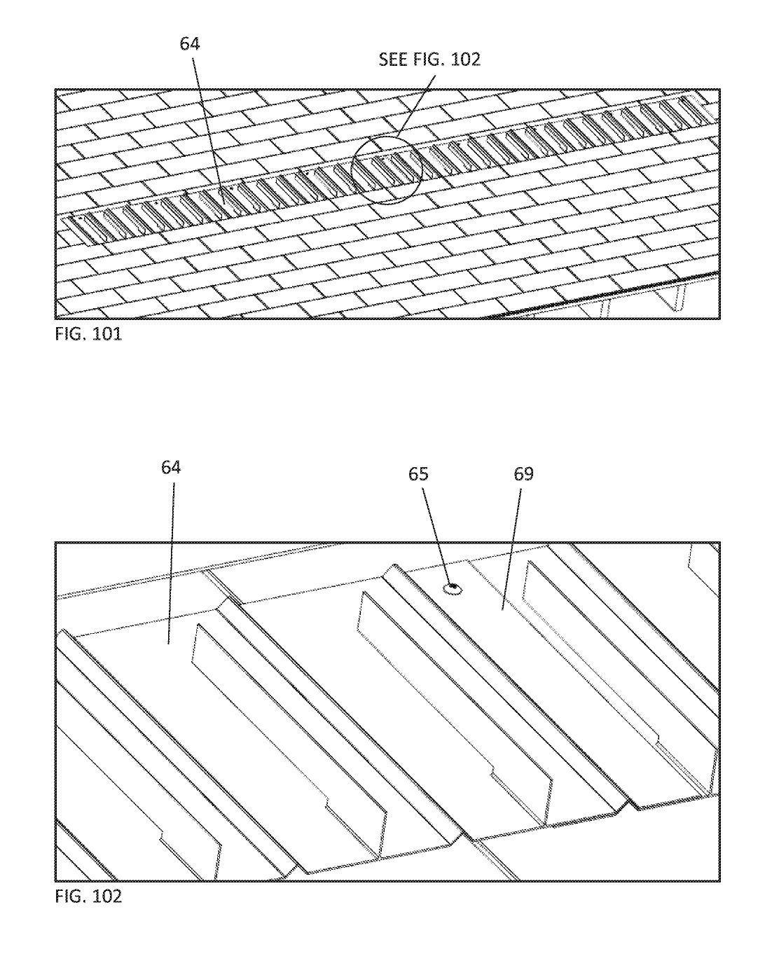

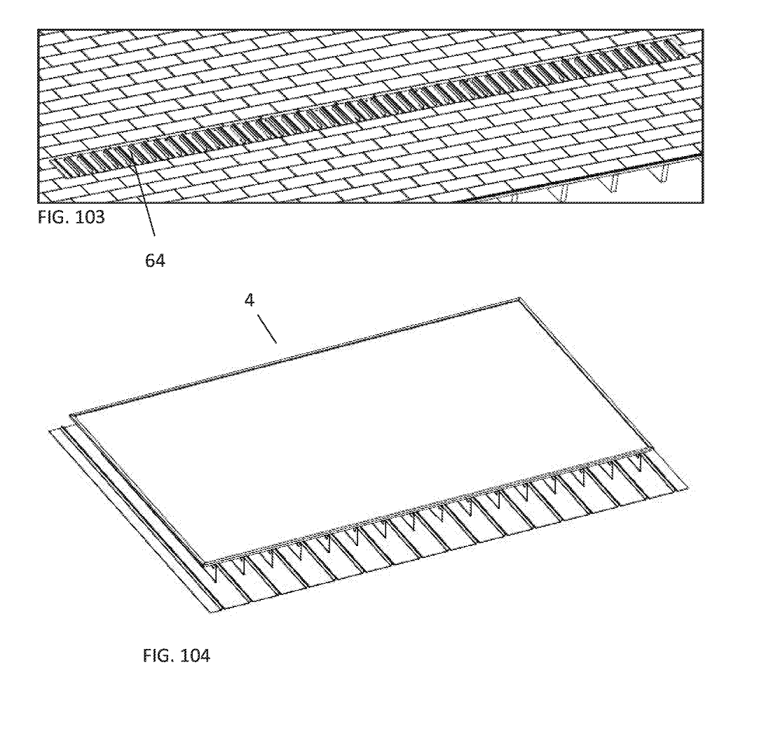

The second bottom flashing (64) may be placed on the pitched roof (63) and may be overlapped as shown by the bottom flashing overlap (69) and then may be screwed down with roof screws (65) as shown in FIGS. 101 and 102. The overlap at the ridge could prevent the water from leaking sideways from between the adjacent bottom flashing (64). These steps may be repeated for the third bottom flashing (64) as shown in FIG. 103.

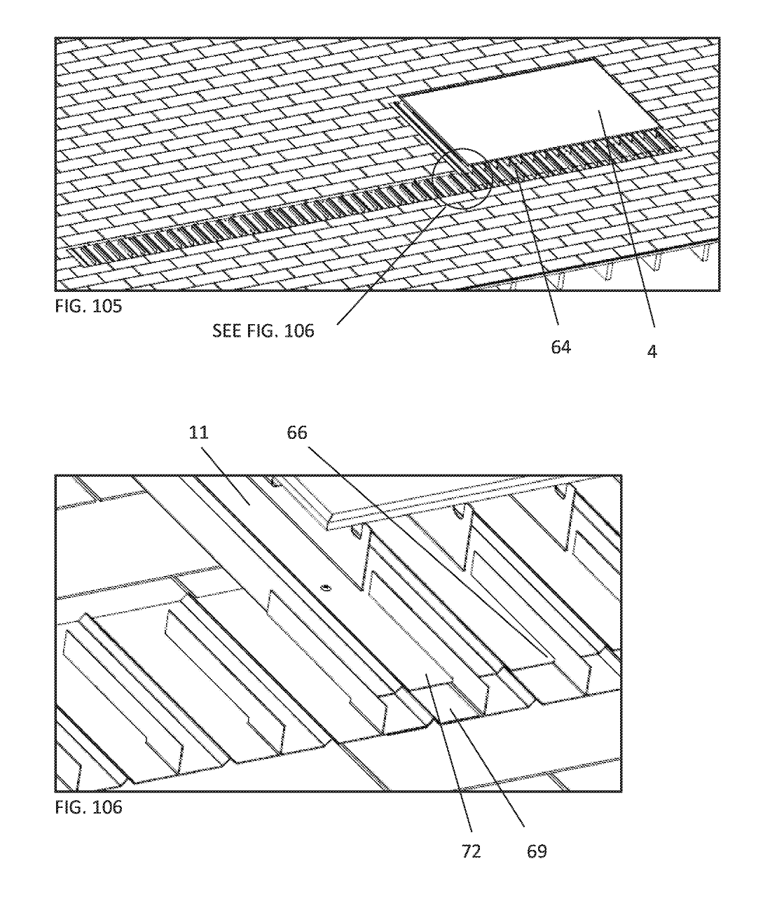

The back supported solar panel (4) shown in the example in FIG. 104, may then be placed on top of the bottom flashing (64) perhaps as shown in FIGS. 105 and 106. A bottom support (11) may be slipped under the bottom flashing web support notch (66). The bottom support (11) may cover up the roof screws (65) on the bottom flashing (64) perhaps to prevent water intrusion at these roof screws (65). At the bottom support overlap on bottom flashing (72) and on bottom flashing (64), bottom support (11) and an overlap of two bottom flashings (64) may be provided. All three of the ridges may overlap perhaps so that there could be no side travel water intrusion.

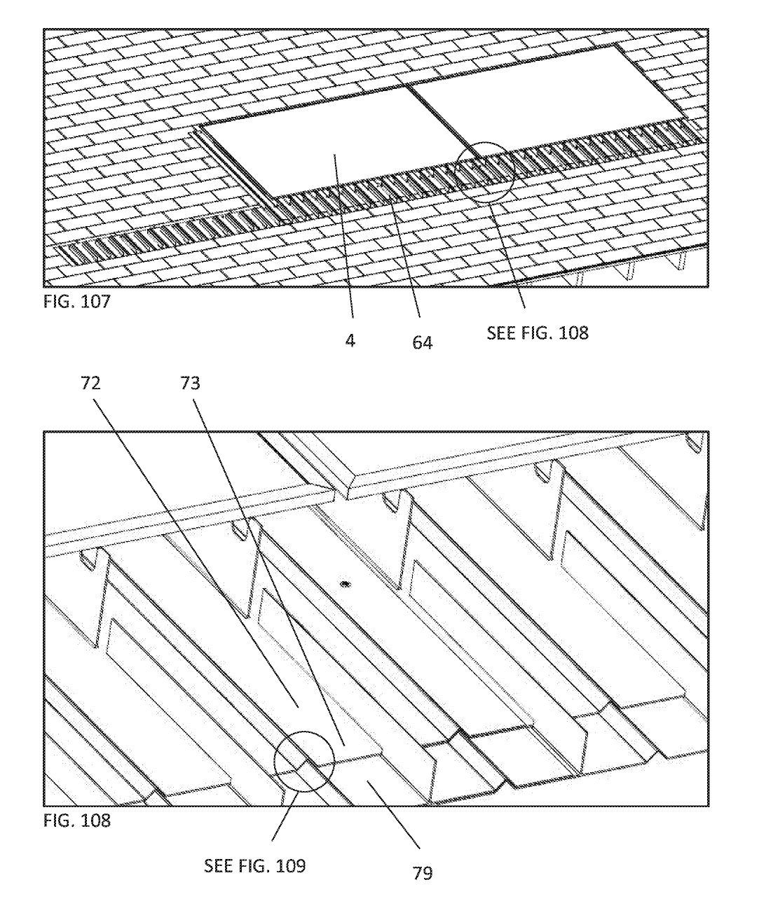

The second and third back supported solar panels (4) may be placed as shown in the examples in FIGS. 107-109. At the overlap location (73), there may be two adjacent bottom supports (11) on the back supported solar panel (4) which may overlap and two bottom flashings (64) may overlap. The roof screws (65) could then be screwed perhaps at the top of the three back supported solar panel (4) as shown in the examples in FIGS. 110-112. The roof screws (65) may hold the upside of the three back supported solar panels (4) and even the bottom flashing web support notches (66) may secure the downside of the three back supported solar panel (4). The next row of three back supported solar panels (4) could be placed like the bottom three as shown in FIG. 114. The roof screws (65) could then be screwed at the top of the three back supported solar panels, perhaps four on row two. The last row of three back supported solar panels (4) could be placed and even screwed down like the previous rows such as shown in FIG. 115.

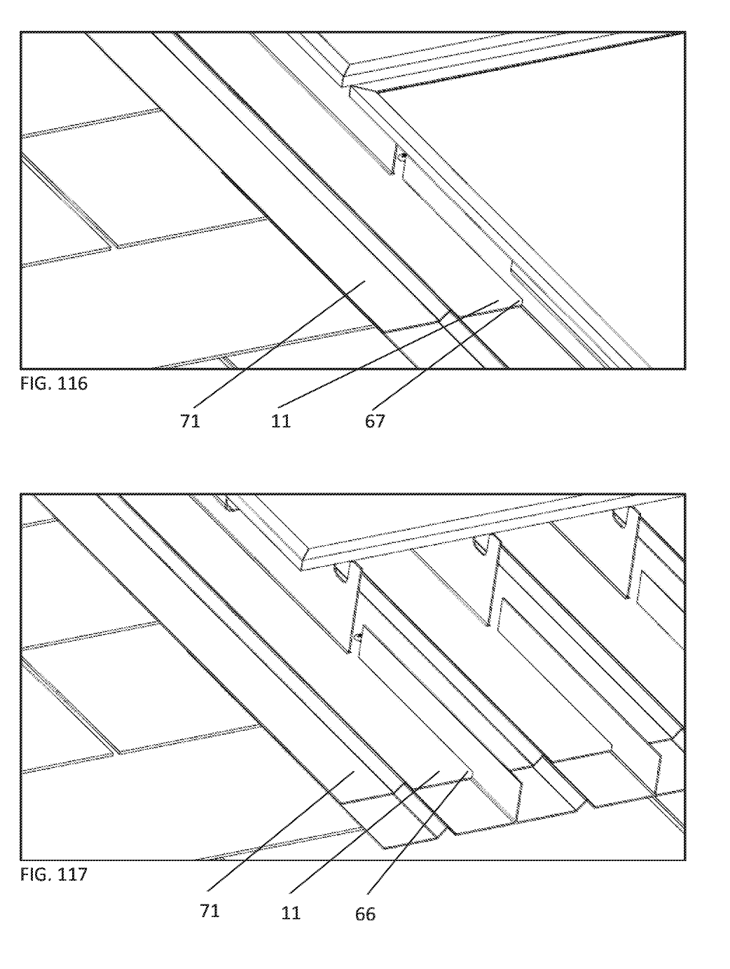

In FIG. 116, an example of a bottom support overlap (71) on back supported solar panel (4) is shown. This overlap may cover the roof screws (65). The downside of an upper bottom support (11) may be secured by the upside web support notch (67).

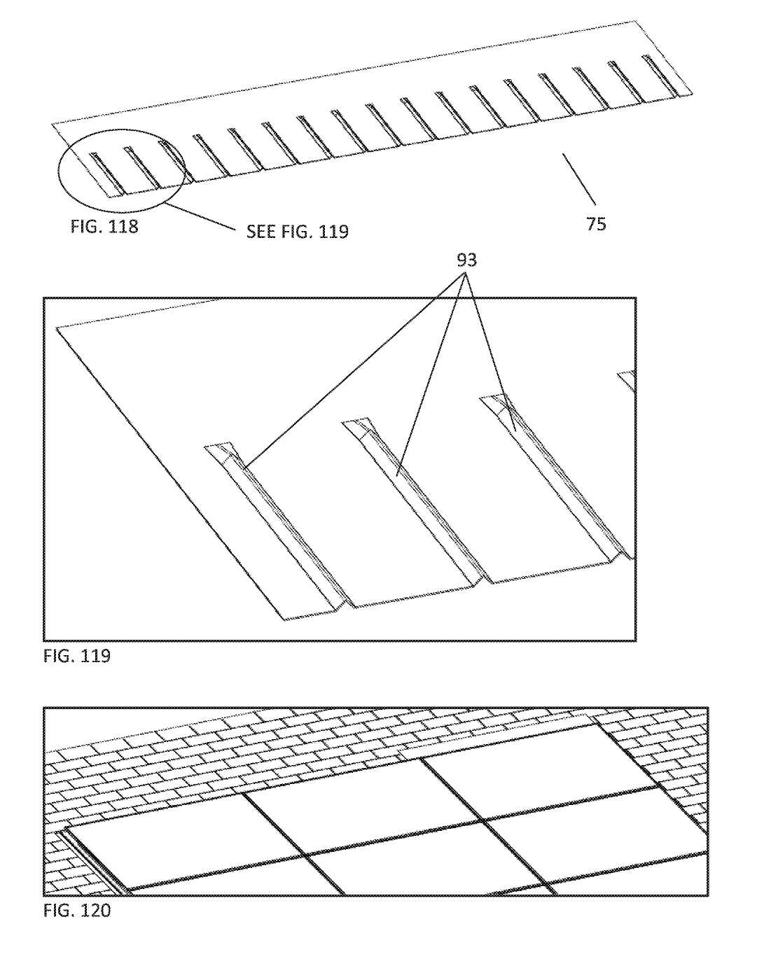

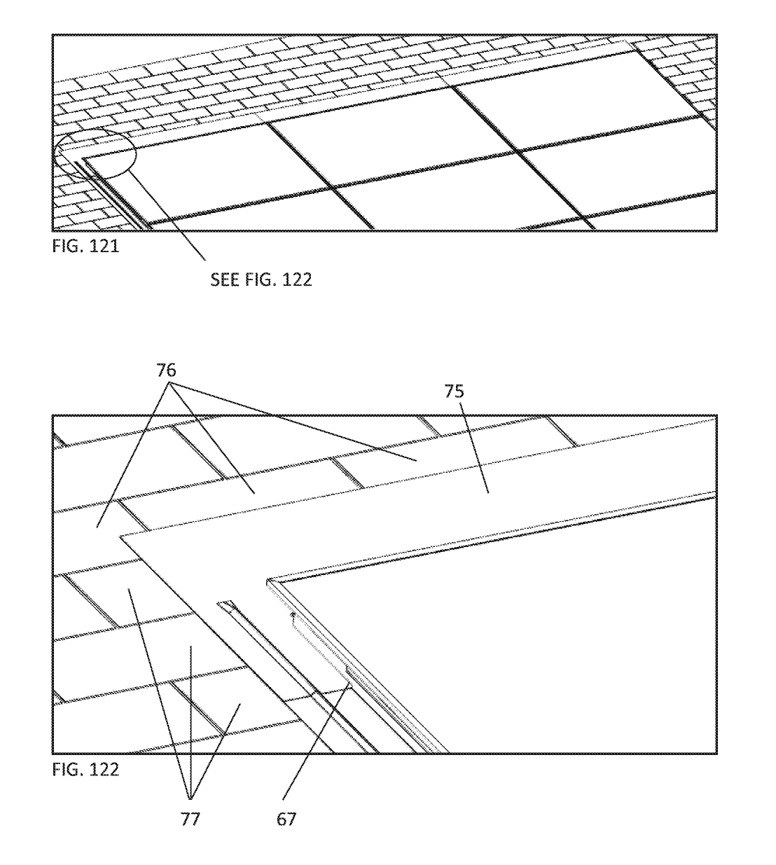

An example of a top flashing (75) is shown in FIGS. 118 and 119. The first top flashing (75) may be placed as shown in FIG. 120. The second and third top flashing (75) may be placed down perhaps overlapping the previous top flashing (75) as shown in FIG. 121. This may be similar to the bottom flashing (64). The top flashing ridges (93) could align with the bottom support ridges (60). The top of the top flashing (75) could be slid under the bottom of the top roof shingles (76). Referring to FIG. 122, a top flashing (75) is not shown under the top roof shingles (76) but it could be used for the installation.

Any water flowing down a pitched roof (63) above a pitched roof PV mounting system (62) could flow over the top flashing (75) over the bottom support (11) on the three rows of back supported solar panel (4) and perhaps even over a bottom flashing (64) and back on the pitched roof (63). All the roof screws (65) may be covered. All the bottom flashing (64), the bottom supports (11) on the back supported solar panel (4), and the top flashing (75) may have side overlap with overlap on one ridge, which may prevent side water intrusion. The system design may provide good water shedding ability.

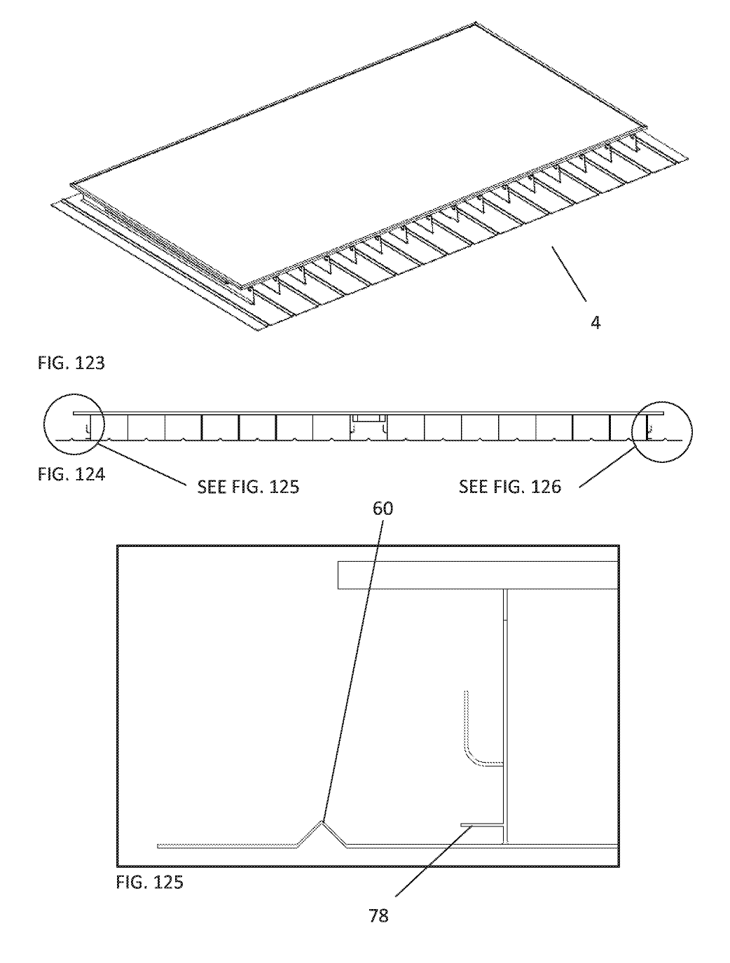

As discussed so far, embodiments of the present invention can be put over existing roofing. If it were to be put down while the shingles were installed, the side roof shingles (77) could be placed over the left ridge shown in the example in FIG. 122. This could be done on the other side of the system also. This may assure that the side roof shingles (77) could be put under the shingle holding lip (78) as shown in the examples in FIGS. 123-127. In FIG. 125, the side roof shingles (77) could go over the bottom support ridge (60) and then even under the shingle holding lip (78).

FIG. 128 shows an example of an irregular pitched roof PV mounting system (62). The back supported solar panel (4) can be offset to an adjacent top or bottom back supported solar panel (4) perhaps by any increment of the ridge pitch (74). This may make a pitched roof PV mounting system (62) very flexible for laying out the back supported solar panels (4). For a pitched roof PV mounting system (62), changing out a defective back supported solar panel (4) may need unscrewing of a defective back supported solar panel (4). Other back supported solar panels (4) or even flashing may also need to be removed. This can be solved by being able to remove the laminate from the support structure.

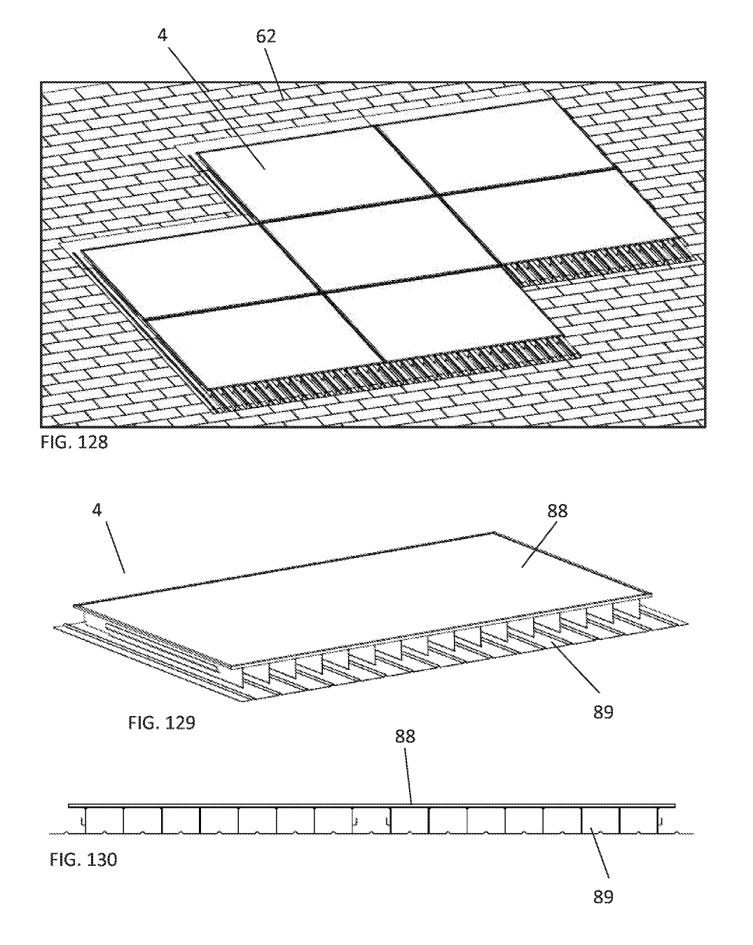

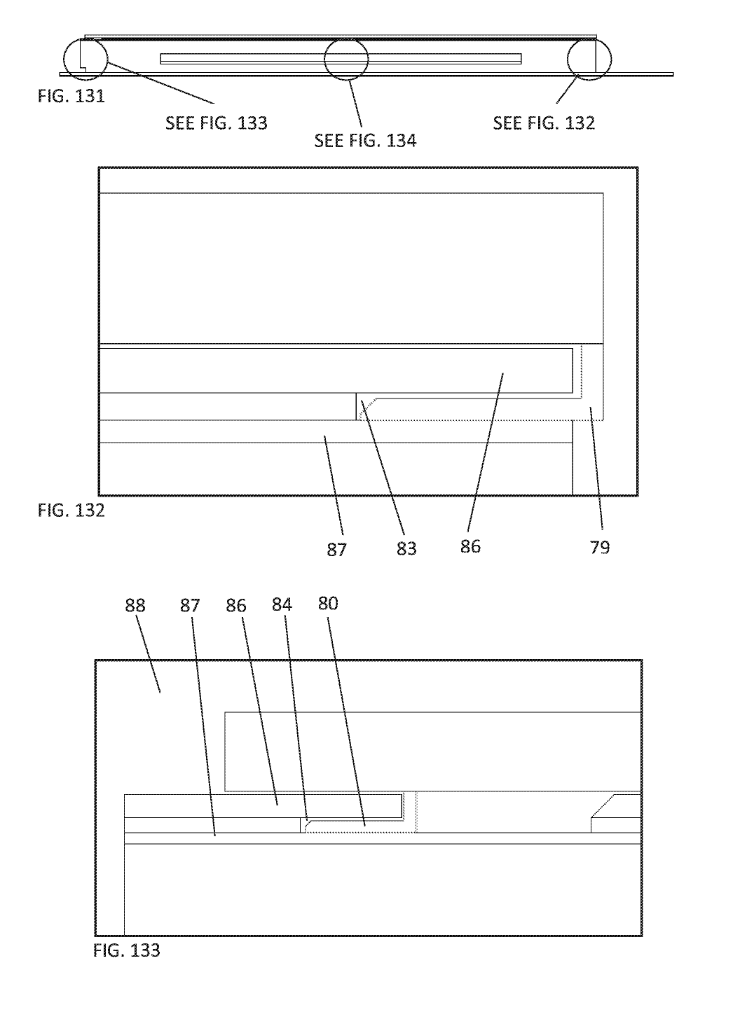

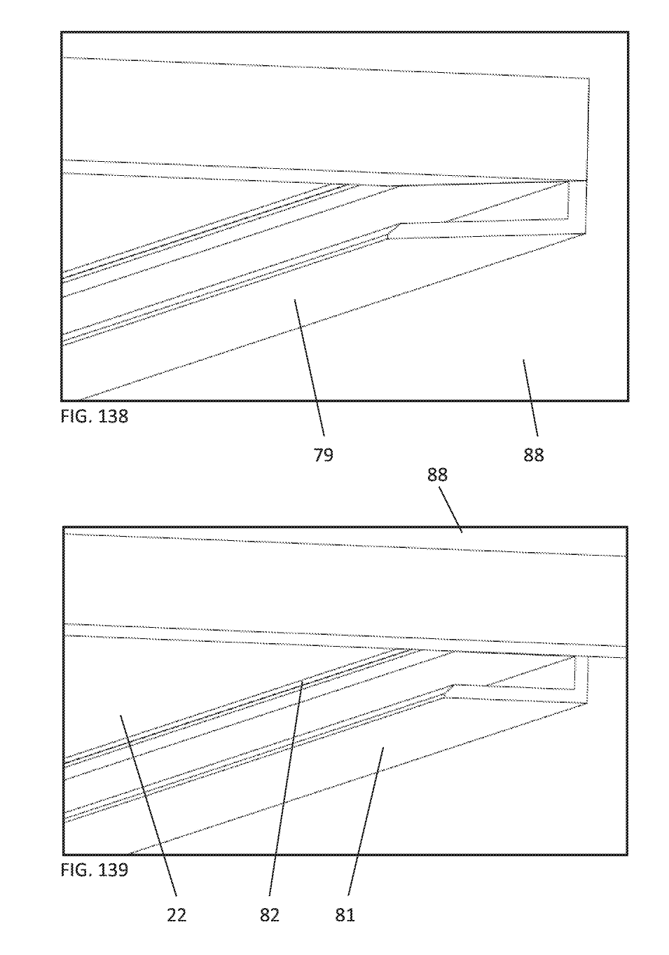

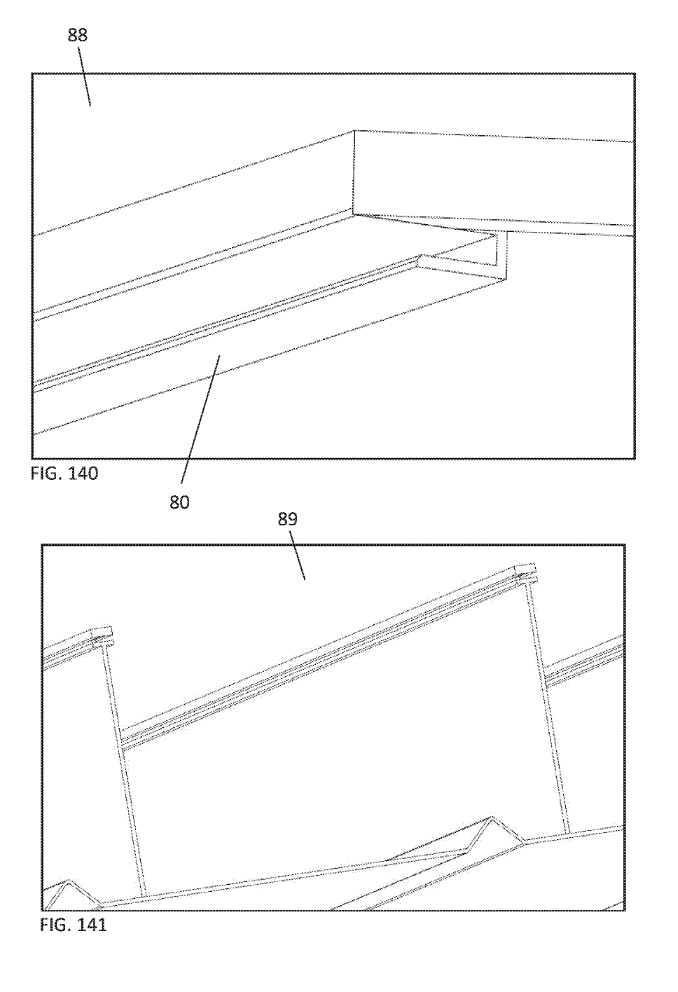

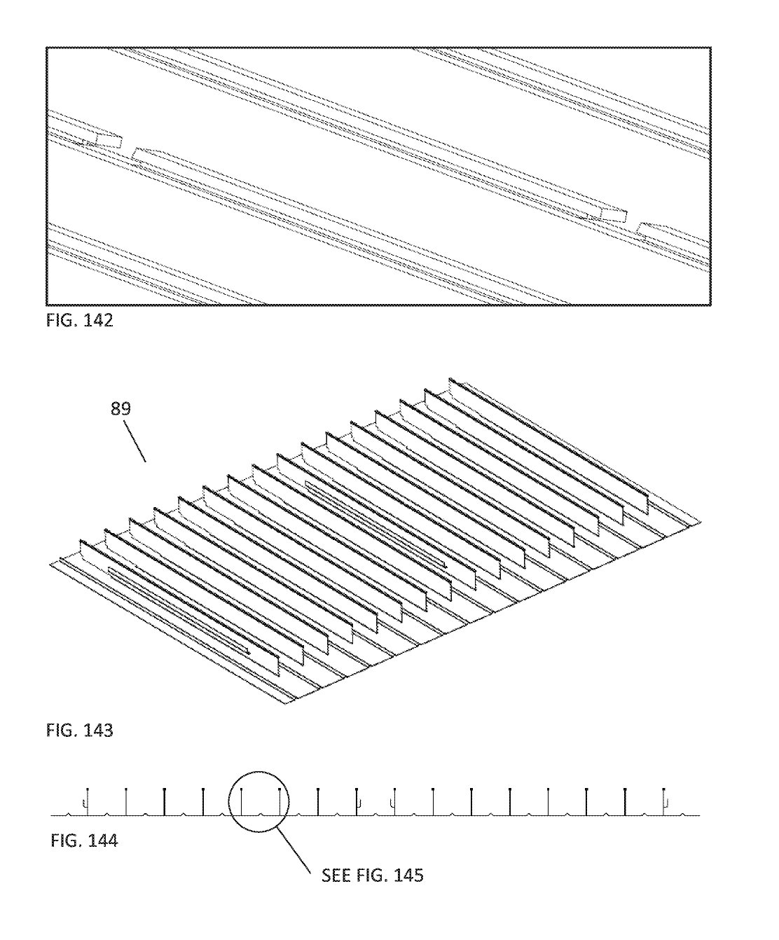

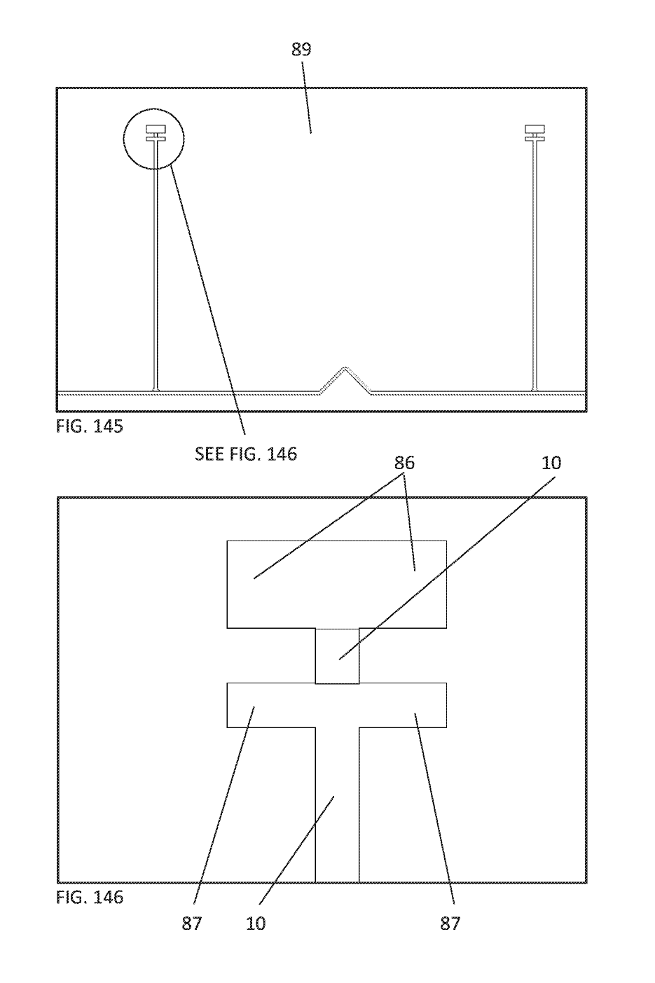

The back supported solar panels (4) in FIG. 129, may allow a lip laminate (88) to be removed from the open top laminate support (89). An example of an open top laminate support (89) is shown and labeled in FIGS. 129 to 131, 141 and 143 to 145. An example of a lip laminate (88) is shown and labeled in FIGS. 129 to 140. More details are shown in FIGS. 130 to 146.

The lip laminate (88) may be held to the open top laminate support (89) perhaps by the laminate frame right lip (79), the laminate frame left lip (80), and even the laminate middle lip (81).

In FIGS. 132 and 135, the laminate frame right lip (79) may be in the web support right notch (83) perhaps held by the top support top lip (86) and may rest on the top support middle lip (87).

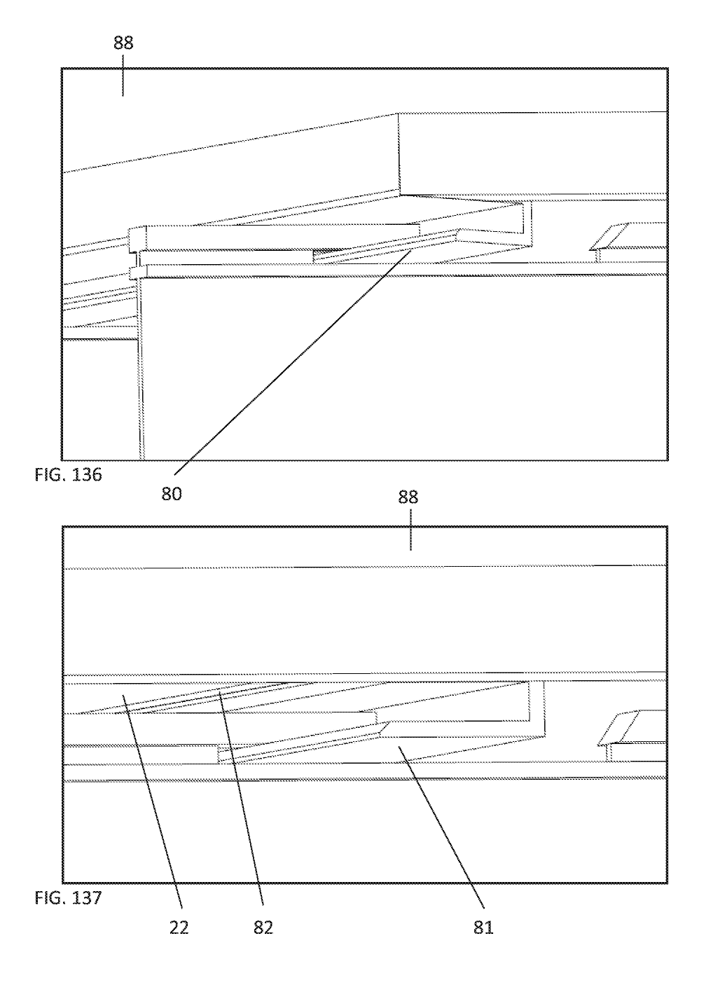

In FIGS. 133 and 136, the laminate frame left lip (80) may be in the web support left notch (84) perhaps held by the top support top lip (86) and may rests on the top support middle lip (87).

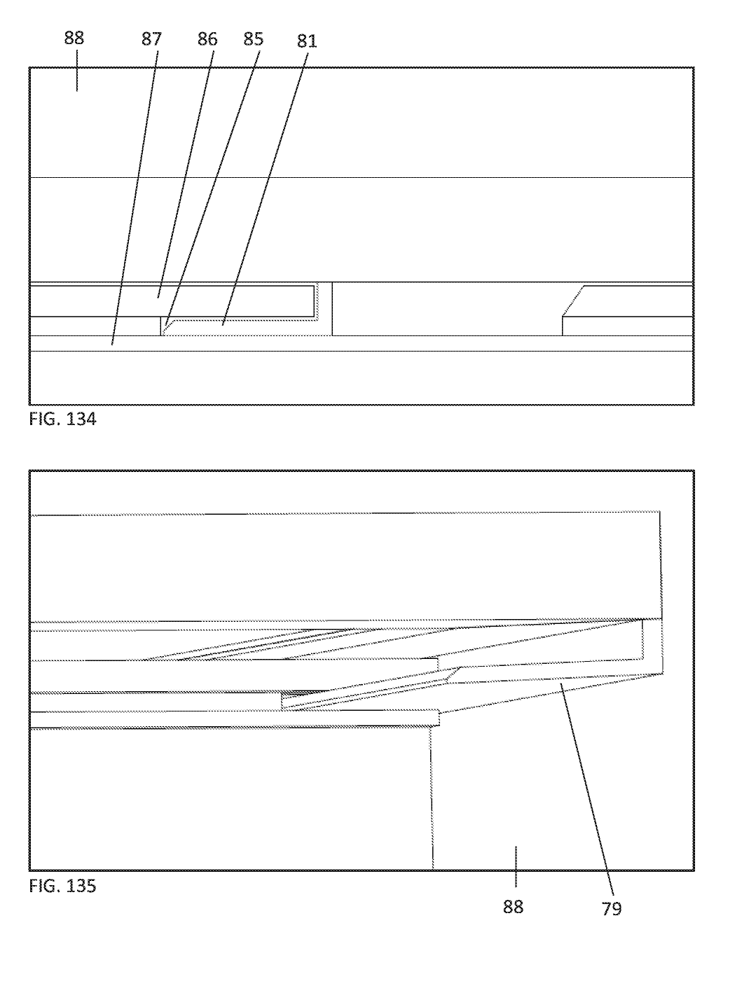

In FIGS. 134 and 137, the laminate middle lip (81) may be in the web support middle notch (85) perhaps held by the top support top lip (86), and may rests on the top support middle lip (87). The laminate middle lip (81) can be attached to the backsheet (22) perhaps with laminate middle lip adhesive (82). The laminate middle lip (81) may be continuous but could be sectioned to improve the air flow.

The lip laminate (88) can be removed perhaps from the open top laminate support (89) by moving it to the right and even lifting up the lip laminate (88). The sequence may be reversed to install the lip laminate (88) in the open top laminate support (89). The direction of the lips on the laminate frame right lip (79), the laminate frame left lip (80), and the laminate middle lip (81) can be reversed perhaps so that gravity may be able to hold them in place. The lips could also be snap latched when they slide in the notches. The laminate middle lip (81) may only be required in very high wind areas and perhaps with large back supported solar panel (4).

In FIG. 146, the open top laminate support (89) can be increased by increasing the width of the top support top lip (86) and even the top support middle lip (87).

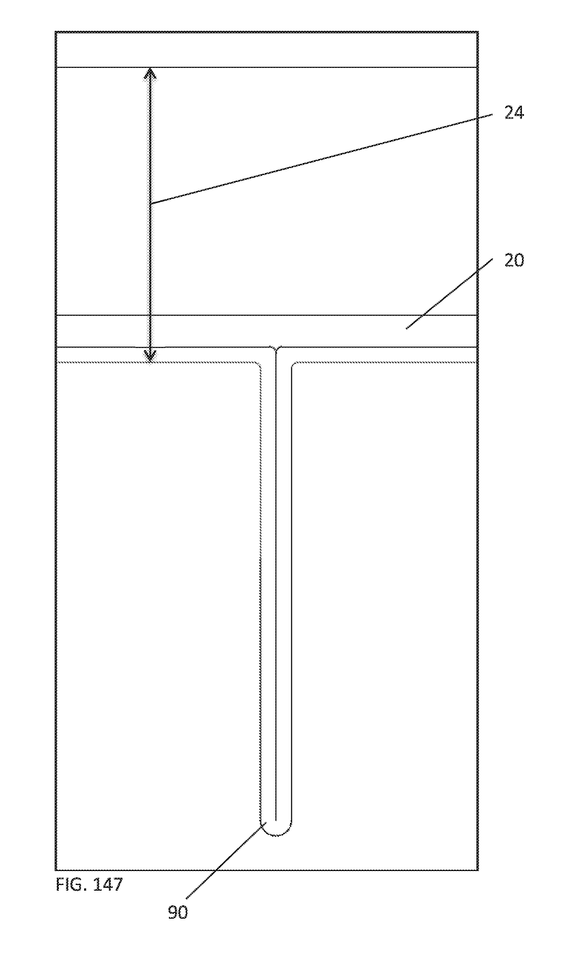

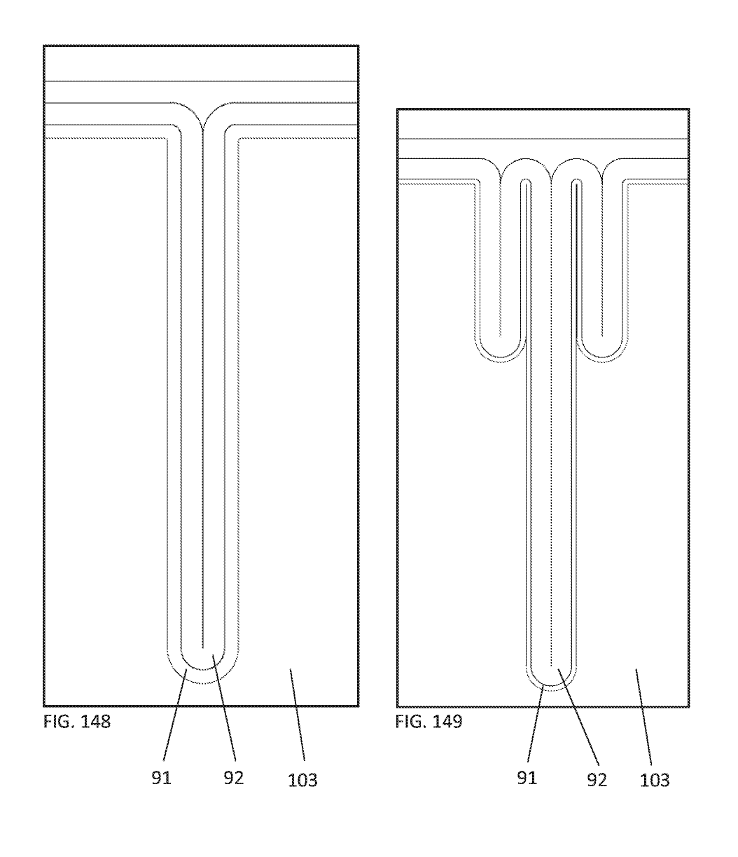

FIG. 147 shows an example of a formed backsheet (90). A formed backsheet (90) can be used for attachment and even for dissipating more heat. More details and usages are described in FIGS. 148 to 163.

FIGS. 148 to 150 show an example of a formed backsheet (90) used as backsheet thermal fins (103). In FIG. 148, a formed conductive layer (92) may efficiently dissipate heat perhaps by increasing the area the heat can dissipate. This may be similar to limbs such as fins on a heatsink. FIGS. 149 and 150 may show a better heat dissipater perhaps by increasing the conduction through the multiple formations.

In FIGS. 148 to 150, a formed protective layer (91) may help protect a formed conductive layer (92) perhaps from corrosion and even damage. A formed protective layer (91) could be PV backsheet material or other polymer, or the like. A formed conductive layer (92) may be aluminum or other high conductive metal or conductive polymer, or the like.

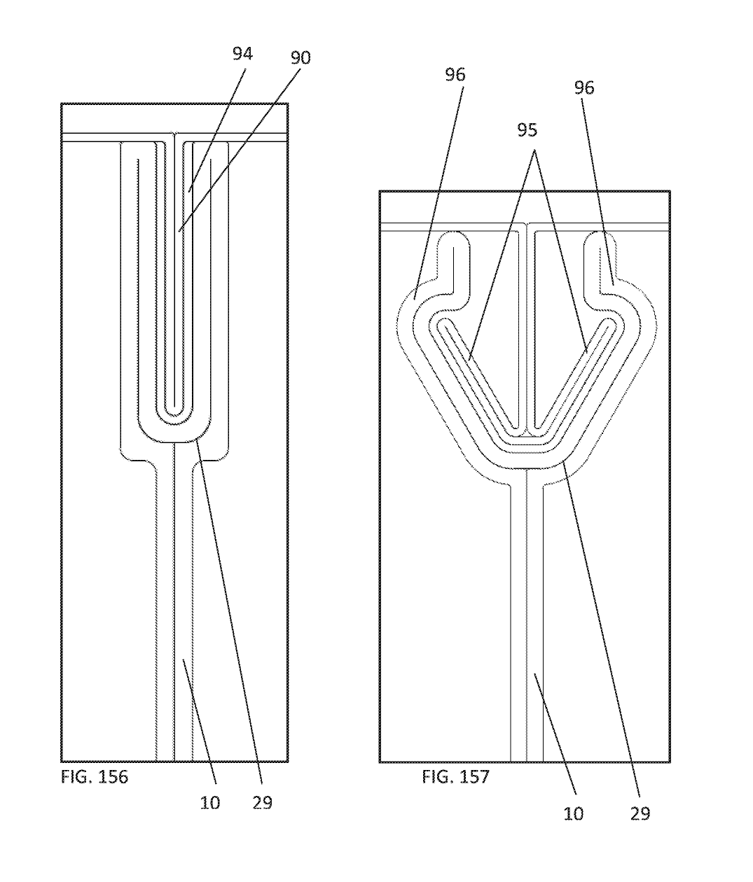

FIGS. 151 to 163 show examples of how a formed backsheet (90) can be used for attachment. In FIGS. 151 to 154, a web support (10) may be formed around a formed backsheet (90). FIGS. 155 and 156 show an example of use of formed backsheet adhesive (94) to attach a web support (10) to a formed backsheet (90).

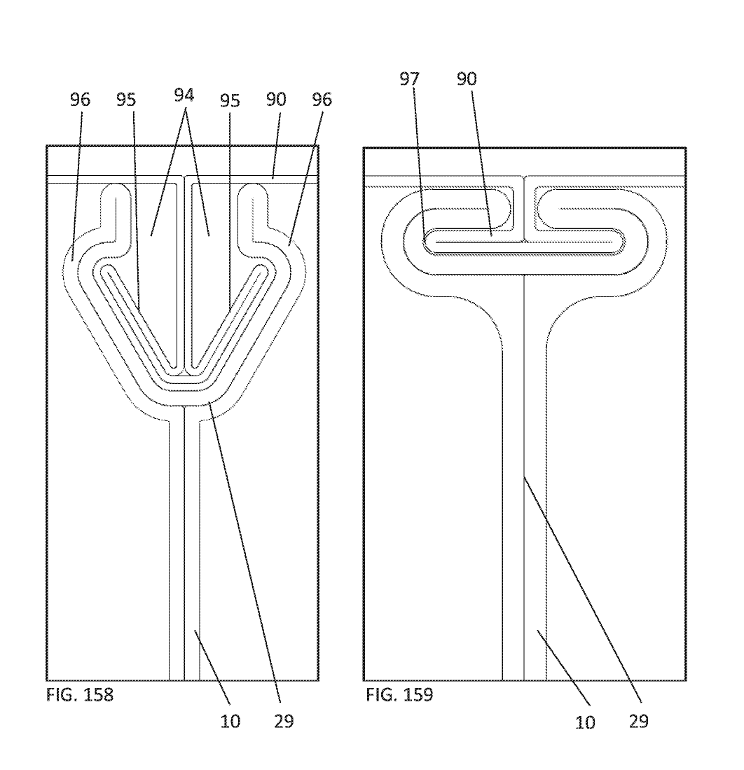

FIG. 157 shows an example of the use of formed backsheet fingers (95) and even support web fingers (96) to create a snap in feature perhaps to attach the web support (10) to the formed backsheet (90). FIG. 158 is the same as FIG. 157 except that formed backsheet adhesive (94) may be added for greater attachment.

FIG. 159 shows an example how the formed backsheet (90) can be slipped into the formed web support (10). A small formed backsheet space (97) may allow a formed backsheet (90) to slide into a formed web support (10).

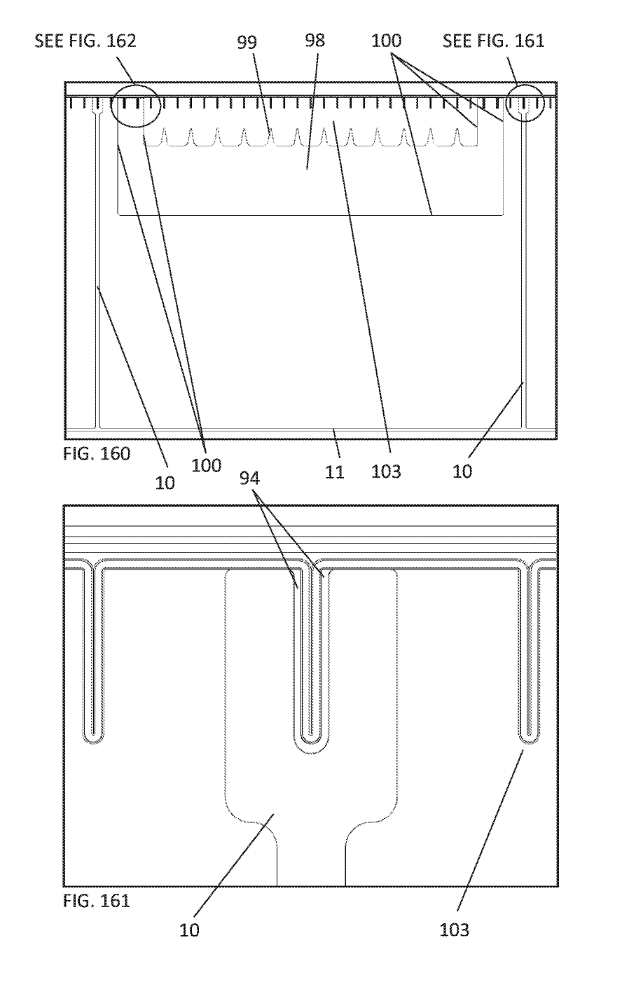

If an electronic enclosure such as a junction box, may be attached to the backsheet, a hot spot may occur perhaps since there may be less heat able to dissipate out the backsheet due to the junction box. In FIG. 160, this hot spot may be greatly reduced perhaps with raised electrical box (98) which may include a finned electronic enclosure. Heat can also be dissipated off the junction box perhaps through electronic enclosure fins (99). Air may flow freely between backsheet thermal fins (103) and electronic enclosure fins (99). Additional electronic enclosure fins (99) can be added on the electronic enclosure sides (100).

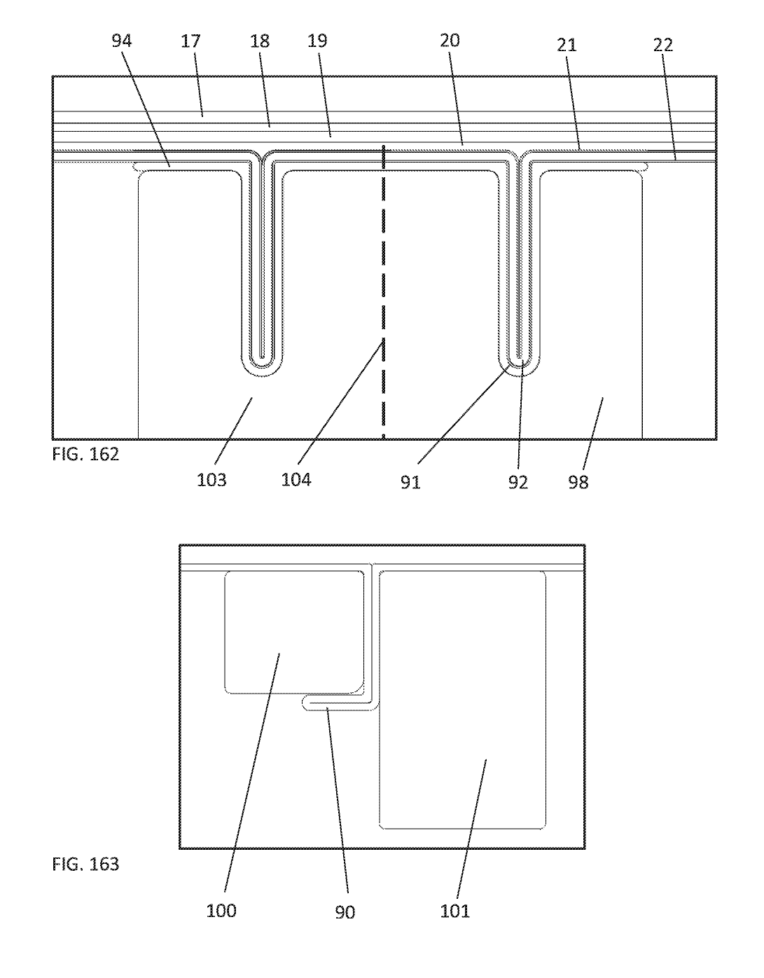

FIG. 162 shows an example of the detail of the attachment of a raised electrical box (98) such as a finned electronic enclosure to backsheet thermal fins (103). Formed backsheet adhesive (94) may be used to attach the finned electronic enclosure (98) to the backsheet thermal fins (103) perhaps as shown in FIG. 162. The buss ribbon (104) may go into the finned electronic enclosure (98) as shown.

The barrier layer (21) in FIG. 162, may help prevent unwanted shorting between the electrical conductors and within the PV layer (19) perhaps through a conductive layer, even a formed conductive layer (92). The electrical conductors could be, but is not limited to, buss and stringing wires. A barrier layer (21) may be eliminated if the formed conductive layer (92) may only be under areas where this shorting would not occur. For example, if a PV Layer (19) were solar cells (112), then the formed conductive layer (92) may be isolated to the area under the solar cell (112) and may not go beyond the solar cell (112) edges.

Formed backsheet adhesive (94) may be used to attach the web support (10) to the backsheet thermal fins (103) as shown in the example in FIG. 161.

FIG. 163 shows an example of how a formed backsheet (90) may be mechanically attached perhaps by sandwiching a left backsheet retainer (101) and a right backsheet retainer (102). A left backsheet retainer (101) and a right backsheet retainer (102) could be part of the racking or even part of the laminate back support (16) or the open top laminate support (89). As little as two pair of left backsheet retainers (101) and right backsheet retainers (102) may be required. Only a small number of and with a small amount of right backsheet retainer (102) may be required.

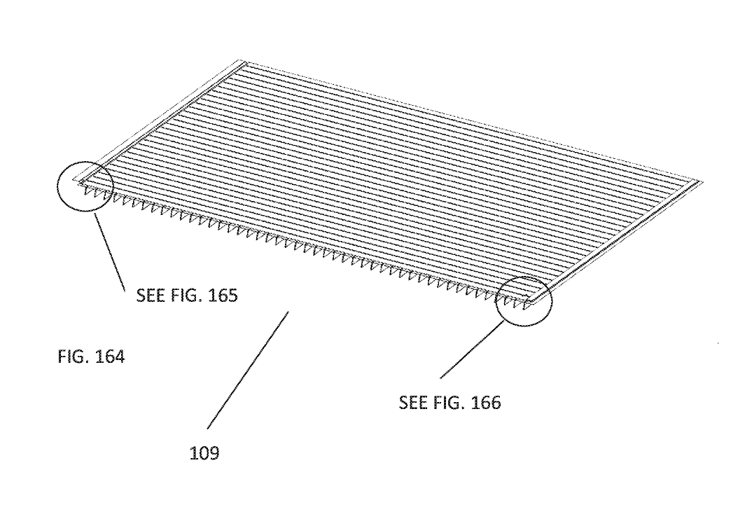

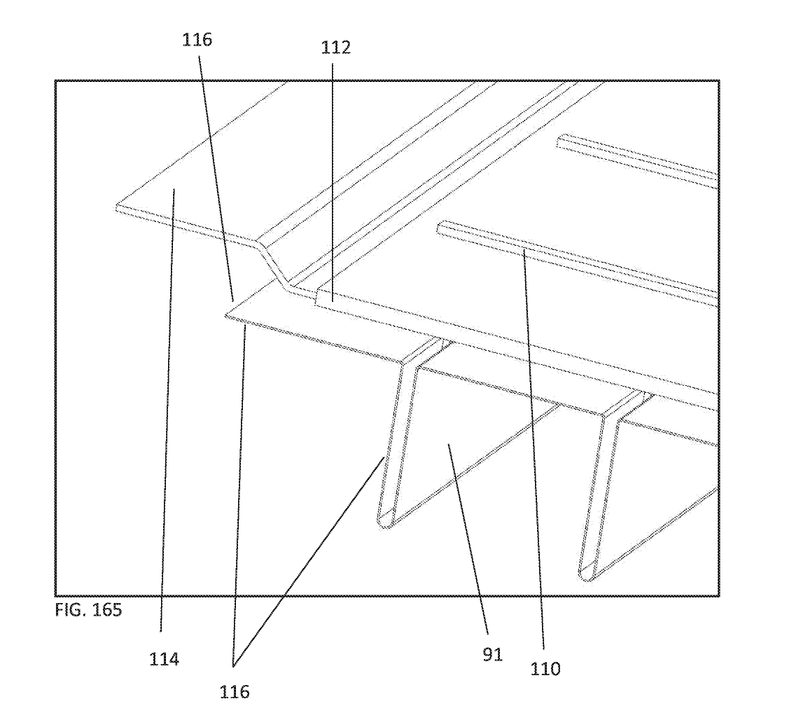

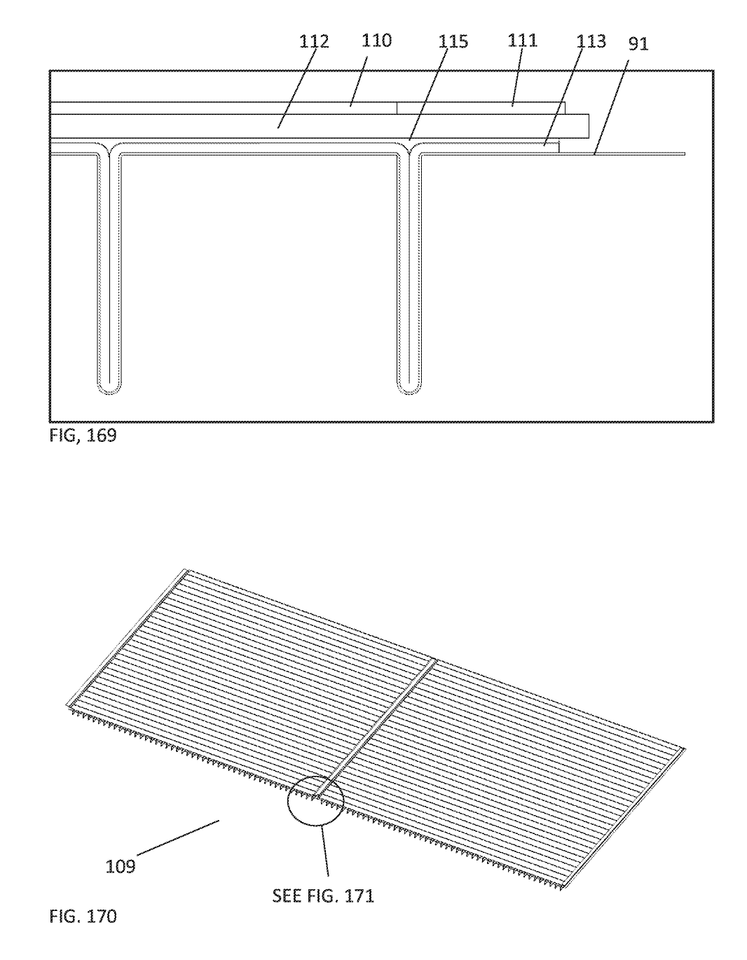

FIGS. 164-172 shows an example of a thermally conductive, electrical connection (113) such as, but not limited to, a formed conductive layer that may both conduct heat away from the solar cell (112) and electrically connect the top contact fingers (110) to the bottom of the adjacent solar cell (112).

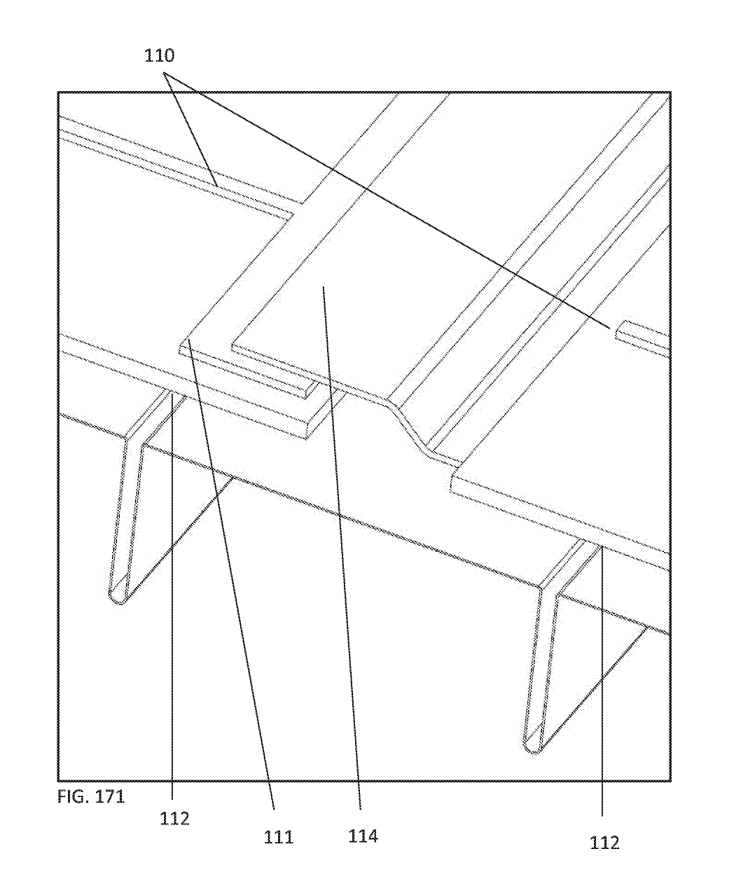

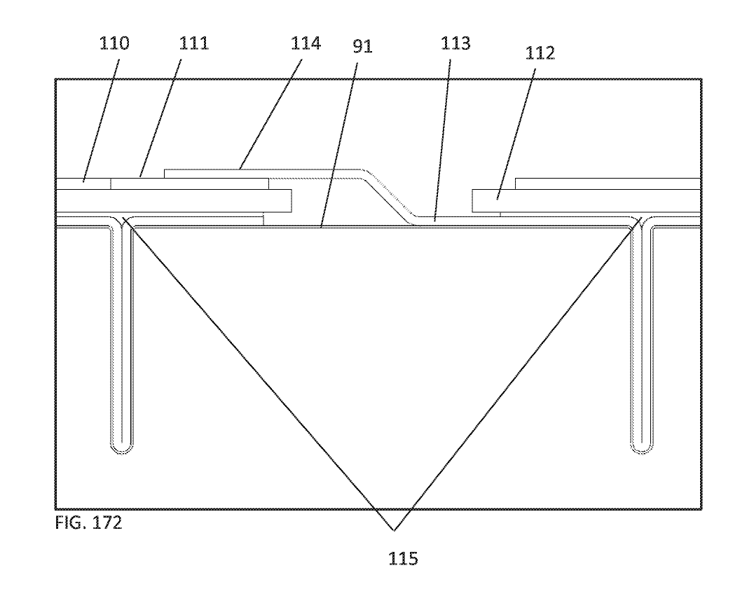

Typical silicon PV solar cells may be connected in series so there may be a need to provide an electrical connection from the top of one solar cell to the bottom of an adjacent solar cell. An example of this electrical connection is shown in FIGS. 171 and 172. The electrical connections path from the connection (113) may be provided from the left top of solar cell (112) to the left top contact fingers (110) to the left top connector pad (111) to the formed end conductive layer (114) to the formed connector layer (113) to the right connective bond (115) to the bottom of the right solar cell (112). This could be continued from solar cell to solar cell. Buss wire may be used to turn the direction of the solar cells as required.

The conductive bond (115) may be, but is not limited to, solder, friction weld (ultrasonic weld), or conductive adhesive, or the like. A conductive bond (115) may also be attached during the curing of the aluminum paste or other type of BSF (back surface field) paste. The formed conductive layer (113) may act as a BSF such that if paste may be used, then the amount of paste could be significantly reduced. If a formed conductive layer (113) may be attached directly to the bottom of the solar cell (112), then it could be a BSF.

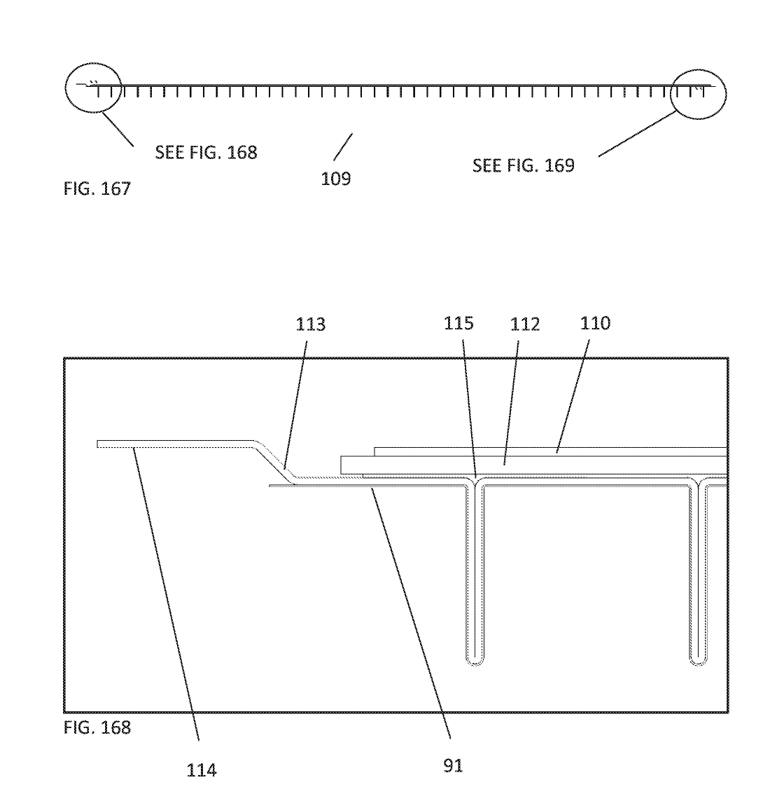

FIGS. 164 and 167 shows an example of one finned-connector partial laminate (109) and FIG. 170 shows an example of two finned-connectors (109).

The bottom of solar cell (112) may be electrically bonded to the formed conductive layer (113) perhaps by the conductive bond (115) as shown in FIGS. 168, 169, and 172. A formed end conductive layer (114) may be electrically bonded to the top contact pad (111) perhaps as shown in FIGS. 170-172.

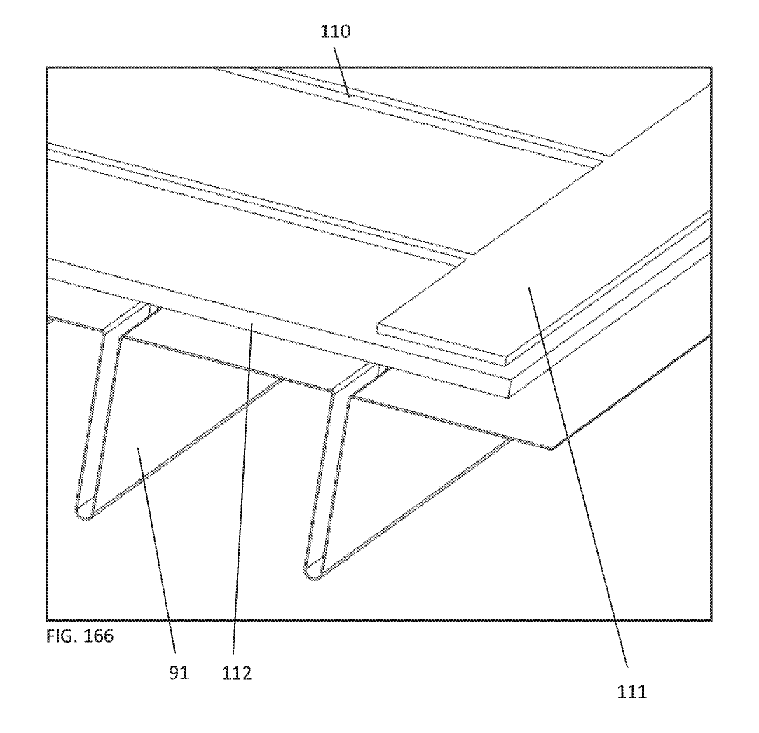

FIGS. 166 and 167, shows an example of a formed productive layer (91) which ends close to the solar cell (112) at the formed protective layer ends (116) for illustration only. The formed protective layer could normally extend out further, depending on the number of solar cells (112) and even the size of the solar panel, as well as other factors. A productive layer (91) may also known as a back sheet or backsheet.

In this patent, different features were discussed in the different types of solar panels (10). These features are not to be considered unique to those individual solar panels (10), but should be considered applicable all solar panels (10).

While the invention has been described in connection with a preferred embodiment, it is not intended to limit the scope of the invention to the particular form set forth, but on the contrary, it is intended to cover such alternatives, modifications, and equivalents as may be included within the spirit and scope of the invention. In this patent, different features were discussed. The features are not to be considered unique to any system or area but should be considered as useful for all of the systems or areas.

As can be easily understood from the foregoing, the basic concepts of the present invention may be embodied in a variety of ways. It involves both photovoltaic system techniques as well as devices to accomplish the appropriate photovoltaic system. In this application, the photovoltaic system techniques are disclosed as part of the results shown to be achieved by the various devices described and as steps which are inherent to utilization. They are simply the natural result of utilizing the devices as intended and described. In addition, while some devices are disclosed, it should be understood that these not only accomplish certain methods but also can be varied in a number of ways. Importantly, as to all of the foregoing, all of these facets should be understood to be encompassed by this disclosure.

The discussion included in this application is intended to serve as a basic description. The reader should be aware that the specific discussion may not explicitly describe all embodiments possible; many alternatives are implicit. It also may not fully explain the generic nature of the invention and may not explicitly show how each feature or element can actually be representative of a broader function or of a great variety of alternative or equivalent elements. Again, these are implicitly included in this disclosure. Where the invention is described in device-oriented terminology, each element of the device implicitly performs a function. Apparatus claims may not only be included for the device described, but also method or process claims may be included to address the functions the invention and each element performs. Neither the description nor the terminology is intended to limit the scope of the claims that will be included in any subsequent patent application.

It should also be understood that a variety of changes may be made without departing from the essence of the invention. Such changes are also implicitly included in the description. They still fall within the scope of this invention. A broad disclosure encompassing the explicit embodiment(s) shown, the great variety of implicit alternative embodiments, and the broad methods or processes and the like are encompassed by this disclosure and may be relied upon when drafting the claims for any subsequent patent application. It should be understood that such language changes and broader or more detailed claiming may be accomplished at a later date (such as by any required deadline) or in the event the applicant subsequently seeks a patent filing based on this filing. With this understanding, the reader should be aware that this disclosure is to be understood to support any subsequently filed patent application that may seek examination of as broad a base of claims as deemed within the applicant's right and may be designed to yield a patent covering numerous aspects of the invention both independently and as an overall system.

Further, each of the various elements of the invention and claims may also be achieved in a variety of manners. Additionally, when used or implied, an element is to be understood as encompassing individual as well as plural structures that may or may not be physically connected. This disclosure should be understood to encompass each such variation, be it a variation of an embodiment of any apparatus embodiment, a method or process embodiment, or even merely a variation of any element of these. Particularly, it should be understood that as the disclosure relates to elements of the invention, the words for each element may be expressed by equivalent apparatus terms or method terms—even if only the function or result is the same. Such equivalent, broader, or even more generic terms should be considered to be encompassed in the description of each element or action. Such terms can be substituted where desired to make explicit the implicitly broad coverage to which this invention is entitled. As but one example, it should be understood that all actions may be expressed as a means for taking that action or as an element which causes that action. Similarly, each physical element disclosed should be understood to encompass a disclosure of the action which that physical element facilitates. Regarding this last aspect, as but one example, the disclosure of a “connection” or “connector” should be understood to encompass disclosure of the act of “connecting”—whether explicitly discussed or not—and, conversely, were there effectively disclosure of the act of “connecting”, such a disclosure should be understood to encompass disclosure of a “connection” and even a “means for connecting.” Such changes and alternative terms are to be understood to be explicitly included in the description. Further, each such means (whether explicitly so described or not) should be understood as encompassing all elements that can perform the given function, and all descriptions of elements that perform a described function should be understood as a non-limiting example of means for performing that function.

Any patents, publications, or other references mentioned in this application for patent are hereby incorporated by reference. Any priority case(s) claimed by this application is hereby appended and hereby incorporated by reference. In addition, as to each term used it should be understood that unless its utilization in this application is inconsistent with a broadly supporting interpretation, common dictionary definitions should be understood as incorporated for each term and all definitions, alternative terms, and synonyms such as contained in the Random House Webster's Unabridged Dictionary, second edition are hereby incorporated by reference. Finally, all references listed below or in any list of references or other information statement filed with the application are hereby appended and hereby incorporated by reference, however, as to each of the above, to the extent that such information or statements incorporated by reference might be considered inconsistent with the patenting of this/these invention(s) such statements are expressly not to be considered as made by the applicant(s).

### LIST OF REFERENCES TO BE INCORPORATED BY REFERENCE

US PATENTS

| | | |
|---|---|---|
| 5,110,370 | 1992 May 5 | Vogeli et al. |
| 5,338,369 | 1994 Aug. 16 | Rawlings |
| 6,075,202 | 2000 Jun. 13 | Mori et al. |
| 8,247,243 | 2012 Aug. 21 | Sheats et al. |

US PATENT APPLICATION PUBLICATIONS

| | | | |
|---|---|---|---|
| 20110017275 | A1 | 2011 Jan. 27 | Zhou et al. |
| 20110056535 | A1 | 2011 Mar. 10 | Cross |
| 20110100425 | A1 | 2011 May 5 | Osamura et al. |
| 20120199176 | A1 | 2012 Aug. 9 | Hong et al. |

FOREIGN PATENT DOCUMENTS

| | | | | |
|---|---|---|---|---|
| 2007022221 | WO | A2 | 2007 Feb. 22 | Leidholm, et al. |
| 2009124098 | WO | A2 | 2009 Oct. 8 | Zhou et al. |

NON-PATENT LITERATURE DOCUMENTS

AI Technology, Inc. | “Thermal Conductive Back Sheets”. Retrieved
Aug. 3, 2016. http://www.aitechnology.com/products/solar/uv-stable-
protective-back-s . . . 6 pages. (c) 2001-2015 - AI Technology, Inc.

Thus, the applicant(s) should be understood to have support to claim and make a statement of invention to at least: i) each of the photovoltaic devices as herein disclosed and described, ii) the related methods disclosed and described, iii) similar, equivalent, and even implicit variations of each of these devices and methods, iv) those alternative designs which accomplish each of the functions shown as are disclosed and described, v) those alternative designs and methods which accomplish each of the functions shown as are implicit to accomplish that which is disclosed and described, vi) each feature, component, and step shown as separate and independent inventions, vii) the applications enhanced by the various systems or components disclosed, viii) the resulting products produced by such systems or components, ix) each system, method, and element shown or described as now applied to any specific field or devices mentioned, x) methods and apparatuses substantially as described hereinbefore and with reference to any of the accompanying examples, xi) an apparatus for performing the methods described herein comprising means for performing the steps, xii) the various combinations and permutations of each of the elements disclosed, xiii) each potentially dependent claim or concept as a dependency on each and every one of the independent claims or concepts presented, and xiv) all inventions described herein.

With regard to claims whether now or later presented for examination, it should be understood that for practical reasons and so as to avoid great expansion of the examination burden, the applicant may at any time present only initial claims or perhaps only initial claims with only initial dependencies. The office and any third persons interested in potential scope of this or subsequent applications should understand that broader claims may be presented at a later date in this case, in a case claiming the benefit of this case, or in any continuation in spite of any preliminary amendments, other amendments, claim language, or arguments presented, thus throughout the pendency of any case there is no intention to disclaim or surrender any potential subject matter. It should be understood that if or when broader claims are presented, such may require that any relevant prior art that may have been considered at any prior time may need to be re-visited since it is possible that to the extent any amendments, claim language, or arguments presented in this or any subsequent application are considered as made to avoid such prior art, such reasons may be eliminated by later presented claims or the like. Both the examiner and any person otherwise interested in existing or later potential coverage, or considering if there has at any time been any possibility of an indication of disclaimer or surrender of potential coverage, should be aware that no such surrender or disclaimer is ever intended or ever exists in this or any subsequent application. Limitations such as arose in Hakim v. Cannon Avent Group, PLC, 479 F.3d 1313 (Fed. Cir 2007), or the like are expressly not intended in this or any subsequent related matter. In addition, support should be understood to exist to the degree required under new matter laws—including but not limited to European Patent Convention Article 123(2) and United States Patent Law 35 USC 132 or other such laws—to permit the addition of any of the various dependencies or other elements presented under one independent claim or concept as dependencies or elements under any other independent claim or concept. In drafting any claims at any time whether in this application or in any subsequent application, it should also be understood that the applicant has intended to capture as full and broad a scope of coverage as legally available. To the extent that insubstantial substitutes are made, to the extent that the applicant did not in fact draft any claim so as to literally encompass any particular embodiment, and to the extent otherwise applicable, the applicant should not be understood to have in any way intended to or actually relinquished such coverage as the applicant simply may not have been able to anticipate all eventualities; one skilled in the art, should not be reasonably expected to have drafted a claim that would have literally encompassed such alternative embodiments.

Further, if or when used, the use of the transitional phrase “comprising” is used to maintain the “open-end” claims herein, according to traditional claim interpretation. Thus, unless the context requires otherwise, it should be understood that the term “comprise” or variations such as “comprises” or “comprising”, are intended to imply the inclusion of a stated element or step or group of elements or steps but not the exclusion of any other element or step or group of elements or steps. Such terms should be interpreted in their most expansive form so as to afford the applicant the broadest coverage legally permissible. Each claim presented herein is hereby incorporated to include that it can be dependent on any other claims, e.g., amended to state, “or any other claim.” The use of the phrase, “or any other claim” is used to provide support for any claim to be dependent on any other claim, such as another dependent claim, another independent claim, a previously listed claim, a subsequently listed claim, and the like. As one clarifying example, if a claim were dependent “on claim 20 or any other claim” or the like, it could be re-drafted as dependent on claim 1, claim 15, or even claim 25 (if such were to exist) if desired and still fall with the disclosure. It should be understood that this phrase also provides support for any combination of elements in the claims and even incorporates any desired proper antecedent basis for certain claim combinations such as with combinations of method, apparatus, process, and the like claims.

Finally, any claims set forth at any time are hereby incorporated by reference with the “or any other claim” dependency language, as part of this description of the invention, and the applicant expressly reserves the right to use all of or a portion of such incorporated content of such claims as additional description to support any of or all of the claims or any element or component thereof, and the applicant further expressly reserves the right to move any portion of or all of the incorporated content of such claims or any element or component thereof from the description into the claims or vice-versa as necessary to define the matter for which protection is sought by this application or by any subsequent continuation, division, or continuation-in-part application thereof, or to obtain any benefit of, reduction in fees pursuant to, or to comply with the patent laws, rules, or regulations of any country or treaty, and such content incorporated by reference shall survive during the entire pendency of this application including any subsequent continuation, division, or continuation-in-part application thereof or any reissue or extension thereon.

1. A surface affixment solar power system comprising:
a photovoltaic layer;
a sheet joined to substantially all of a back of said photovoltaic layer;
at least one protuberant limb formed from said sheet and extending away from said sheet; and
at least one planted limb docking base for said photovoltaic layer configured to securely couple with said at least one protuberant limb when mated with said planted base limb docking support.

2. A surface affixment solar power system according to claim 1 wherein said sheet joined to substantially all of a back of said photovoltaic layer comprises a sheet directly joined to substantially all of said back of said photovoltaic layer or a sheet indirectly joined to substantially all of said back of said photovoltaic layer.

3. A surface affixment solar power system according to claim 1 further comprising an adhesive between said protuberant limb and said planted limb docking base.

4. A surface affixment solar power system according to claim 1 wherein said at least one planted limb docking base comprises a molded base so that said molded base mates with said protuberant limb.

5. A surface affixment solar power system according to claim 1 wherein said protruberant limb is configured to latch with said planted limb docking base.

6. A surface affixment solar power system according to claim 1 wherein said protruberant limb is configured to conform with said planted limb docking base.

7. A surface affixment solar power system according to claim 1 wherein said planted limb docking base is attached to a surface selected from a group consisting of a roof, ground, carport, and structure.

8. A surface affixment solar power system according to claim 1 further comprising a conductive layer within said sheet joined to substantially all of said back of said photovoltaic layer.

9. A surface affixment solar power system according to claim 8 wherein said conductive layer is selected from an element consisting of aluminum, copper, silver, conductive metal, and any combination thereof.

10. A surface affixment solar power system according to claim 1 wherein said sheet comprises a folded sheet.

11. A surface affixment solar power system according to claim 1 wherein said planted limb docking base comprises a surface securement element.

12. A cooling solar power system comprising:
a photovoltaic layer;
a sheet joined to substantially all of a back of said photovoltaic layer;
a plurality of cooling conductive protuberant limbs formed from said sheet and extending away from said sheet;
a thermal conductive layer within said sheet conforming within said protuberant limbs;
wherein said thermal conductive layer dissipates heat from said photovoltaic layer.

13. A cooling solar power system according to claim 12 wherein said sheet joined to substantially all of a back of said photovoltaic layer comprises a sheet directly joined to substantially all of said back of said photovoltaic layer or a sheet indirectly joined to substantially all of said back of said photovoltaic layer.

14. A cooling solar power system according to claim 12 wherein said thermal conductive layer is substantially integrated within said sheet.

15. A cooling solar power system according to claim 12 wherein said thermal conductive layer is placed to follow a curvature of said sheet.

16. A cooling solar power system according to claim 12 wherein said sheet comprises a folded sheet.

17. A cooling solar power system according to claim 12 wherein said conductive layer is selected from an element consisting of aluminum, copper, silver, conductive metal, and any combination thereof.

18. A cooling solar power system according to claim 12 wherein said thermal conductive layer is selectively placed within said sheet to avoid an electrical short.

19. A cooling solar power system according to claim 12 further comprising a raised electronic box attached to at least one cooling conductive protuberant limb.

20. A connected solar power system comprising:
a plurality of individual photovoltaic cells;
a sheet joined to substantially all of a back of each of said plurality of individual photovoltaic cells;
a thermal conductive layer within said sheet;
a plurality of cooling conductive protuberant limbs formed from said sheet and extending away from said sheet;
a thermally conductive, electrical connection between said sheet joined to substantially all of said back of one of said individual photovoltaic cells and a top surface electric current of an adjacent individual photovoltaic cell.

21. A connected solar power system according to claim 20 wherein said sheet joined to substantially all of said back of said photovoltaic layer comprises a sheet directly joined to substantially all of said back of said photovoltaic layer or a sheet indirectly joined to substantially all of said back of said photovoltaic layer.

22. A connected solar power system according to claim 20 wherein said thermally conductive, electrical connection comprises a thermally conductive sheet.

23. A connected solar power system according to claim 22 wherein said conductive sheet comprises a formed sheet.

24. A connected solar power system according to claim 22 wherein said conductive sheet comprises a folded sheet.

25. A connected solar power system according to claim 20 wherein said thermally conductive, electrical connection comprises a conductive element selected from an element consisting of aluminum, copper, silver, conductive metal, and any combination thereof.
